(19) United States
(12) Patent Application Publication
(10) Pub. No.: US 2026/0281681 A1
(43) Pub. Date: Sep. 17, 2026

(54) TRANSFERRING CONTENT BETWEEN COMPUTER SYSTEMS

(71) Applicant: Apple Inc., Cupertino, CA (US)

(72) Inventors: Jae Woo CHANG, Los Altos Hills, CA (US); Darren GUINNESS, Santa Clara, CA (US); Travis JONES, Hickory Creek, TX (US)

(21) Appl. No.: 19/681,557

(22) Filed: May 19, 2026

Related U.S. Application Data
(63) Continuation of application No. 18/444,430, filed on Feb. 16, 2024.
(60) Provisional application No. 63/464,467, filed on May 5, 2023.
(60) Provisional application No. 63/545,293, filed on Oct. 23, 2023.
(60) Provisional application No. 63/614,151, filed on Dec. 22, 2023.

(51) Int. Cl. H04W 4/80; G06F 9/451

(52) U.S. Cl. CPC H04W 4/80; G06F 9/451

(57) ABSTRACT

The present disclosure generally relates to transferring content between computer systems.

### CROSS-REFERENCE TO RELATED APPLICATIONS

This application claims priority to U.S. application Ser. No. 18/444,430, filed Feb. 16, 2024, and entitled “TRANSFERRING CONTENT BETWEEN COMPUTER SYSTEMS,” which claims priority to U.S. Provisional Application No. 63/614,151, filed Dec. 22, 2023, and entitled “TRANSFERRING CONTENT BETWEEN COMPUTER SYSTEMS,” U.S. Provisional Application No. 63/545,293, filed Oct. 23, 2023, and entitled “TRANSFERRING CONTENT BETWEEN COMPUTER SYSTEMS,” and U.S. Provisional Application No. 63/464,467, filed May 5, 2023, and entitled “TRANSFERRING CONTENT BETWEEN COMPUTER SYSTEMS”. The contents of each of these applications are hereby incorporated by reference for all purposes.

### FIELD

The present disclosure relates generally to computer user interfaces, and more specifically to techniques for transferring content between computer systems.

### BACKGROUND

Electronic devices store various type of information including contact information such as a name, phone number, and email address of a person or other entity. Electronic devices can also display various types of content such as websites, videos, photos, and documents.

### BRIEF SUMMARY

Some techniques for transferring content using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for transferring content between computer systems. Such methods and interfaces optionally complement or replace other methods for transferring content between computer systems. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a first computer system that is in communication with a display generation component: obtaining an indication that a set of contact information-sharing criteria is met, wherein the set of contact information-sharing criteria includes a set of position criteria that requires that a physical distance between the first computer system and a second computer system satisfies a distance threshold; and in response to obtaining the indication that the set of contact information-sharing criteria is met: displaying, via the display generation component, a first set of contact information associated with the first computer system; and providing a prompt for transferring respective contact information.

In accordance with some embodiments, a non-transitory computer-readable storage medium storing one or more programs configured to be executed by one or more processors of a computer system that is in communication with a display generation component is described. The one or more programs include instructions for: obtaining an indication that a set of contact information-sharing criteria is met, wherein the set of contact information-sharing criteria includes a set of position criteria that requires that a physical distance between the first computer system and a second computer system satisfies a distance threshold; and in response to obtaining the indication that the set of contact information-sharing criteria is met: displaying, via the display generation component, a first set of contact information associated with the first computer system; and providing a prompt for transferring respective contact information.

In accordance with some embodiments, a transitory computer-readable storage medium storing one or more programs configured to be executed by one or more processors of a computer system that is in communication with a display generation component is described. The one or more programs include instructions for: obtaining an indication that a set of contact information-sharing criteria is met, wherein the set of contact information-sharing criteria includes a set of position criteria that requires that a physical distance between the first computer system and a second computer system satisfies a distance threshold; and in response to obtaining the indication that the set of contact information-sharing criteria is met: displaying, via the display generation component, a first set of contact information associated with the first computer system; and providing a prompt for transferring respective contact information.

In accordance with some embodiments, a computer system configured to communicate with a display generation component is described. The computer system comprises: one or more processors; and memory storing one or more programs configured to be executed by the one or more processors, the one or more programs including instructions for: obtaining an indication that a set of contact information-sharing criteria is met, wherein the set of contact information-sharing criteria includes a set of position criteria that requires that a physical distance between the first computer system and a second computer system satisfies a distance threshold; and in response to obtaining the indication that the set of contact information-sharing criteria is met: displaying, via the display generation component, a first set of contact information associated with the first computer system; and providing a prompt for transferring respective contact information.

In accordance with some embodiments, a computer system configured to communicate with a display generation component is described. The computer system comprises: means for obtaining an indication that a set of contact information-sharing criteria is met, wherein the set of contact information-sharing criteria includes a set of position criteria that requires that a physical distance between the first computer system and a second computer system satisfies a distance threshold; and mean for, in response to obtaining the indication that the set of contact information-sharing criteria is met: displaying, via the display generation component, a first set of contact information associated with the first computer system; and providing a prompt for transferring respective contact information.

In accordance with some embodiments, a computer program product is described. The computer program product comprises one or more programs configured to be executed by one or more processors of a computer system that is in communication with a display generation component. The one or more programs include instructions for: obtaining an indication that a set of contact information-sharing criteria is met, wherein the set of contact information-sharing criteria includes a set of position criteria that requires that a physical distance between the first computer system and a second computer system satisfies a distance threshold; and in response to obtaining the indication that the set of contact information-sharing criteria is met: displaying, via the display generation component, a first set of contact information associated with the first computer system; and providing a prompt for transferring respective contact information.

In accordance with some embodiments, a method is described. The method comprises: at a first computer system that is in communication with a display generation component: obtaining an indication that a set of content-sharing criteria is met, wherein the set of content-sharing criteria includes a set of position criteria that requires that a physical distance between the first computer system and a second computer system satisfies a distance threshold; and in response to obtaining the indication that the set of content-sharing criteria is met: providing a prompt for sharing, with the second computer system, respective designated content that is currently designated at the first computer system.

In accordance with some embodiments, a non-transitory computer-readable storage medium storing one or more programs configured to be executed by one or more processors of a computer system that is in communication with a display generation component is described. The one or more programs include instructions for: obtaining an indication that a set of content-sharing criteria is met, wherein the set of content-sharing criteria includes a set of position criteria that requires that a physical distance between the first computer system and a second computer system satisfies a distance threshold; and in response to obtaining the indication that the set of content-sharing criteria is met: providing a prompt for sharing, with the second computer system, respective designated content that is currently designated at the first computer system.

In accordance with some embodiments, a transitory computer-readable storage medium storing one or more programs configured to be executed by one or more processors of a computer system that is in communication with a display generation component is described. The one or more programs include instructions for: obtaining an indication that a set of content-sharing criteria is met, wherein the set of content-sharing criteria includes a set of position criteria that requires that a physical distance between the first computer system and a second computer system satisfies a distance threshold; and in response to obtaining the indication that the set of content-sharing criteria is met: providing a prompt for sharing, with the second computer system, respective designated content that is currently designated at the first computer system.

In accordance with some embodiments, a computer system configured to communicate with a display generation component is described. The computer system comprises: one or more processors; and memory storing one or more programs configured to be executed by the one or more processors, the one or more programs including instructions for: obtaining an indication that a set of content-sharing criteria is met, wherein the set of content-sharing criteria includes a set of position criteria that requires that a physical distance between the first computer system and a second computer system satisfies a distance threshold; and in response to obtaining the indication that the set of content-sharing criteria is met: providing a prompt for sharing, with the second computer system, respective designated content that is currently designated at the first computer system.

In accordance with some embodiments, a computer system configured to communicate with a display generation component is described. The computer system comprises: means for obtaining an indication that a set of content-sharing criteria is met, wherein the set of content-sharing criteria includes a set of position criteria that requires that a physical distance between the first computer system and a second computer system satisfies a distance threshold; and means for, in response to obtaining the indication that the set of content-sharing criteria is met: providing a prompt for sharing, with the second computer system, respective designated content that is currently designated at the first computer system.

In accordance with some embodiments, a computer program product is described. The computer program product comprises one or more programs configured to be executed by one or more processors of a computer system that is in communication with a display generation component, the one or more programs including instructions for: obtaining an indication that a set of content-sharing criteria is met, wherein the set of content-sharing criteria includes a set of position criteria that requires that a physical distance between the first computer system and a second computer system satisfies a distance threshold; and in response to obtaining the indication that the set of content-sharing criteria is met: providing a prompt for sharing, with the second computer system, respective designated content that is currently designated at the first computer system.

In accordance with some embodiments, a method is described. The method comprises: at a first computer system that is in communication with a display generation component: obtaining an indication that a set of information-sharing criteria is met, wherein the set of information-sharing criteria includes a set of position criteria that requires that a physical distance between the first computer system and a second computer system satisfies a distance threshold; and in response to obtaining the indication that the set of information-sharing criteria is met: in accordance with a determination that a first set of criteria is met, providing a prompt for transferring a first set of information; and in accordance with a determination that the first set of criteria is not met, providing a prompt for transferring a second set of information that is different from the first set of information.

In accordance with some embodiments, a non-transitory computer-readable storage medium storing one or more programs configured to be executed by one or more processors of a computer system that is in communication with a display generation component is described. The one or more programs include instructions for: obtaining an indication that a set of information-sharing criteria is met, wherein the set of information-sharing criteria includes a set of position criteria that requires that a physical distance between the first computer system and a second computer system satisfies a distance threshold; and in response to obtaining the indication that the set of information-sharing criteria is met: in accordance with a determination that a first set of criteria is met, providing a prompt for transferring a first set of information; and in accordance with a determination that the first set of criteria is not met, providing a prompt for transferring a second set of information that is different from the first set of information.

In accordance with some embodiments, a transitory computer-readable storage medium storing one or more programs configured to be executed by one or more processors of a computer system that is in communication with a display generation component is described. The one or more programs include instructions for: obtaining an indication that a set of information-sharing criteria is met, wherein the set of information-sharing criteria includes a set of position criteria that requires that a physical distance between the first computer system and a second computer system satisfies a distance threshold; and in response to obtaining the indication that the set of information-sharing criteria is met: in accordance with a determination that a first set of criteria is met, providing a prompt for transferring a first set of information; and in accordance with a determination that the first set of criteria is not met, providing a prompt for transferring a second set of information that is different from the first set of information.

In accordance with some embodiments, a computer system configured to communicate with a display generation component is described. The computer system comprises: one or more processors; and memory storing one or more programs configured to be executed by the one or more processors, the one or more programs including instructions for: obtaining an indication that a set of information-sharing criteria is met, wherein the set of information-sharing criteria includes a set of position criteria that requires that a physical distance between the first computer system and a second computer system satisfies a distance threshold; and in response to obtaining the indication that the set of information-sharing criteria is met: in accordance with a determination that a first set of criteria is met, providing a prompt for transferring a first set of information; and in accordance with a determination that the first set of criteria is not met, providing a prompt for transferring a second set of information that is different from the first set of information.

In accordance with some embodiments, a computer system configured to communicate with a display generation component is described. The computer system comprises: means for obtaining an indication that a set of information-sharing criteria is met, wherein the set of information-sharing criteria includes a set of position criteria that requires that a physical distance between the first computer system and a second computer system satisfies a distance threshold; and means for, in response to obtaining the indication that the set of information-sharing criteria is met: in accordance with a determination that a first set of criteria is met, providing a prompt for transferring a first set of information; and in accordance with a determination that the first set of criteria is not met, providing a prompt for transferring a second set of information that is different from the first set of information.

In accordance with some embodiments, a computer program product is described. The computer program product comprises one or more programs configured to be executed by one or more processors of a computer system that is in communication with a display generation component, the one or more programs including instructions for: obtaining an indication that a set of information-sharing criteria is met, wherein the set of information-sharing criteria includes a set of position criteria that requires that a physical distance between the first computer system and a second computer system satisfies a distance threshold; and in response to obtaining the indication that the set of information-sharing criteria is met: in accordance with a determination that a first set of criteria is met, providing a prompt for transferring a first set of information; and in accordance with a determination that the first set of criteria is not met, providing a prompt for transferring a second set of information that is different from the first set of information.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for transferring content, thereby increasing the effectiveness, efficiency, and user satisfaction with such devices. Such methods and interfaces may complement or replace other methods for transferring content between computer systems.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 5C illustrates an exemplary diagram of a communication session between electronic devices in accordance with some embodiments.

FIGS. 6A-6BB illustrate user interfaces for transferring information, in accordance with some embodiments.

FIG. 7 is a flow diagram illustrating methods for transferring contact information, in accordance with some embodiments.

FIG. 8 is a flow diagram illustrating methods for transferring designated content, in accordance with some embodiments.

FIG. 9 is a flow diagram illustrating methods for transferring information, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for transferring content. In some embodiments, a first computer system provides a prompt to share contact information with a second computer system in response to obtaining an indication that a set of contact information-sharing criteria is met. In some embodiments, a first computer system provides a prompt for transferring designated content to a second computer system in response to obtaining an indication that a set of content-sharing criteria is met. In some embodiments, a first computer system provides a prompt to transfer a first set of information or a second set of information to a second computer system based on whether a set of criteria is met. Such techniques can reduce the cognitive burden on a user who transfer information between computer systems, thereby enhancing productivity. Further, such techniques can reduce processor and battery power otherwise wasted on redundant user inputs.

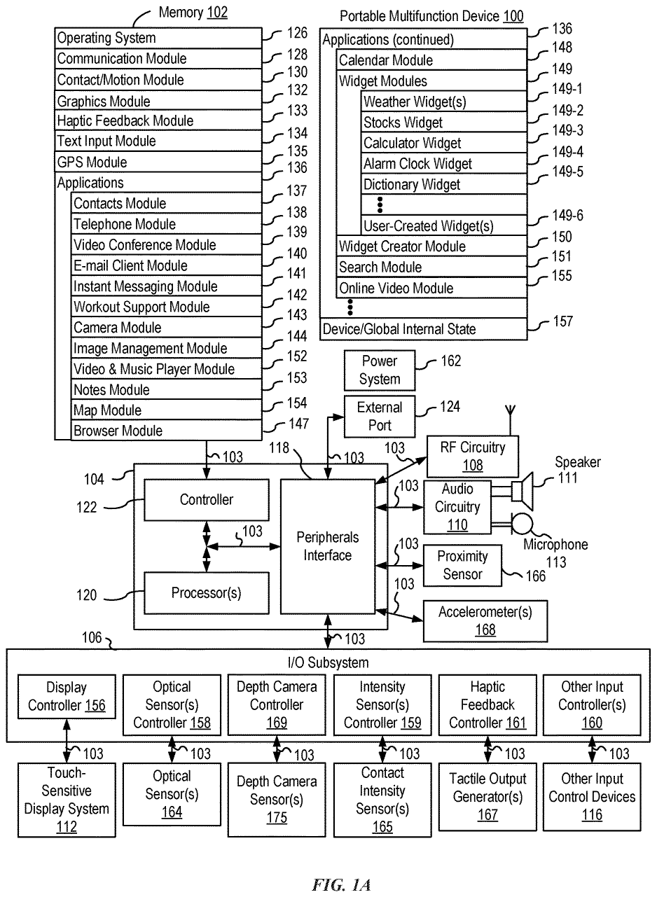

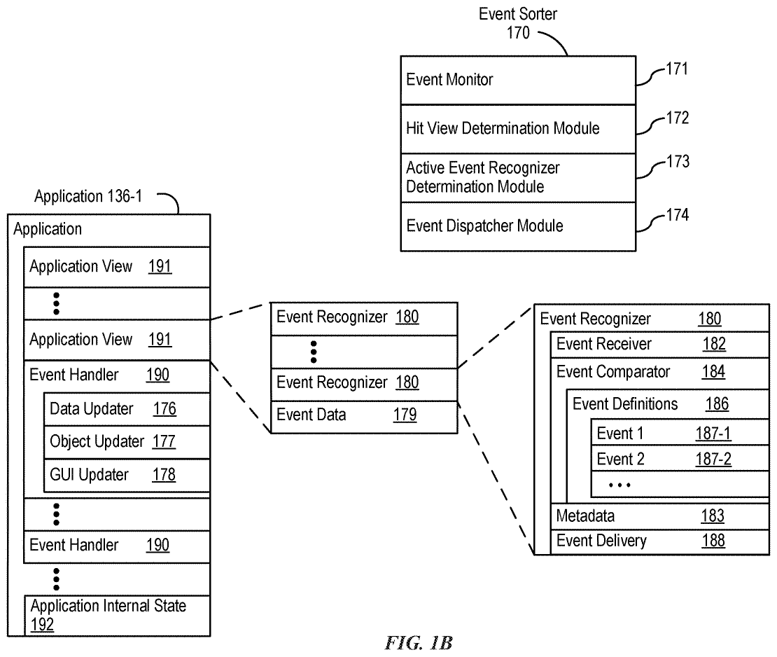

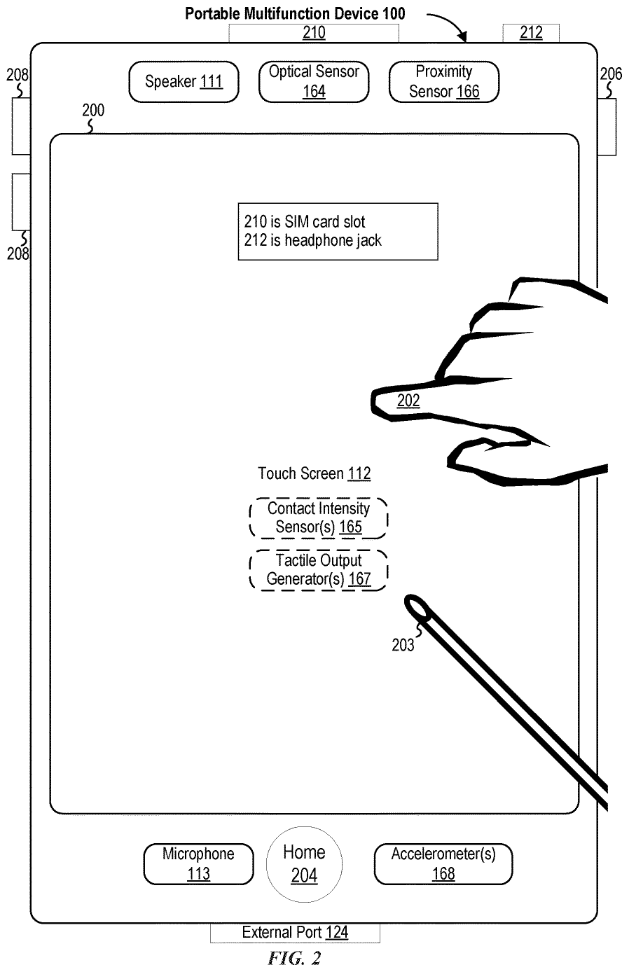

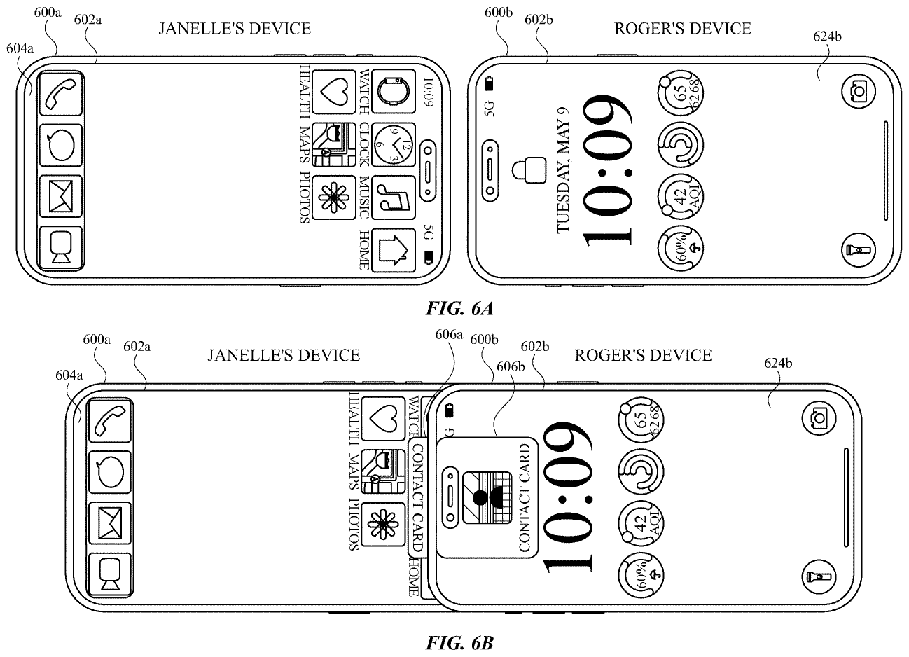

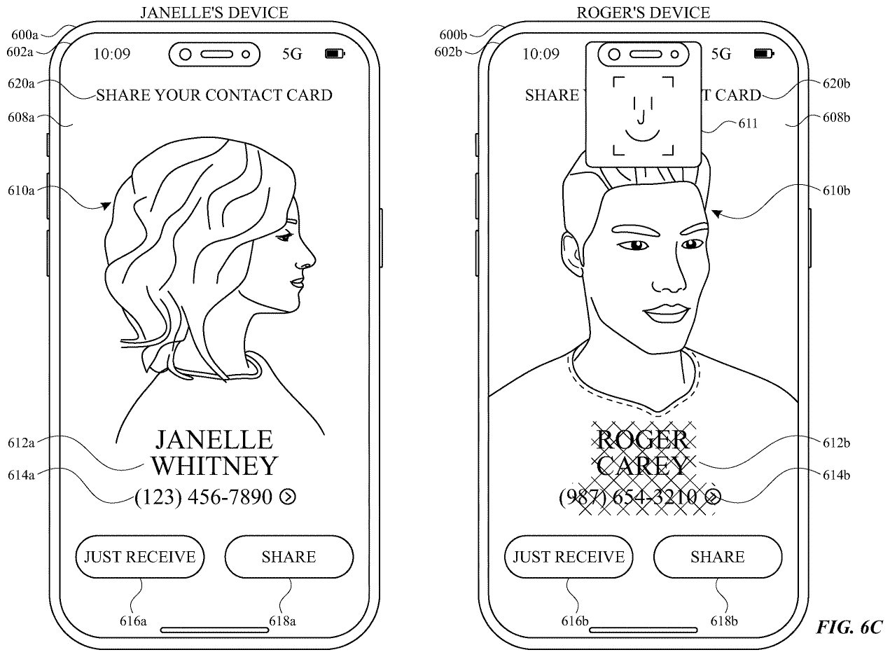

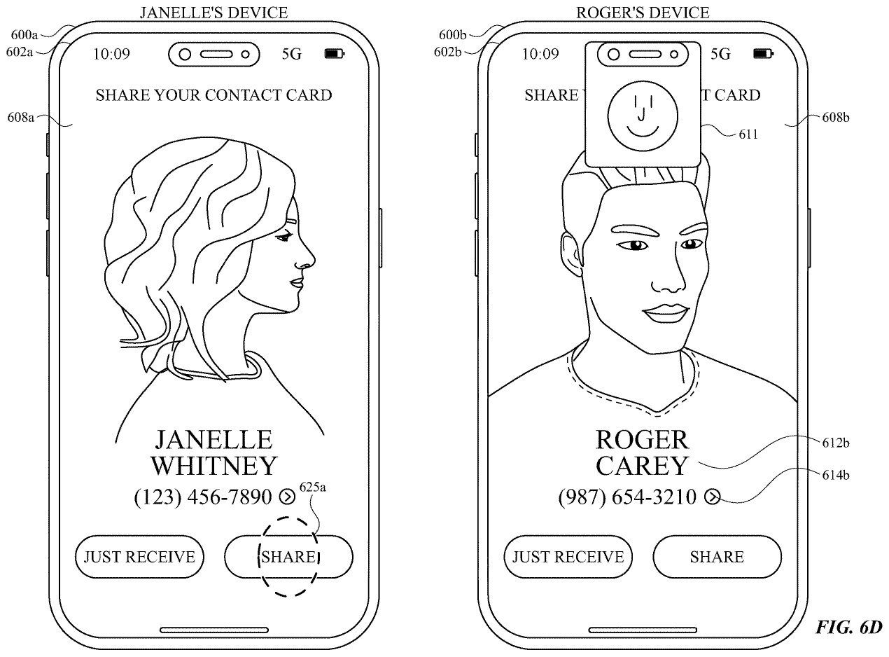

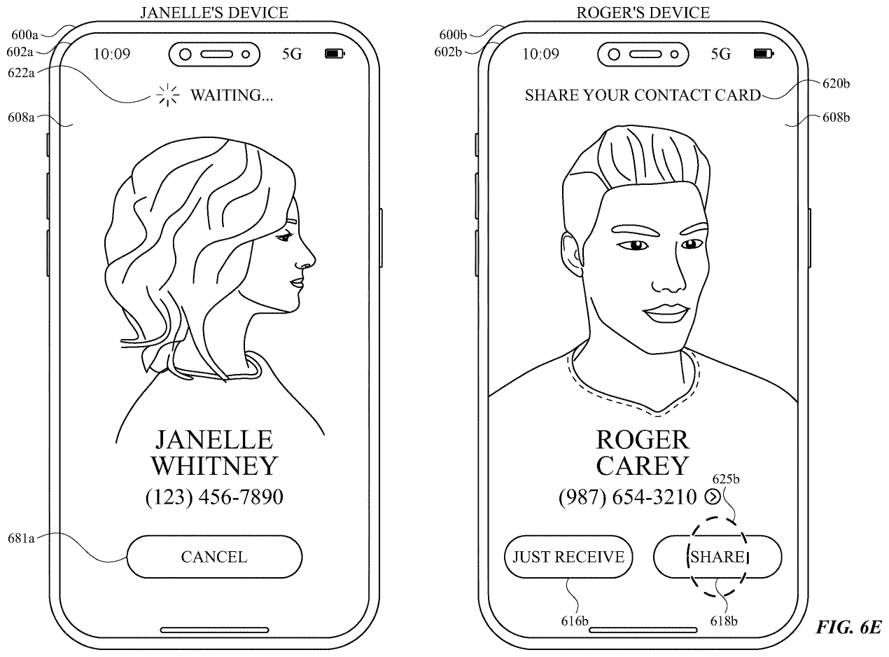

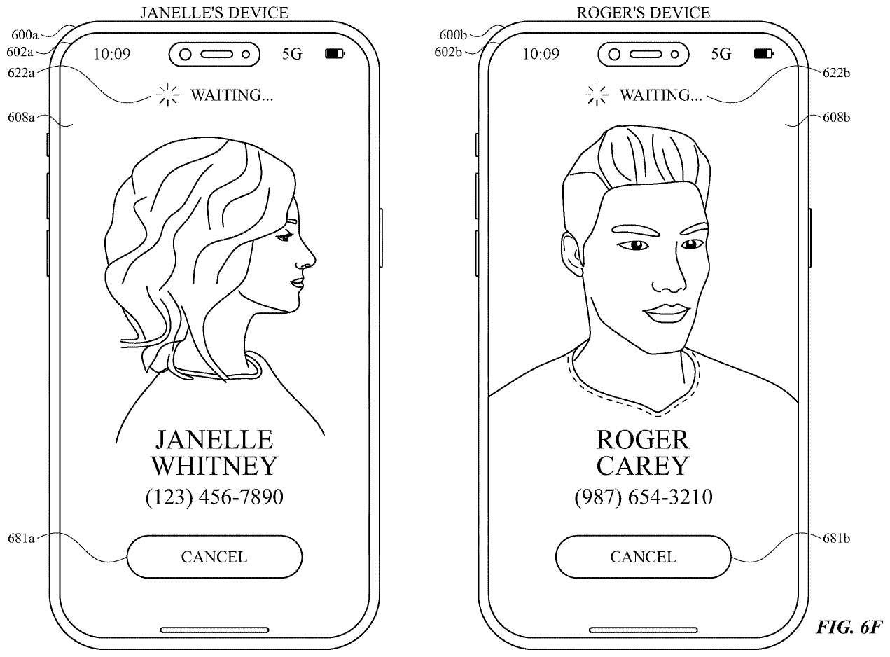

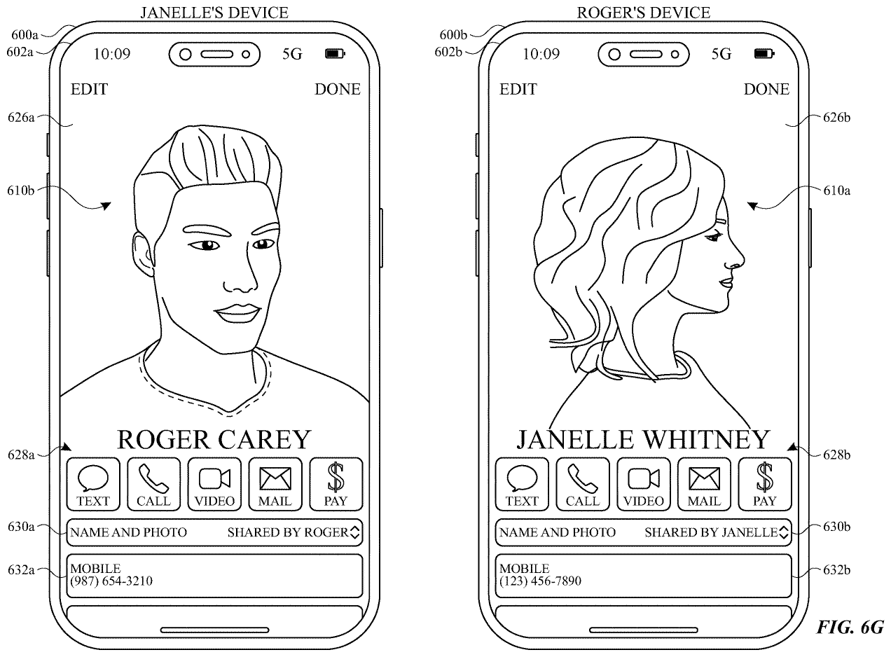

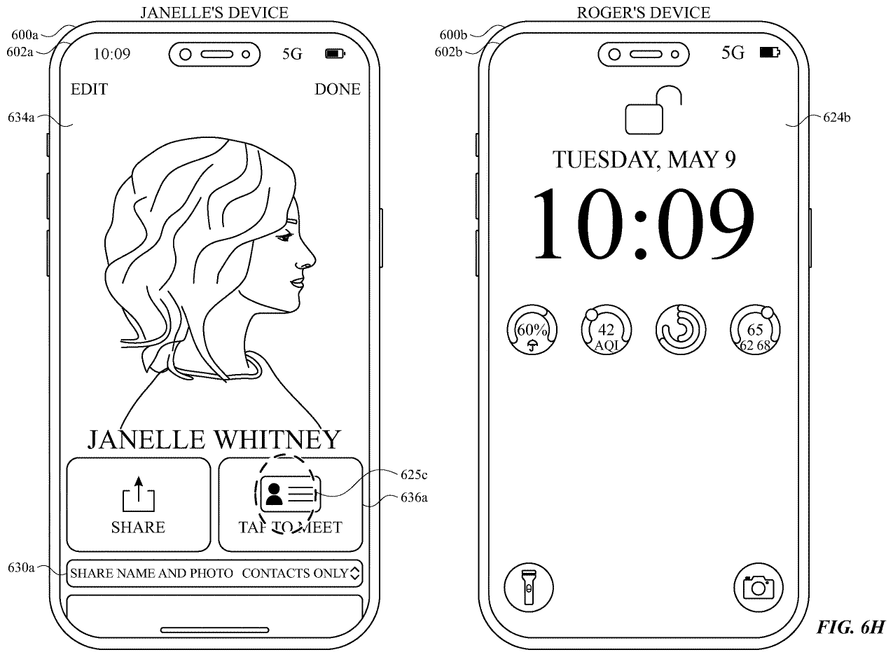

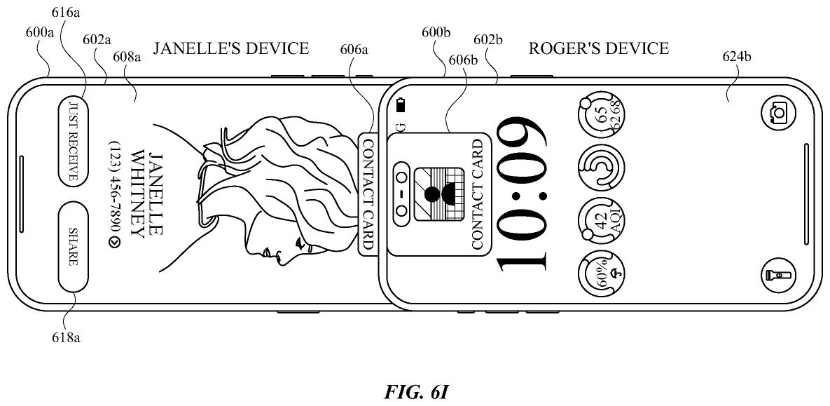

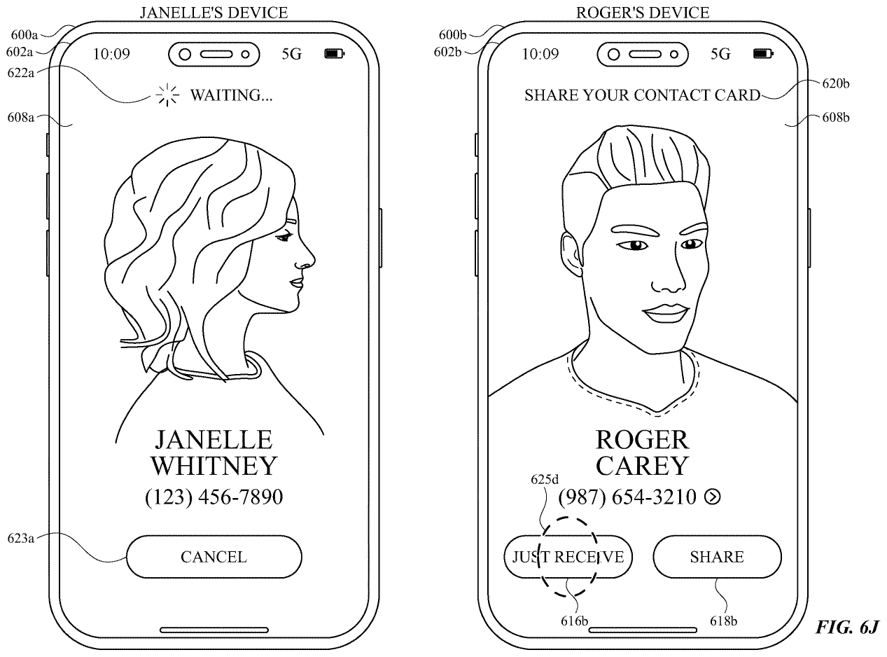

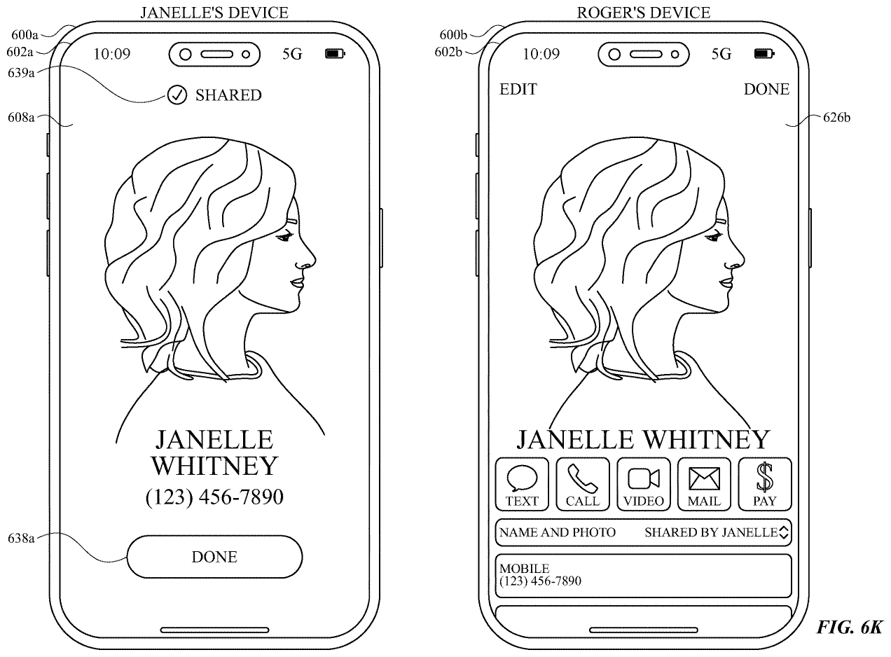

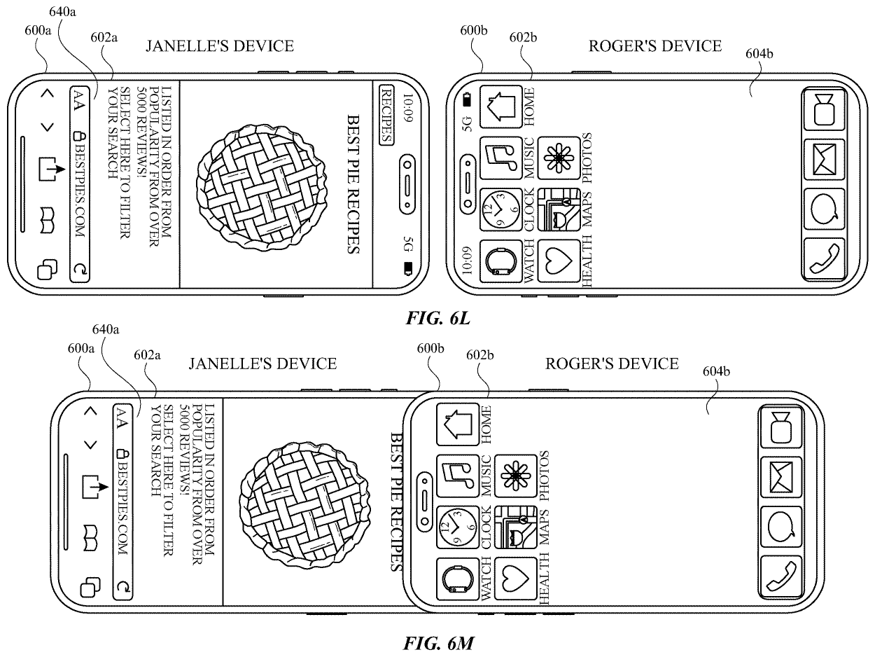

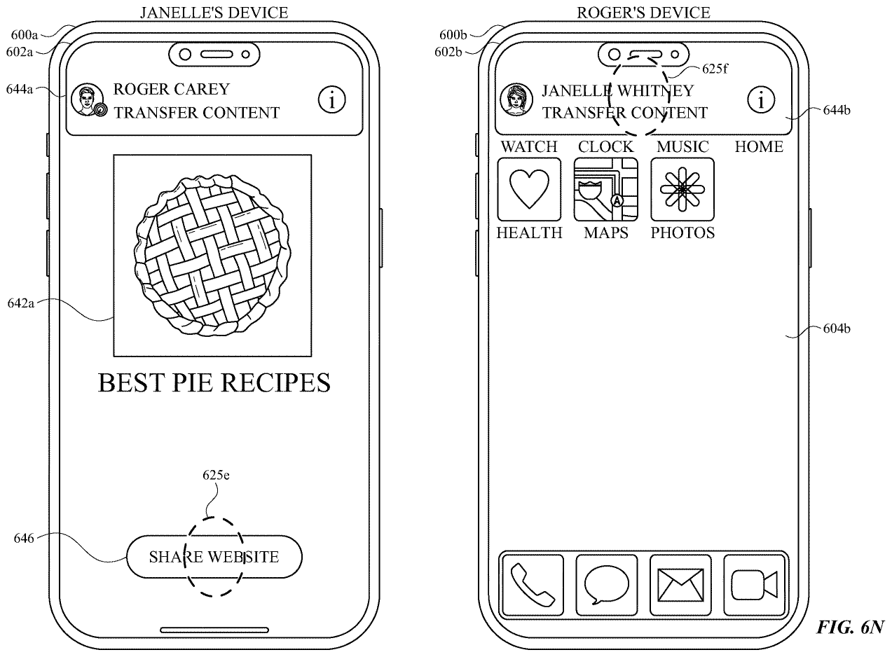

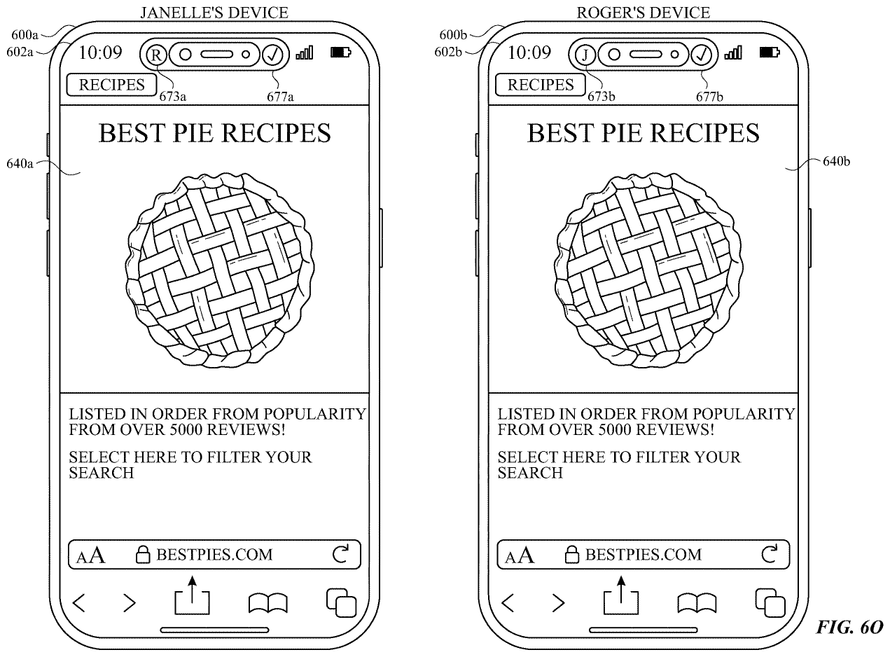

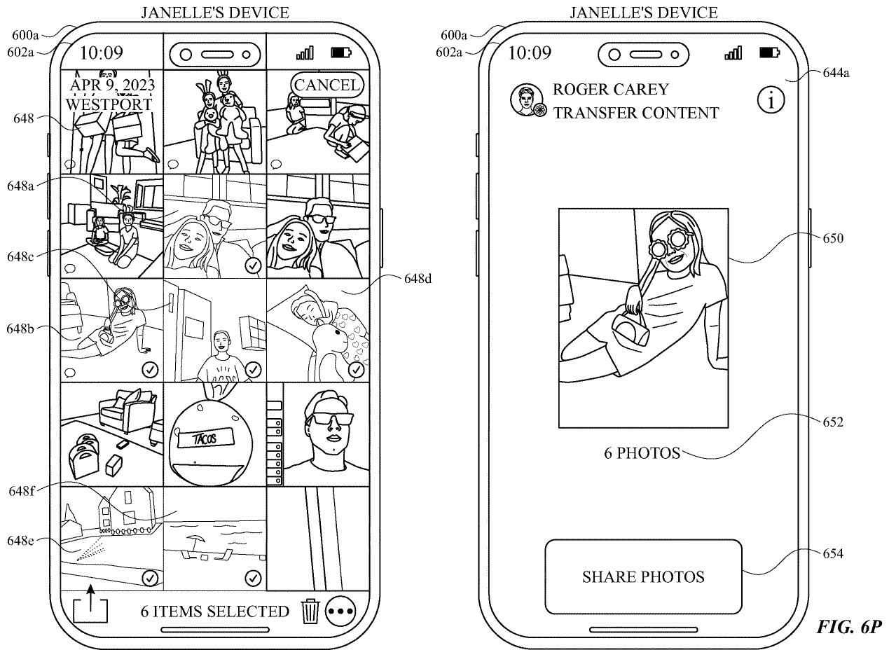

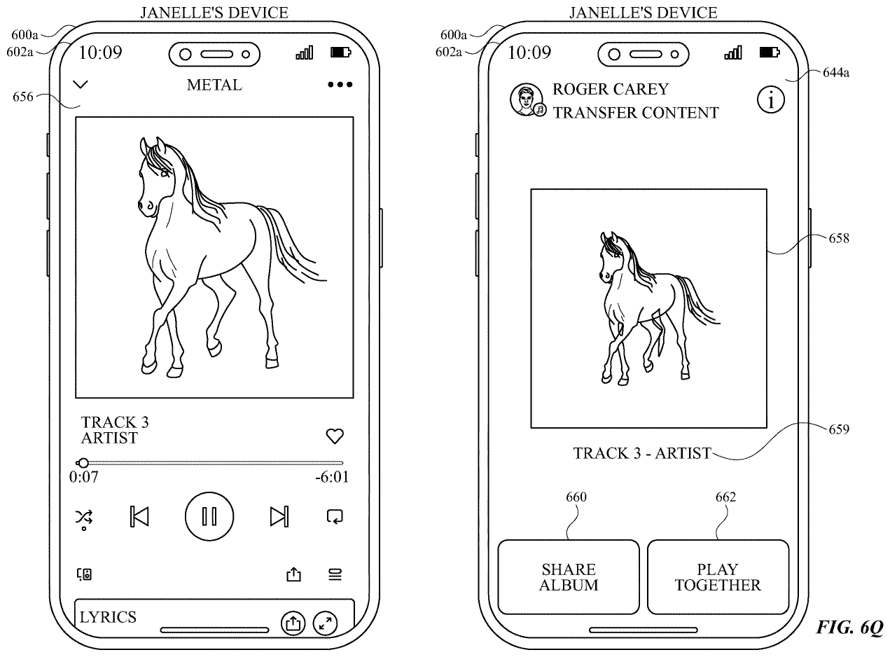

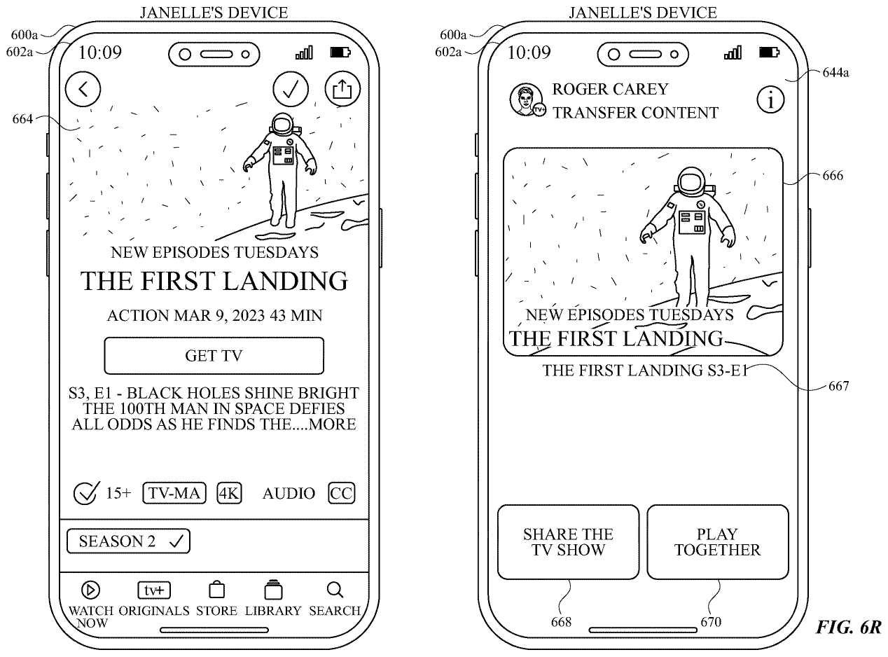

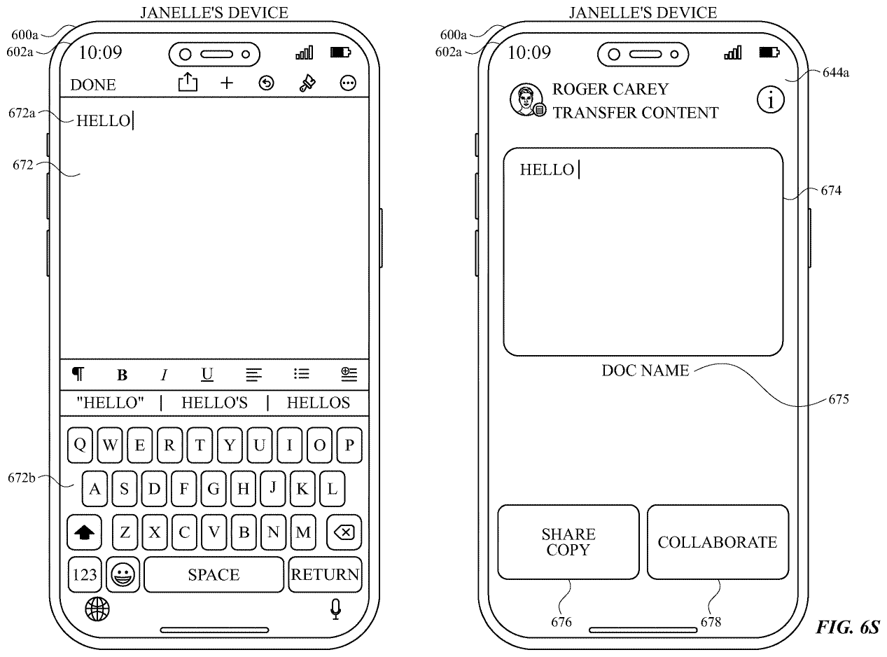

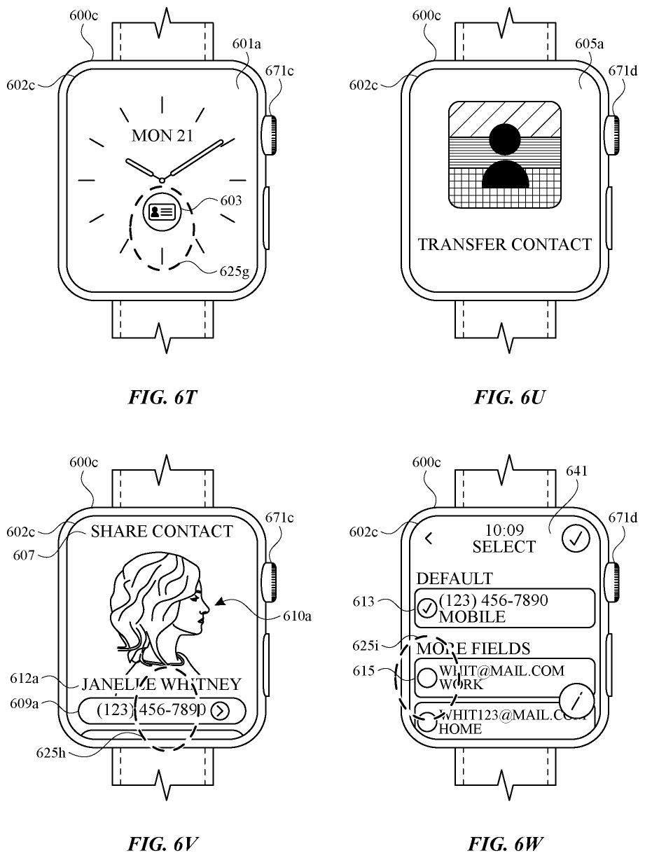

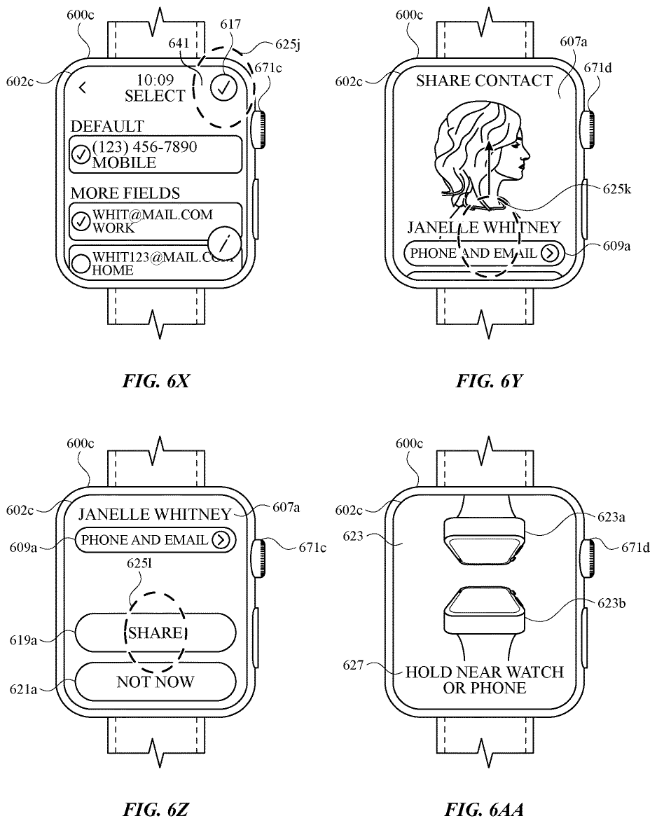

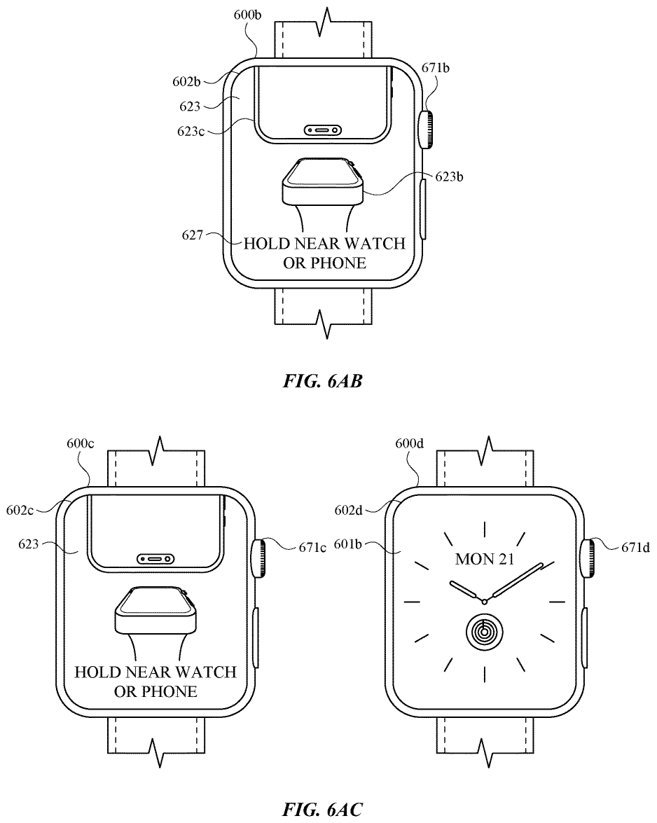

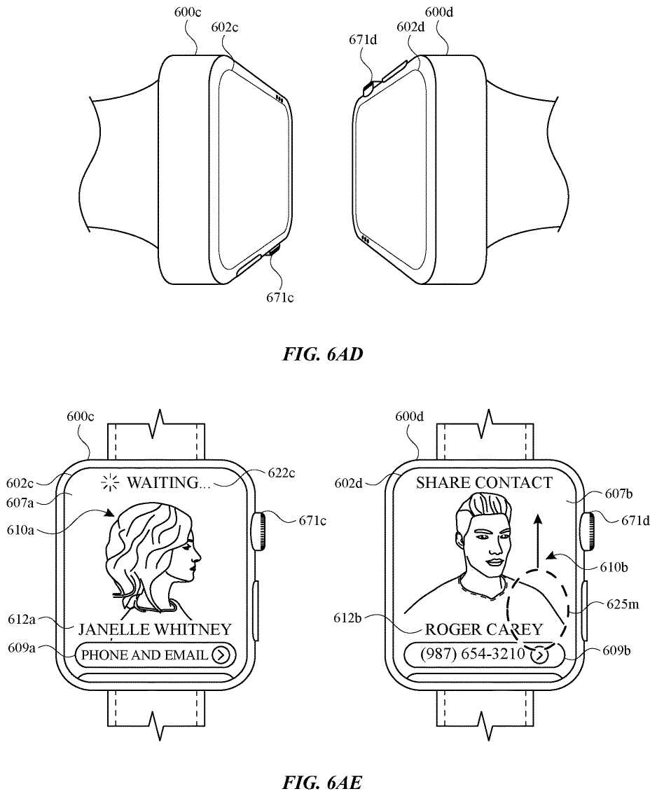

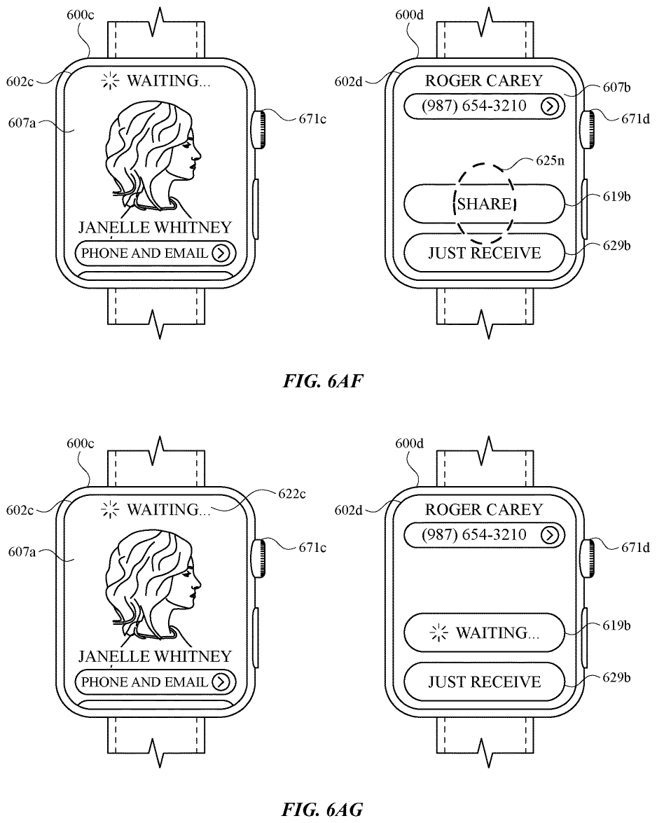

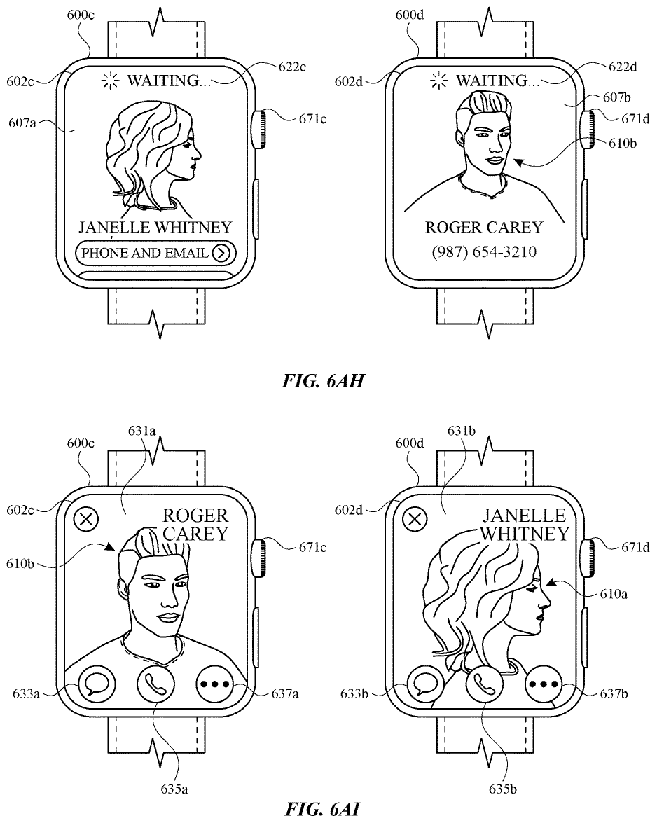

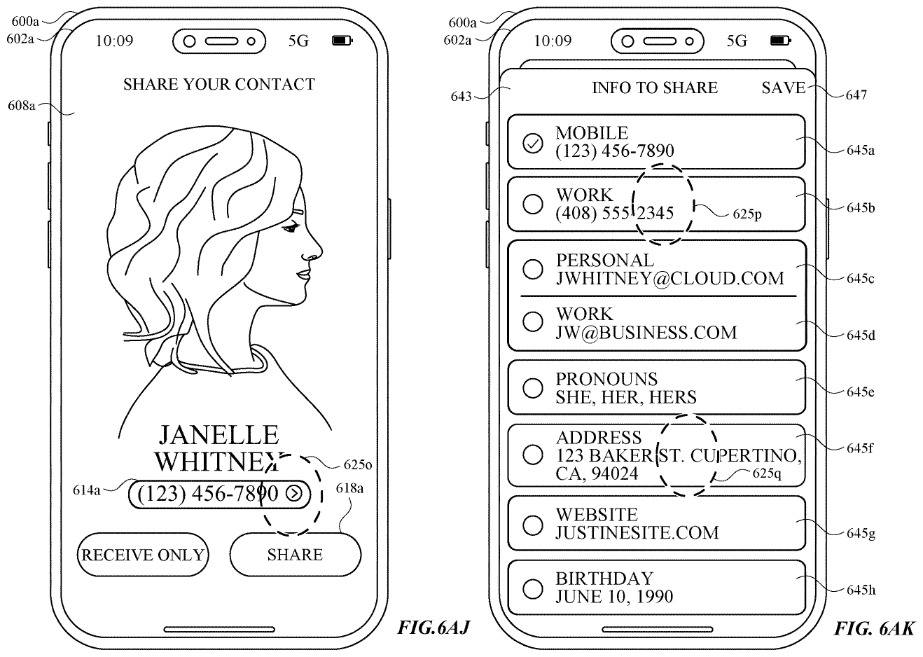

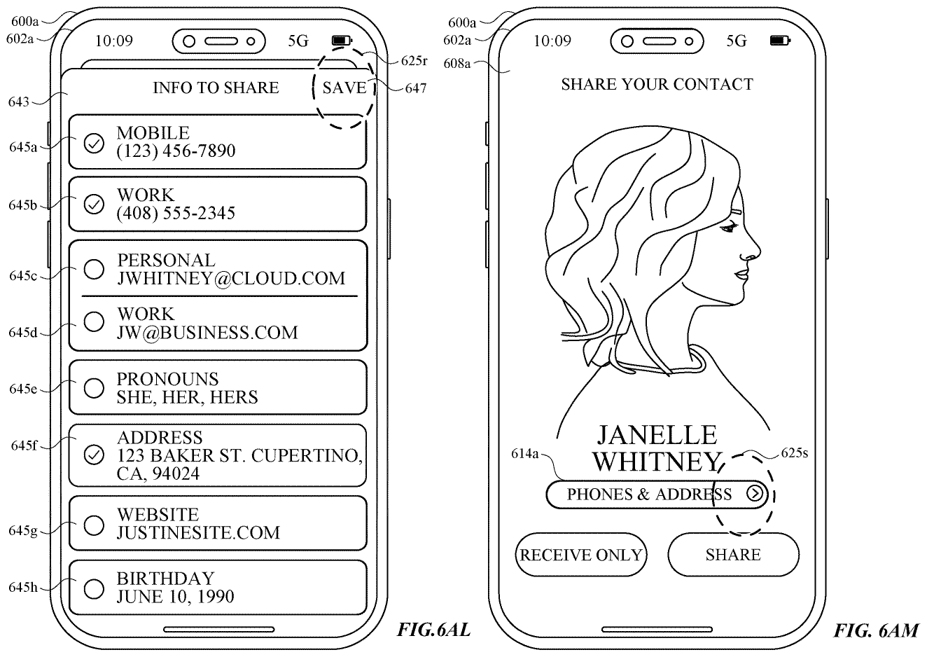

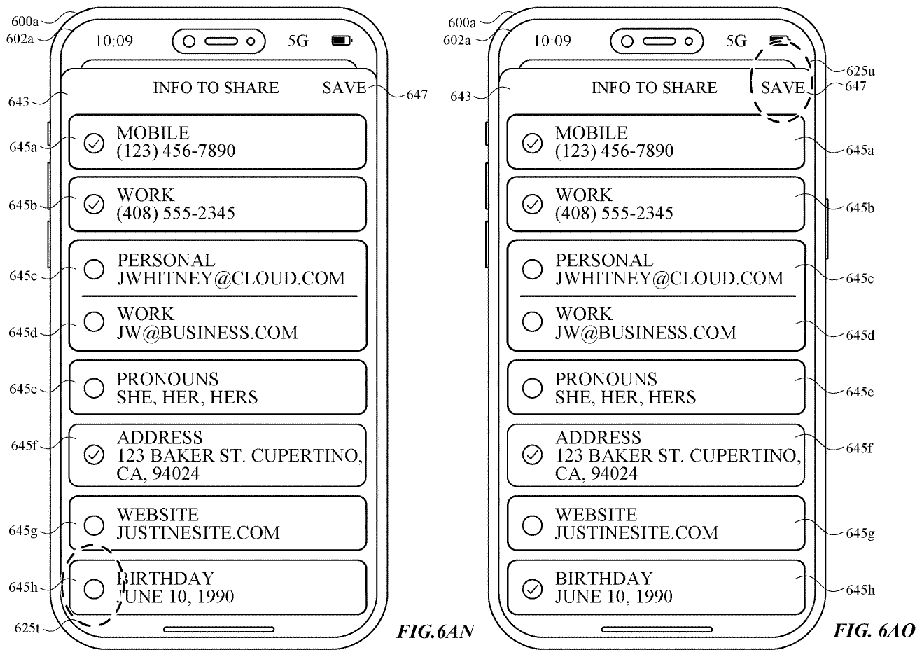

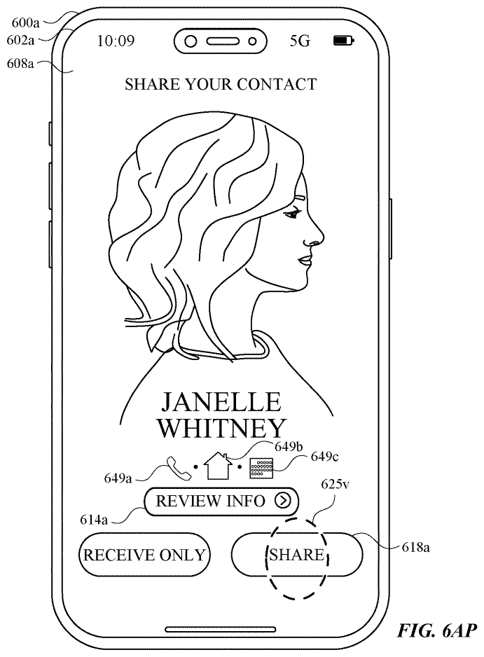

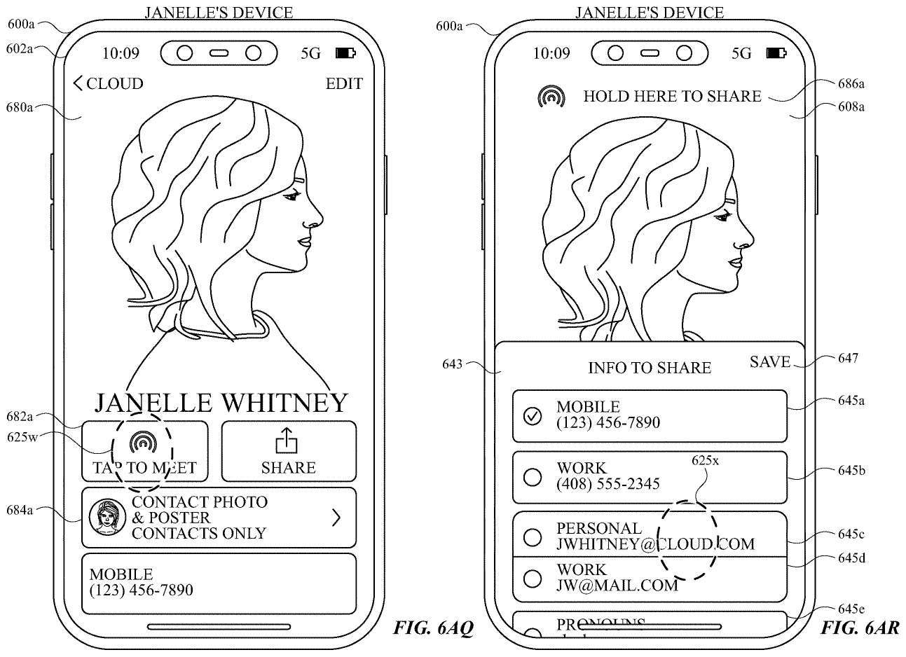

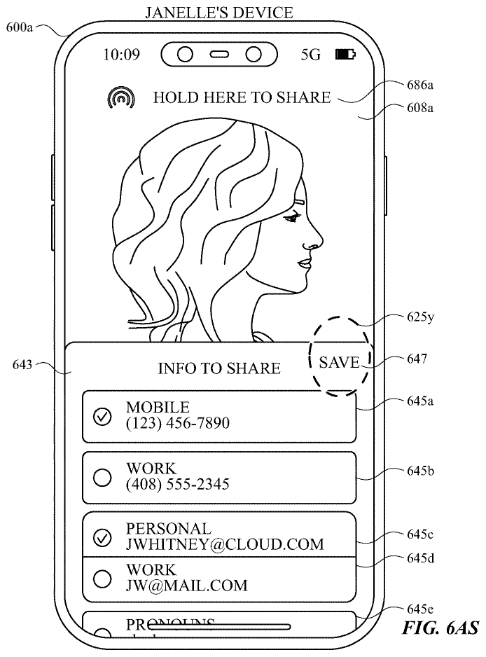

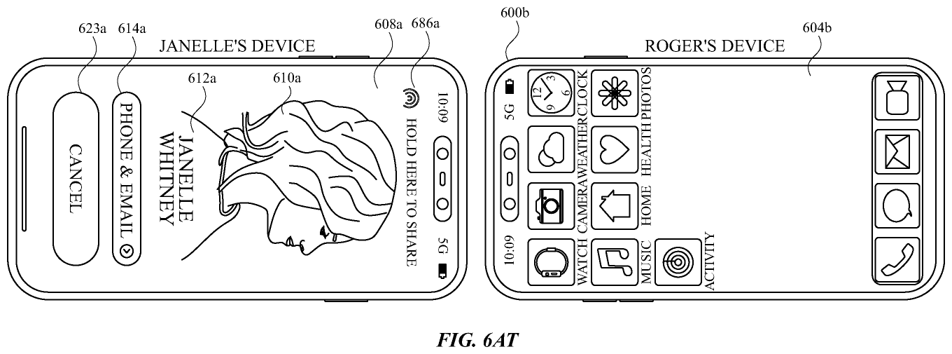

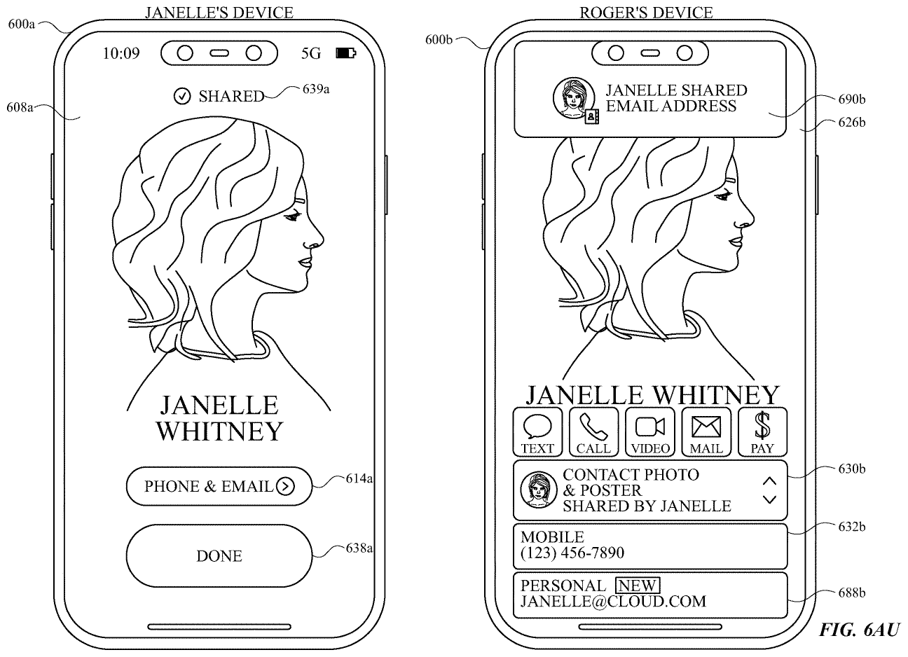

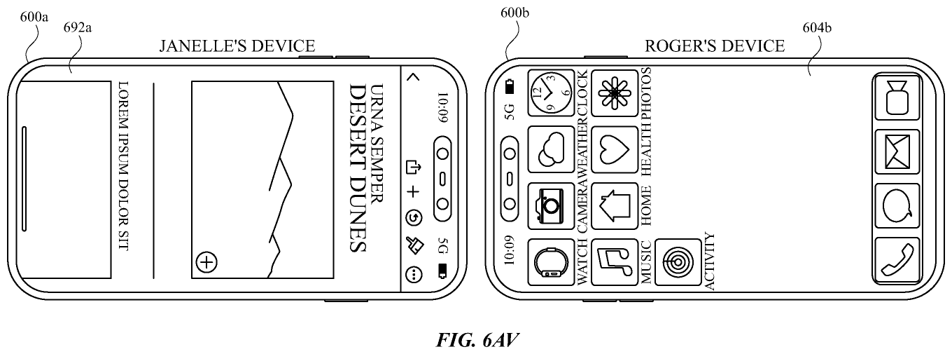

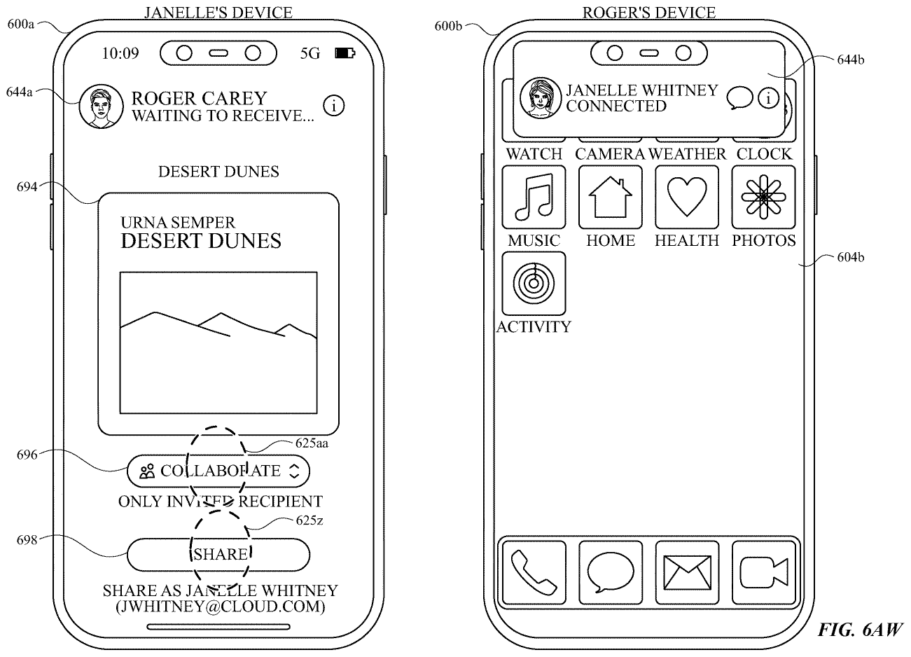

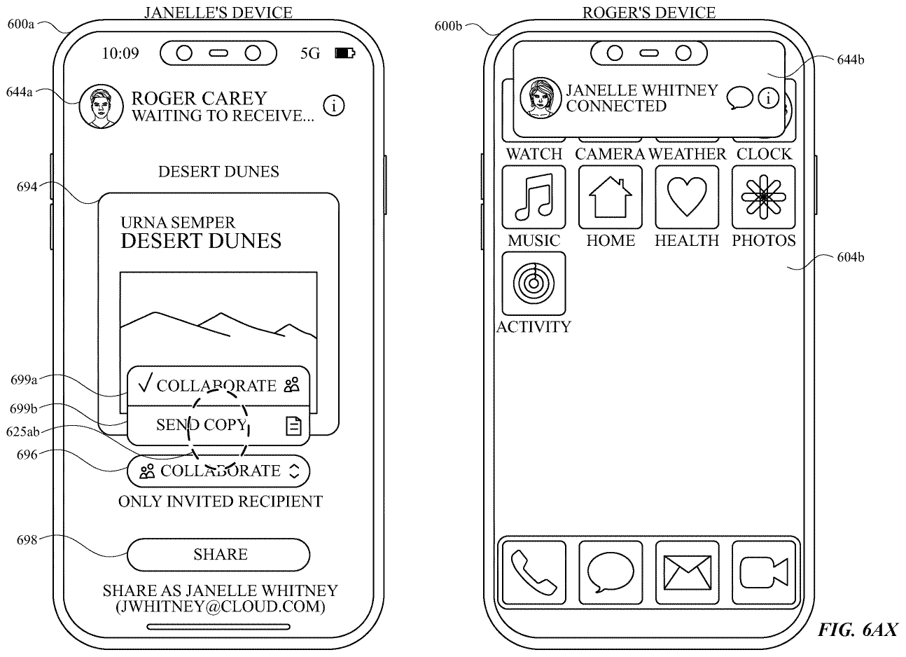

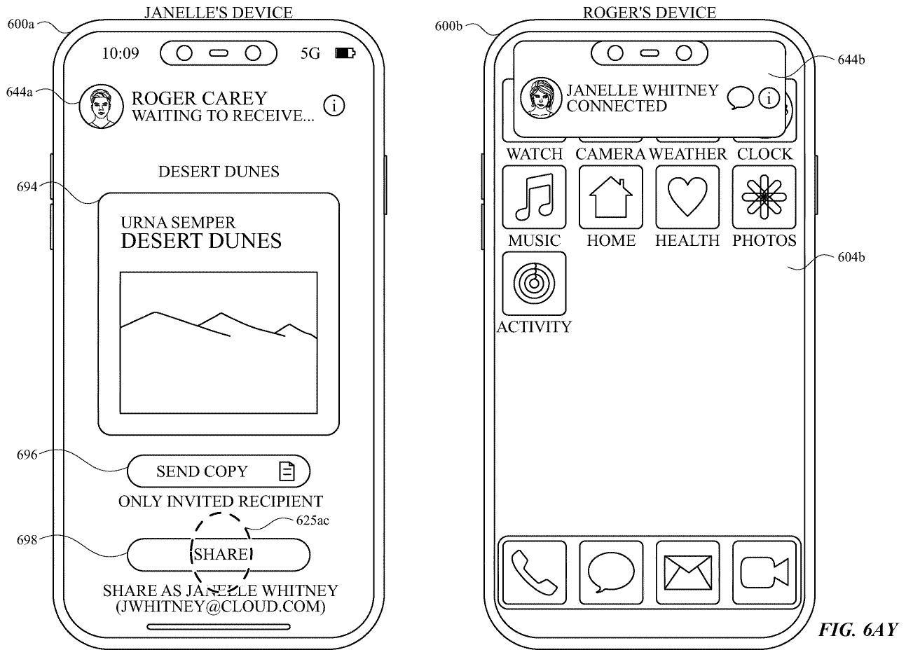

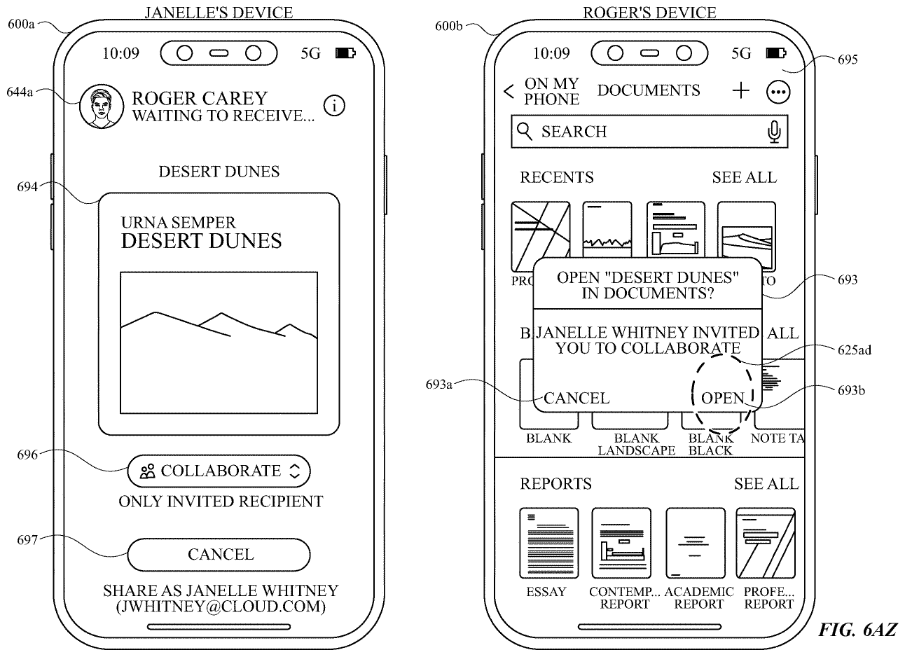

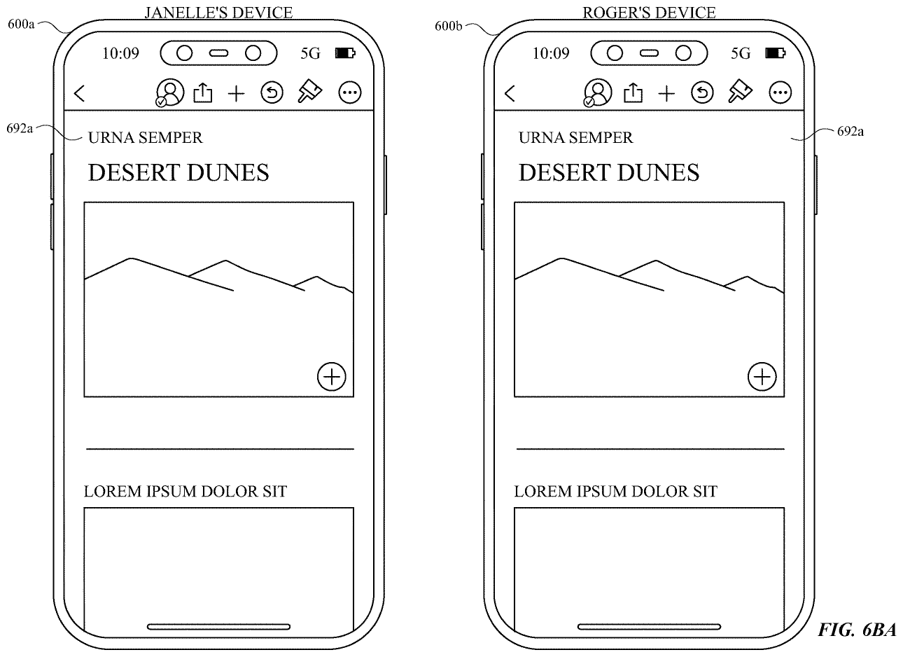

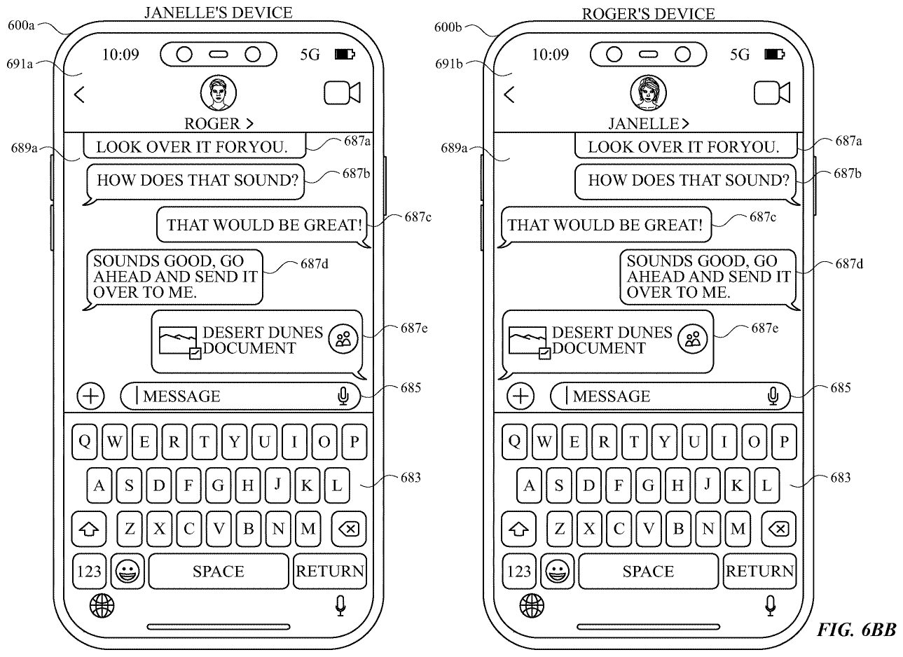

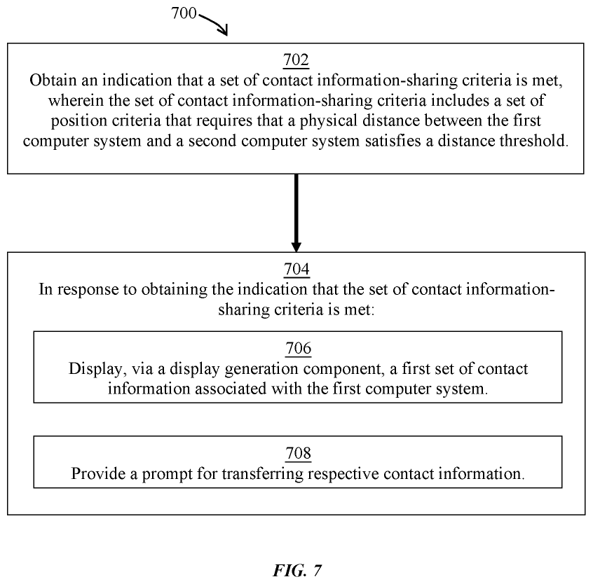

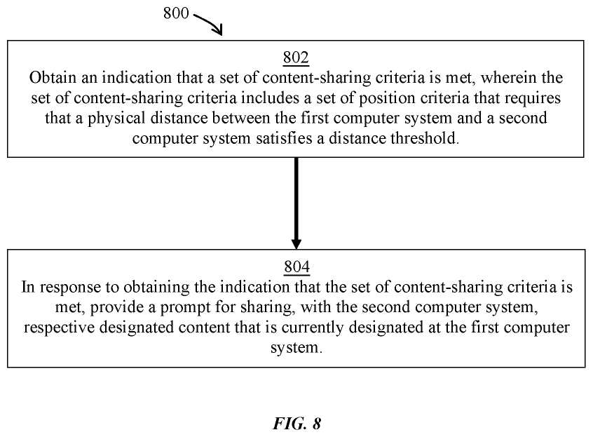

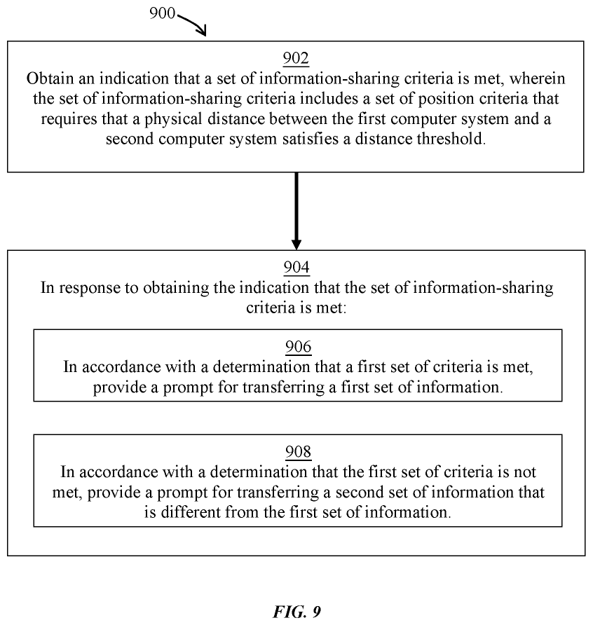

Below, FIGS. 1A-1B, 2, 3, 4A-4B, and 5A-5C provide a description of exemplary devices for performing the techniques for managing event notifications. FIGS. 6A-6BB illustrate exemplary user interfaces for transferring information. FIG. 7 is a flow diagram illustrating methods of transferring contact information in accordance with some embodiments. FIG. 8 is a flow diagram illustrating methods of transferring designated content in accordance with some embodiments. FIG. 9 is a flow diagram illustrating methods of transferring information in accordance with some embodiments. The user interfaces in FIGS. 6A-6BB are used to illustrate the processes described below, including the processes in FIGS. 7, 8, and 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, providing improved security, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random-access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

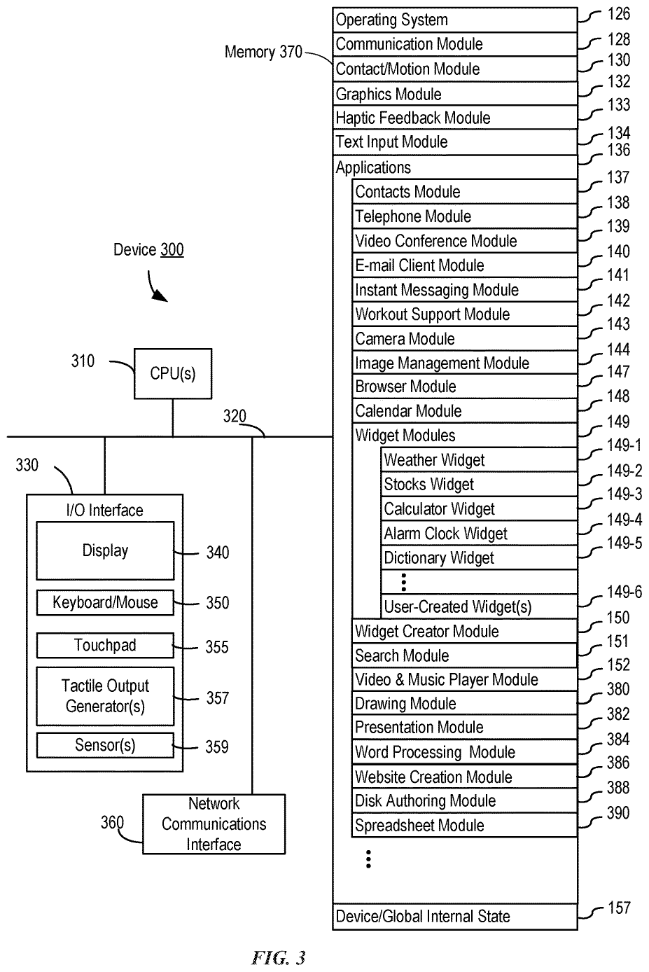

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random-access memory, such as DRAM, SRAM, DDR RAM, or other random-access solid-state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

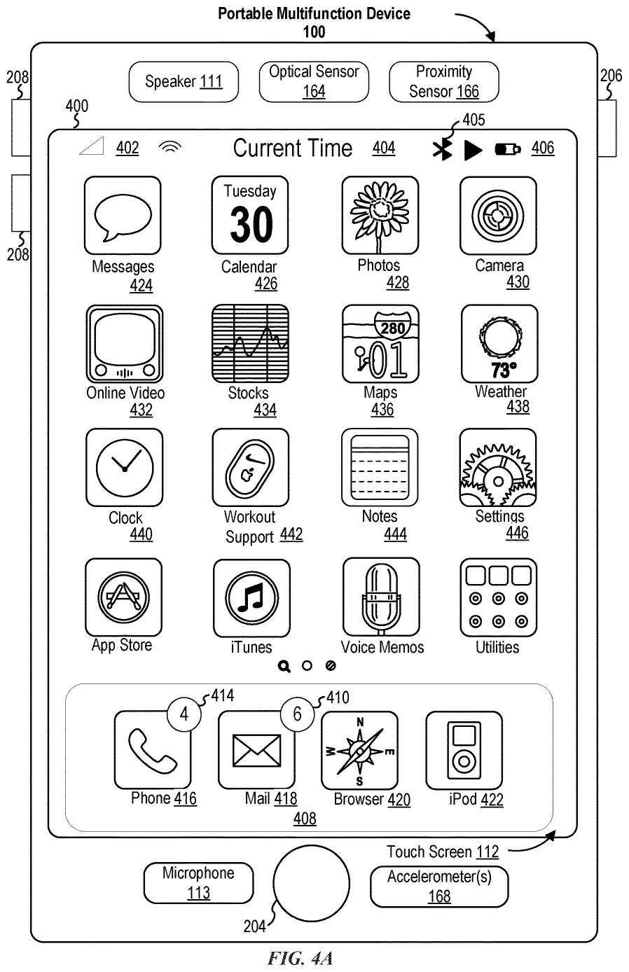

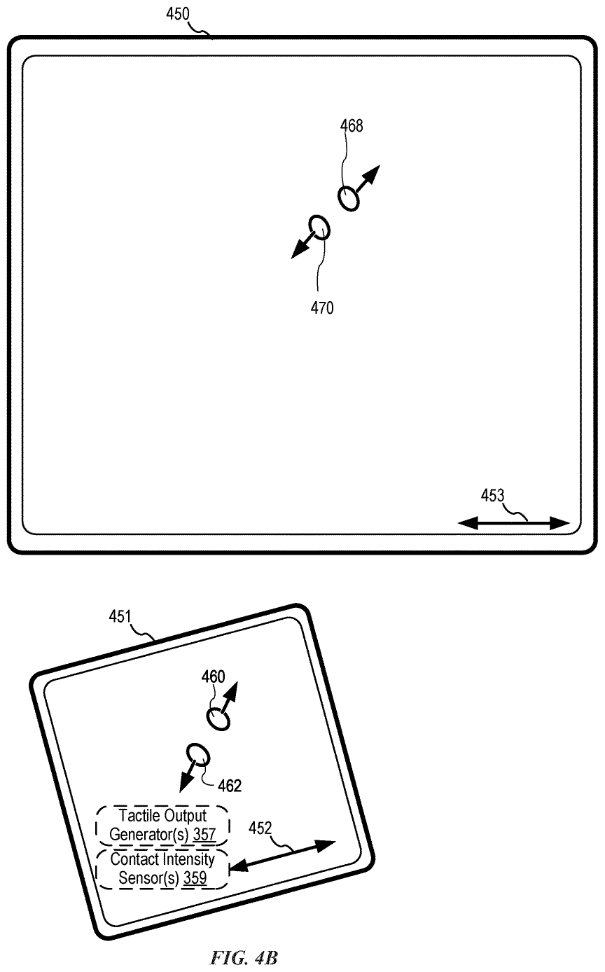

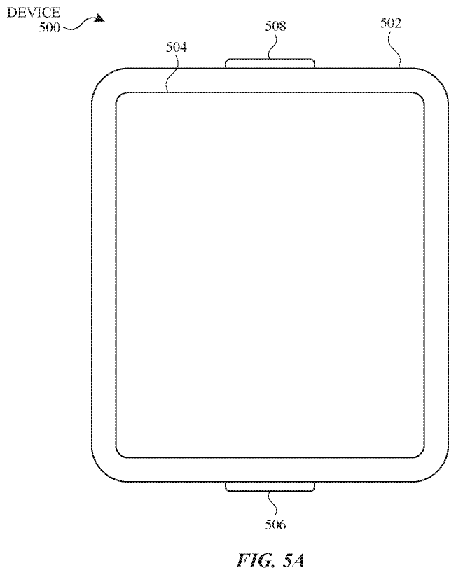

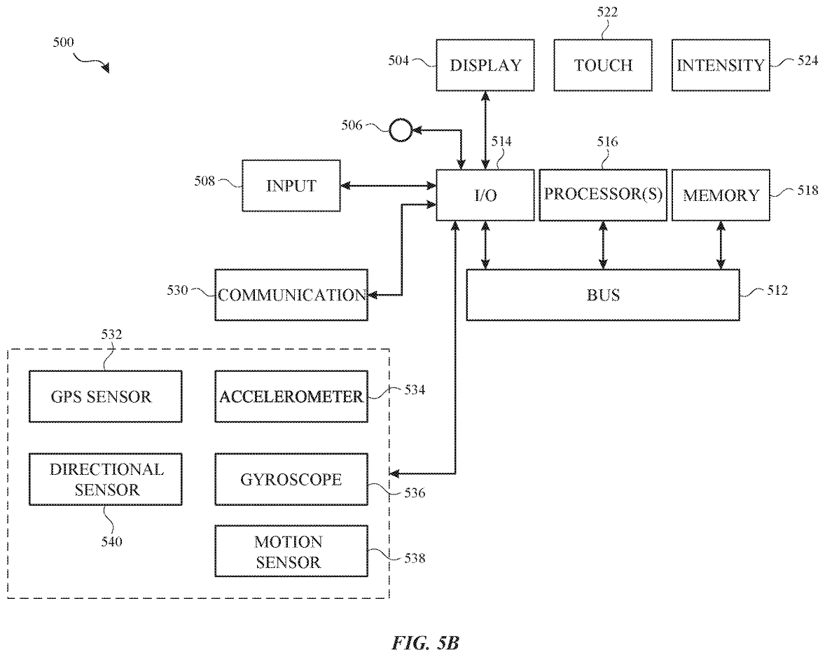

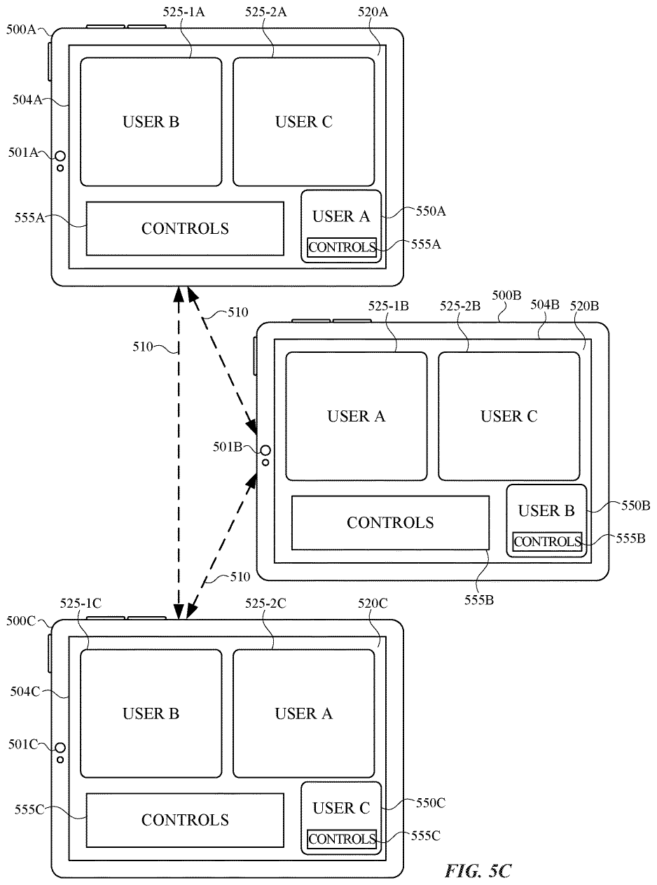

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including methods 700, 800, and 900 (FIGS. 7, 8, and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C depicts an exemplary diagram of a communication session between electronic devices 500A, 500B, and 500C. Devices 500A, 500B, and 500C are similar to electronic device 500, and each share with each other one or more data connections 510 such as an Internet connection, Wi-Fi connection, cellular connection, short-range communication connection, and/or any other such data connection or network so as to facilitate real time communication of audio and/or video data between the respective devices for a duration of time. In some embodiments, an exemplary communication session can include a shared-data session whereby data is communicated from one or more of the electronic devices to the other electronic devices to enable concurrent output of respective content at the electronic devices. In some embodiments, an exemplary communication session can include a video conference session whereby audio and/or video data is communicated between devices 500A, 500B, and 500C such that users of the respective devices can engage in real time communication using the electronic devices.

In FIG. 5C, device 500A represents an electronic device associated with User A. Device 500A is in communication (via data connections 510) with devices 500B and 500C, which are associated with User B and User C, respectively. Device 500A includes camera 501A, which is used to capture video data for the communication session, and display 504A (e.g., a touchscreen), which is used to display content associated with the communication session. Device 500A also includes other components, such as a microphone (e.g., 113) for recording audio for the communication session and a speaker (e.g., 111) for outputting audio for the communication session.

Device 500A displays, via display 504A, communication UI 520A, which is a user interface for facilitating a communication session (e.g., a video conference session) between device 500B and device 500C. Communication UI 520A includes video feed 525-1A and video feed 525-2A. Video feed 525-1A is a representation of video data captured at device 500B (e.g., using camera 501B) and communicated from device 500B to devices 500A and 500C during the communication session. Video feed 525-2A is a representation of video data captured at device 500C (e.g., using camera 501C) and communicated from device 500C to devices 500A and 500B during the communication session.

Communication UI 520A includes camera preview 550A, which is a representation of video data captured at device 500A via camera 501A. Camera preview 550A represents to User A the prospective video feed of User A that is displayed at respective devices 500B and 500C.

Communication UI 520A includes one or more controls 555A for controlling one or more aspects of the communication session. For example, controls 555A can include controls for muting audio for the communication session, changing a camera view for the communication session (e.g., changing which camera is used for capturing video for the communication session, adjusting a zoom value), terminating the communication session, applying visual effects to the camera view for the communication session, activating one or more modes associated with the communication session. In some embodiments, one or more controls 555A are optionally displayed in communication UI 520A. In some embodiments, one or more controls 555A are displayed separate from camera preview 550A. In some embodiments, one or more controls 555A are displayed overlaying at least a portion of camera preview 550A.

In FIG. 5C, device 500B represents an electronic device associated with User B, which is in communication (via data connections 510) with devices 500A and 500C. Device 500B includes camera 501B, which is used to capture video data for the communication session, and display 504B (e.g., a touchscreen), which is used to display content associated with the communication session. Device 500B also includes other components, such as a microphone (e.g., 113) for recording audio for the communication session and a speaker (e.g., 111) for outputting audio for the communication session.

Device 500B displays, via touchscreen 504B, communication UI 520B, which is similar to communication UI 520A of device 500A. Communication UI 520B includes video feed 525-1B and video feed 525-2B. Video feed 525-1B is a representation of video data captured at device 500A (e.g., using camera 501A) and communicated from device 500A to devices 500B and 500C during the communication session. Video feed 525-2B is a representation of video data captured at device 500C (e.g., using camera 501C) and communicated from device 500C to devices 500A and 500B during the communication session. Communication UI 520B also includes camera preview 550B, which is a representation of video data captured at device 500B via camera 501B, and one or more controls 555B for controlling one or more aspects of the communication session, similar to controls 555A. Camera preview 550B represents to User B the prospective video feed of User B that is displayed at respective devices 500A and 500C.

In FIG. 5C, device 500C represents an electronic device associated with User C, which is in communication (via data connections 510) with devices 500A and 500B. Device 500C includes camera 501C, which is used to capture video data for the communication session, and display 504C (e.g., a touchscreen), which is used to display content associated with the communication session. Device 500C also includes other components, such as a microphone (e.g., 113) for recording audio for the communication session and a speaker (e.g., 111) for outputting audio for the communication session.

Device 500C displays, via touchscreen 504C, communication UI 520C, which is similar to communication UI 520A of device 500A and communication UI 520B of device 500B. Communication UI 520C includes video feed 525-1C and video feed 525-2C. Video feed 525-1C is a representation of video data captured at device 500B (e.g., using camera 501B) and communicated from device 500B to devices 500A and 500C during the communication session. Video feed 525-2C is a representation of video data captured at device 500A (e.g., using camera 501A) and communicated from device 500A to devices 500B and 500C during the communication session. Communication UI 520C also includes camera preview 550C, which is a representation of video data captured at device 500C via camera 501C, and one or more controls 555C for controlling one or more aspects of the communication session, similar to controls 555A and 555B. Camera preview 550C represents to User C the prospective video feed of User C that is displayed at respective devices 500A and 500B.

While the diagram depicted in FIG. 5C represents a communication session between three electronic devices, the communication session can be established between two or more electronic devices, and the number of devices participating in the communication session can change as electronic devices join or leave the communication session. For example, if one of the electronic devices leaves the communication session, audio and video data from the device that stopped participating in the communication session is no longer represented on the participating devices. For example, if device 500B stops participating in the communication session, there is no data connection 510 between devices 500A and 500C, and no data connection 510 between devices 500C and 500B. Additionally, device 500A does not include video feed 525-1A and device 500C does not include video feed 525-1C. Similarly, if a device joins the communication session, a connection is established between the joining device and the existing devices, and the video and audio data is shared among all devices such that each device is capable of outputting data communicated from the other devices.

The embodiment depicted in FIG. 5C represents a diagram of a communication session between multiple electronic devices, including the real-time communication sessions described herein. In some embodiments, communication sessions include two or more electronic devices, even if other electronic devices participating in the communication session are not mentioned.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on a computer system, such as portable multifunction device 100, device 300, or device 500.

FIGS. 6A-6BB illustrate exemplary user interfaces for transferring information between computer systems, in accordance with some embodiments. The user interfaces in these figures are used to illustrate the processes described below, including the processes in FIGS. 7, 8, and 9.

FIGS. 6A-6BB illustrate techniques for sharing information between two computer systems. In some embodiments, if a proximity condition is satisfied (e.g., the two computer systems are within a threshold distance of each other) and at least one of the computer systems does not have contact information of the other computer system, user interfaces are provided for the computer systems to exchange contact information. Alternatively, if a proximity condition is satisfied and the computer systems have contact information of the other computer system, user interfaces are provided for the computer systems to exchange designated content (e.g., as long as the designated content is a type of content that can be shared). As described herein, if a first computer system includes contact information of the user of the second computer system (e.g., the user of the second computer system is in a contacts list of the first computer system), then the user of the second computer system is referred to as a known contact of the first computer system. Conversely, if a first computer system does not include contact information of a user of a second computer system, then the user of the second computer system is not a known contact of the first computer system.

FIG. 6A illustrates first computer system 600a and second computer system 600b. First computer system 600a displays home screen 604a on display 602a. Second computer system 600b displays lock screen 624b on display 602b. Lock screen 624b indicates that second computer system 600b is in a locked state (e.g., a user interface locked state in which only a predetermined set of functionalities is available). In FIG. 6A, the position of first computer system 600a relative to second computer system 600 does not satisfy a set of criteria for sharing information (e.g., a set of information-sharing criteria, a set of contact information-sharing criteria, and/or a set of content-sharing criteria).

In some embodiments, the set of criteria for sharing information requires that a distance between a portion (e.g., a near-field communication antenna) of first computer system 600a and a portion (e.g., a near-field communication antenna) of second computer system 600b satisfies a distance threshold. In some embodiments, the set of criteria for sharing information requires that the portion of first computer system 600a is in a predetermined orientation relative to the portion of second computer system 600b (e.g., that the portion of computer system 600a is aligned with the portion of second computer system 600b).

In the example illustrated in FIGS. 6A-6G, a user of second computer system 600b is not a known contact of first computer system 600a and/or a user of first computer system 600a is not a known contact of second computer system 600b.

In FIG. 6B, first computer system 600a and second computer system 600b are brought into closer proximity of each other to a position (e.g., location and/or orientation) that satisfies the set of criteria for sharing information. In the example illustrated in FIG. 6B, a top portion of first computer system 600a overlaps a top portion of second computer system 600b. As shown in FIG. 6B, computer system 606b is on top of or above computer system 606a. In some embodiments, the set of criteria for sharing information is met when computer system 606a is on top of or above computer system 606b or when computer system 606b is on top of or above computer system 606a. In response to obtaining an indication that the set of criteria for sharing information is met and because a user of second computer system 600b is not a known contact of first computer system 600a and/or a user of first computer system 600a is not a known contact of second computer system 600b, first computer system 600a displays notification 606a and second computer system 600b displays notification 606b. Notification 606a is displayed at the top portion of first computer system 600a that overlaps with second computer system 600b. Second computer system 600b displays notification 606b at the corresponding top portion of second computer system 600b. In some embodiments, first computer system 600a displays notification 606a for a predetermined amount of time and then automatically ceases display of notification 606a.

In FIG. 6C, first computer system 600a and second computer system 600b are separated from each other (e.g., the position of computer system 600a relative to computer system 600b no longer satisfies the set of criteria for sharing information). After initially displaying notification 606a, first computer system 600a ceases display of notification 606a and displays user interface 608a. In some embodiments, in response to the position of first computer system 600a relative to second computer system 600b satisfying the set of criteria for sharing information, first computer system 600a displays user interface 608a without displaying notification 606a.

User interface 608a includes prompt 620a to share contact information and a set of information about a user, Janelle Whitney, of first computer system 600a. The set of information includes representation 610a (e.g., a picture) of the user of first computer system 600a, a name 612a of the user of first computer system 600a (e.g., “Janelle Whitney”), and contact information 614a (e.g., a phone number such as “(123) 456-7890” and/or an email address) of the user of first computer system 600a. In some embodiments, representation 610a is a background of user interface 608a. In some embodiments, contact information 614a can be selected via user input (e.g., a tap on contact information 614a) to choose what information is to be shared with second computer system 600b (e.g., as described with reference to FIGS. 6V-6Y). In FIG. 6C, user interface 608a includes share option 618a and just receive option 616a. Selection of share option 618a enables first computer system 600a to share contact information of the user of first computer system 600a with second computer system 600b. Selection of just receive option 616a enables first computer system 600a to receive contact information of the user, Roger Carey, of second computer system 600b without sharing contact information of the user of first computer system 600a with second computer system 600b.

In FIG. 6C, second computer system 600b displays user interface 608b, which includes a set of information about the user of second computer system 600b. The set of information includes representation 610b (e.g., a picture) of the user of second computer system 600b. Because second computer system 600b is in a locked state, name 612b of the user of second computer system 600b (e.g., “Roger Carey”) and contact information 614b (e.g., a phone number) of the user of second computer system 600b are obscured (e.g., blurred out, greyed out, hidden, and/or not displayed). In some embodiments, representation 610b is a background of user interface 608b. In FIG. 6C, user interface 608b includes share option 618b and just receive option 616b. Selection of share option 618b enables second computer system 600b to share contact information of the user of second computer system 600b with first computer system 600a. Selection of just receive option 616b enables second computer system 600b to receive contact information of the user of first computer system 600a without sharing contact information of the user of second computer system 600b with first computer system 600a. In some embodiments, because second computer system 600b is in a locked state, second computer system 600b disables (e.g., greys out) or does not display just receive option 606b and/or share option 618b in user interface 608b.

Because second computer system 600b is in a locked state, second computer system 600b requires authentication before displaying name 612b and/or contact information 614b (e.g., for security purposes). In FIG. 6C, second computer system 600b displays authentication prompt 611, which prompts the user of second computer system 600b to perform an authentication process (e.g., facial identification and/or to position a face of the user so that the face of the user can be detected by one or more sensors of second computer system 600b).

In FIG. 6D, second computer system 600b indicates that the authentication process was successful by changing the appearance of authentication prompt 611 (e.g., displaying a smiley face or other indication of success). In response to a determination that authentication of the user of second computer system 600b was successful, second computer system 600b displays (e.g., reveals and/or un-obscures) name 612b of the user of second computer system 600b and contact information 614b of the user of second computer system 600b. In some embodiments, second computer system 600b displays just receive option 606b and/or share option 618b in response to the determination that authentication of the user of second computer system 600b was successful.

In FIG. 6D, first computer system 600a detects selection 625a of share option 618a (e.g., a tap on share option 618a and/or other input corresponding to selection of share option 618b). In response to detecting selection 625a of share option 618a, first computer system 600a displays waiting indicator 622a and cancel option 681a in user interface 608a, as shown in FIG. 6E. Waiting indicator 622a indicates that first computer system 600a is waiting for the process for sharing contact information to proceed. In some embodiments, first computer system 600a requires that a selection of either just receive option 616b or share option 618b is detected at second computer system 600b before the process for sharing contact information can proceed.

In FIG. 6E, second computer system 600b detects selection 625b of share option 618b. In response to detecting selection 625b of share option 618b, second computer system 600b displays waiting indicator 622b and cancel option 681b in user interface 608b, as shown in FIG. 6F. Waiting indicator 622b indicates that second computer system 600b is waiting for second computer system 600b to receive contact information of the user of first computer system 600a and/or for contact information of the user of second computer system 600b to be transferred to first computer system 600a. In FIG. 6F, first computer system 600a maintains display of waiting indicator 622a, which indicates that first computer system is waiting to receive contact information of the user of second computer system 600b and/or for contact information of the user of first computer system 600a to be transferred to second computer system 600b. In some embodiments, first computer system 600a and second computer system 600b transfer information between each other via near-field communication.

After the contact information of the user of first computer system 600a has been transferred to second computer system 600b, second computer system 600b displays user interface 626b (e.g., a contact card user interface), which includes contact information of the user of first computer system 600a. In some embodiments, second computer system 600b displays user interface 626b in response to receiving the contact information of the user of first computer system 600a. In some embodiments, the contact information includes name(s), phone number(s), email address(es), physical address(es), and/or other information.

Similarly, after the contact information of the user of second computer system 600b has been transferred to first computer system 600a, first computer system 600a displays user interface 626a (e.g., a contact card user interface), which includes contact information of the user of second computer system 600b. In some embodiments, first computer system 600a displays user interface 626a in response to receiving the contact information of the user of second computer system 600b.

In some embodiments, the operations described with reference to FIGS. 6B-6G are performed only if the user of first computer system 600a is not a known contact of second computer system 600b and the user of second computer system 600b is not a known contact of first computer system 600a (e.g., both users are not known contacts).

Turning to FIG. 6H, techniques for initiating the process for sharing contact information are illustrated. In FIG. 6H, first computer system 600a displays user interface 634a (e.g., a contact card), which includes contact information for the user of first computer system 600a. User interface 634a includes a representation (e.g., photo and/or name) of the user of first computer system 600a. User interface 634a can be scrolled to display additional information (e.g., phone number, email address, and/or physical address) of the user of first computer system 600a. User interface element 630a can be selected (e.g., via a tap input and/or other input selecting user interface element 630a) to open a menu for selecting the information that is transferred when contact information is shared with another computer system (e.g., the information that is shared with second computer system 600b in the process described with reference to FIGS. 6A-6G). In some embodiments, in response to detecting selection of user interface element 630a, first computer system 600a displays a user interface with some or all features described with reference to FIGS. 6V-6Y for selecting the contact information for transfer.

In FIG. 6H, first computer system 600a detects selection 625c of user interface element 636a. In response to detecting selection 625c of user interface element 636a, first computer system 600a activates a mode for transferring contact information to another computer system. For example, in response to detecting selection 625c of user interface element 636a, first computer system 600a displays user interface 608a described with reference to FIG. 6C.

While first computer system 600a is displaying user interface 608a, first computer system 600a and second computer system 600b are brought together as shown in FIG. 6I. In response to the position of first computer system 600a relative to second computer system 600b satisfying the set of criteria for sharing contact information, first computer system 600a and second computer system 600b initiate a process for transferring contact information. First computer system 600a displays (e.g., temporarily) notification 606a and then displays user interface 608a with waiting indicator 622a, as shown in FIG. 6J. Second computer system 600b displays (e.g., temporarily) notification 606b and then displays user interface 608b with prompt 620b to share contact information, just receive option 616b, and share option 618b, as shown in FIG. 6J.

In FIG. 6J, second computer system 600b detects selection 625d of just receive option 616b. In response to detection of selection 625d of just receive option 616b, second computer system 600b receives contact information of the user of first computer system 600a (e.g., according to the information selected by the user of first computer system 600a) and displays user interface 626b (as described with reference to FIG. 6G), as shown in FIG. 6K. Because just receive option 616b was selected at second computer system 600b in FIG. 6J, second computer system receives the contact information of the user of first computer system 600a without sharing contact information of the user of second computer system 600b.

In response to detection of selection 625d of just receive option 616b, first computer system 600a transfers the contact information of the user of first computer system 600a to second computer system 600b and displays user interface 608a as shown in FIG. 6K. In the example illustrated in FIG. 6K, user interface 608a includes indication 639a, which indicates that the contact information of the user of first computer system 600a was shared with second computer system 600b, and done option 638a that can be selected to cease display of user interface 608a. In contrast to the process described with reference to FIG. 6G, first computer system 600a does not display a user interface (e.g., user interface 626a) because just receive option 616b was selected in FIG. 6J instead of share option 618b.

In some embodiments, if just receive option 616a is selected in, e.g., FIG. 6C or 6D, then first computer system 600a is enabled to receive contact information of the user of second computer system 600b without transferring contact information of the user of computer system 600a. Similarly, in some embodiments, if just receive option 616b is selected in, e.g., FIGS. 6D-6E, then second computer system 600b is enabled to receive contact information of the user of first computer system 600b without transferring contact information of the user of computer system 600a. In some embodiments, if just receive option 616a and just receive option 616b are selected (e.g., in FIGS. 6C-6E), then neither first computer system 600a nor second computer system 600b receives nor transfers contact information.

Turning to FIGS. 6L-6S, techniques for sharing content other than contact information are described. In some embodiments, if first computer system 600a includes contact information of the user of second computer system 600b and second computer system 600b includes contact information of the user of first computer system 600a when first computer system 600a and second computer system 600b are brought together (e.g., like in FIGS. 6B and 6I), then first computer system 600a and second computer system 600b do not transfer contact information with each other. Instead, first computer system 600a and second computer system 600b can transfer other content, depending on the context in which first computer system 600a and second computer system 600b are operating. In FIGS. 6L-6S, first computer system 600a includes contact information of the user of second computer system 600b and second computer system 600b includes contact information of the user of first computer system 600a.

In FIG. 6L, first computer system 600a displays website 640a (e.g., in a web browser application), while second computer system 600b displays home screen 604b. In FIG. 6M, while first computer system 600a displays website 640a, first computer system 600a and second computer system 600b are brought together. In response to obtaining an indication that the set of criteria for sharing information is met, and because first computer system 600a includes contact information of the user of second computer system and second computer system 600b includes contact information of the user of first computer system 600a, first computer system 600a and second computer system 600b initiate a process for sharing content that is designated (e.g., displayed, in focus, and/or selected) at first computer system 600a. In FIG. 6M, because first computer system 600a is displaying a predetermined type of content (e.g., a website), first computer system 600a and second computer system 600b initiate a process for sharing website 640a with second computer system 600b (e.g., via near-field communication).

For example, in response to obtaining the indication that the set of criteria for sharing information is met, first computer system 600a displays representation 642a of website 640a, notification 644a, and share option 646. Notification 644a includes a representation (e.g., photo, avatar, initials, and/or name) of the user with which website 640a can be shared and an indication (e.g., “Transfer Content”) that the user is being prompted to share website 640a. In some embodiments, in response to detecting a selection of notification 644a (e.g., a tap on the “i” element in notification 644a), first computer system 600a displays more information (e.g., a contact card) of the user with which website 640a can be shared. Representation 642a includes a photo, graphical representation, textual description, or other indication of the content (e.g., website) that can be shared with second computer system 600b.

In response to obtaining the indication that the set of criteria for sharing information is met, second computer system 600b displays notification 644b, which informs the user of second computer system 600b that content from first computer system 600a can be transferred to second computer system 600b. In the example illustrated in FIG. 6N, notification 644b includes a representation (e.g., photo, avatar, initials, and/or name) of the user sharing the content and an indication (e.g., “Transfer Content”) that the user is being prompted to accept website 640a. In some embodiments, in response to detecting a selection of a portion of notification 644b (e.g., a tap on the “i” element in notification 644b), second computer system 600b displays more information (e.g., a contact card) of the user who is sharing website 640a.

In FIG. 6N, first computer system 600a detects selection 625e of share option 646. In response to detecting selection 625e of share option 646, first computer system 600a is enabled to transfer website 640a to second computer system 600b and displays (e.g., re-displays) website 640a (e.g., first computer system ceases display of notification 644a, representation 642a, and share option 646), as shown in FIG. 6O.

In FIG. 6N, second computer system 600b detects selection 625f of notification 644b. In response to detecting selection 625f of notification 644b, second computer system 600b is enabled to receive website 640a. Once first computer system is enabled to transfer website 640a and second computer system 600b is enabled to receive website 640a, website 640a is transferred to second computer system 600b, second computer system 600b displays instance 640b of website 640a, and first computer system 600a displays (e.g., re-displays) website 640a, as shown in FIG. 6O. In the example illustrated in FIG. 6O, displaying (e.g., re-displaying) website 640a includes ceasing display of (e.g., removing) notification 644a, representation 642a, and share option 646 and displaying instance 642b includes ceasing display of (e.g., removing) notification 644b. In FIG. 6O, computer system 600a displays user representation 673a corresponding to the user with whom the content was shared (e.g., the user of computer system 600b, Roger) and computer system 600b displays user representation 673b corresponding to the user from whom the content was received (e.g., the user of computer system 600a, Janelle). In some embodiments, user representation 673a and/or user representation 673b is displayed in a dynamic region of a user interface (e.g., a region of the user interface that changes shape and/or size over time, such as dynamic region 677a and/or dynamic region 677b). For example, in FIG. 6O, user representation 673a is displayed in dynamic region 677a on computer system 600a and user representation 673b is displayed in dynamic region 677b on computer system 600b. Dynamic region 677a and dynamic region 677b are not displayed on computer system 600a and computer system 600b, respectively, in, e.g., FIG. 6N. In some embodiments, computer system 600a and computer system 600b cease display of user representation 673a and user representation 673b, respectively, after a predetermined amount of time and/or when navigating to a different user interface (e.g., navigating away from the shared content).

FIG. 6P illustrates an example of sharing photo content. In FIG. 6P, first computer system 600a displays user interface 648, which includes one or more selected photos. In the example illustrated in FIG. 6P, six photos 648a-648f are selected. While displaying user interface 648, first computer system 600a and second computer system 600b are brought together (e.g., as shown in FIG. 6B, 6I, or 6M) such that the set of criteria for sharing information is met. In response to obtaining an indication that the set of criteria for sharing information is met, first computer system 600a displays notification 644a (e.g., as described with reference to FIG. 6N), graphical representation 650 of the photos selected for transfer, description 652 of the photos selected for transfer, and share photos option 654. In some embodiments, in response to obtaining an indication that the set of criteria for sharing information is met while first computer system 600a is displaying user interface 648, second computer system 600b displays notification 644b (e.g., as described with reference to FIG. 6N). In some embodiments, first computer system 600a detects selection of share option 654 and, in response, enables first computer system 600a to transfer the selected photos to second computer system 600b. Second computer system 600b detects selection of notification 644b and, in response, enables second computer system 600b to receive the selected photos. Once first computer system 600a is enabled to transfer the selected photos to second computer system 600b and second computer system 600b is enabled to receive the selected photos, first computer system 600a transfers the selected photos to second computer system 600b. In some embodiments, when second computer system 600b receives the selected photos, second computer system 600b displays a notification that the photos have been received and/or displays a representation of the photos (e.g., in a photo viewing application).

FIG. 6Q illustrates an example of sharing audio content (e.g., a song, album, and/or podcast). In FIG. 6Q, first computer system 600a displays user interface 656 of an audio player application, which includes a representation of a media item (e.g., a song) and options for controlling playback of the media item. While displaying user interface 656, first computer system 600a and second computer system 600b are brought together (e.g., as shown in FIG. 6B, 6I, or 6M) such that the set of criteria for sharing information is met. In response to obtaining an indication that the set of criteria for sharing information is met, first computer system 600a displays notification 644a (e.g., as described with reference to FIG. 6N), graphical representation 658 of the media item selected for transfer, description 659 of the media item selected for transfer, share album option 660, and play together option 662. First computer system 600a displays play together option 662 because the designated media item is a type of media that can be played in a synchronized media sharing session in which playback of the media item is synchronized between two or more computer systems. For example, when playback of the media item is synchronized between two or more computer systems, first computer system 600a plays the same portion of the media item at the same time as second computer system 600b and/or playback operations (e.g., start, stop, pause, rewind, fast forward, restart, and/or skip) performed at one computer system are implemented at the other computer systems in the media sharing session.

In some embodiments, in response to obtaining an indication that the set of criteria for sharing information is met while first computer system 600a is displaying user interface 656, second computer system 600b displays notification 644b (e.g., as described with reference to FIG. 6N).

In some embodiments, first computer system 600a detects selection of share option 660, and in response, enables first computer system 600a to transfer the selected media item to second computer system 600b. Second computer system 600b detects selection of notification 644b and, in response, enabled second computer system 600b to receive the selected media item. Once first computer system 600a is enabled to transfer the selected media item to second computer system 600b and second computer system 600b is enabled to receive the selected media item, first computer system 600a transfers the selected media item (or data representing the selected media item) to second computer system 600b.

In some embodiments, first computer system 600a detects selection of play together option 662 and, in response, enables first computer system 600a to initiate a synchronized media sharing session between first computer system 600a and second computer system 600b. Second computer system 600b detects selection of notification 644b and, in response, enabled second computer system 600b to join the synchronized media sharing session. Once first computer system 600a is enabled to initiate the synchronized media sharing session and second computer system 600b is enabled to join the synchronized media sharing session, the synchronized media sharing session is initiated between first computer system 600a and second computer system 600b with synchronized playback of the shared media item.

FIG. 6R illustrates an example of sharing video content (e.g., a TV show or a movie). In FIG. 6R, first computer system 600a displays user interface 664 of a video player application, which includes a representation (e.g., an information screen) of a video media item (e.g., a TV show). While displaying user interface 664, first computer system 600a and second computer system 600b are brought together (e.g., as shown in FIG. 6B, 6I, or 6M) such that the set of criteria for sharing information is met. In response to obtaining an indication that the set of criteria for sharing information is met, first computer system 600a displays notification 644a (e.g., as described with reference to FIG. 6N), graphical representation 666 of the video media item, description 667 of the video media item, share option 668, and play together option 670. First computer system 600a displays play together option 670 because the designated video media item is a type of media that can be played in a synchronized media sharing session in which playback of the video media item is synchronized between two or more computer systems. For example, when playback of the video media item is synchronized between two or more computer systems, first computer system 600a plays the same portion of the video media item at the same time as second computer system 600b and/or playback operations (e.g., start, stop, pause, rewind, fast forward, restart, and/or skip) performed at one computer system are implemented at the other computer systems in the media sharing session.

In some embodiments, in response to obtaining an indication that the set of criteria for sharing information is met while first computer system 600a is displaying user interface 664, second computer system 600b displays notification 644b (e.g., as described with reference to FIG. 6N).

In some embodiments, first computer system 600a detects selection of share option 668 and, in response, enables first computer system 600a to transfer the designated video media item to second computer system 600b. Second computer system 600b detects selection of notification 644b and, in response, enabled second computer system 600b to receive the designated video media item. Once first computer system 600a is enabled to transfer the designated video media item to second computer system 600b and second computer system 600b is enabled to receive the video media item, first computer system 600a transfers the video media item (or data representing the video media item) to second computer system 600b.

In some embodiments, first computer system 600a detects selection of play together option 670 and, in response, enables first computer system 600a to initiate a synchronized media sharing session between first computer system 600a and second computer system 600b. Second computer system 600b detects selection of notification 644b and, in response, enables second computer system 600b to join the synchronized media sharing session. Once first computer system 600a is enabled to initiate the synchronized media sharing session and second computer system 600b is enabled to join the synchronized media sharing session, the synchronized media sharing session is initiated between first computer system 600a and second computer system 600b with synchronized playback of the video media item.

FIG. 6S illustrates an example of sharing editable content such as, e.g., a presentation, word processing document, and/or other content that can be edited. In FIG. 6S, first computer system 600a displays user interface 672 of a word processing application, which includes content area 672a and keyboard 672b. Content in content area 672a can be editing using keyboard 672b and/or other functions of user interface 672. While displaying user interface 672, first computer system 600a and second computer system 600b are brought together (e.g., as shown in FIG. 6B, 6I, or 6M) such that the set of criteria for sharing information is met. In response to obtaining an indication that the set of criteria for sharing information is met, first computer system 600a displays notification 644a (e.g., as described with reference to FIG. 6N), graphical representation 674 of the editable content, description 675 of the editable content, share option 676, and collaborate option 678. First computer system 600a displays collaborate option 678 because the editable content is a type of content that can be edited (e.g., in real time) in a collaborative editing session in which the editable content can be viewed and/or edited by two or more computer systems. For example, in the collaborative editing session, when an edit to the editable content is made at first computer system 600a, the edit is displayed in a view of the editable content at second computer system 600b.

In some embodiments, in response to obtaining an indication that the set of criteria for sharing information is met while first computer system 600a is displaying user interface 672, second computer system 600b displays notification 644b (e.g., as described with reference to FIG. 6N).

In some embodiments, first computer system 600a detects selection of share option 676 and, in response, enables first computer system 600a to transfer a copy of the editable content to second computer system 600b. Second computer system 600b detects selection of notification 644b and, in response, enables second computer system 600b to receive a copy of the editable content. Once first computer system 600a is enabled to transfer the copy of the editable content to second computer system 600b and second computer system 600b is enabled to receive the copy of the editable content, first computer system 600a transfers the copy of the editable content (or data representing the editable content) to second computer system 600b.

In some embodiments, first computer system 600a detects selection of collaborate option 678 and, in response, enables first computer system 600a to initiate a collaborative editing session between first computer system 600a and second computer system 600b. Second computer system 600b detects selection of notification 644b and, in response, enables second computer system 600b to join the collaborative editing session. Once first computer system 600a is enabled to initiate the collaborative editing session and second computer system 600b is enabled to join the collaborative editing session, the collaborative editing session is initiated between first computer system 600a and second computer system 600b, with the editable content provided for editing.

In FIGS. 6A-6S, different operations are described with reference to first computer system 600a than for second computer system 600b. In some embodiments, second computer system 600b can perform any or all operations performed by first computer system 600a described with reference to FIGS. 6A-6S; and first computer system 600a can perform any or all operation performed by computer system 600b described with reference to FIGS. 6A-6S.

Turning to FIGS. 6T-6AI, techniques for sharing contact information are described. FIG. 6T illustrates computer system 600c displaying user interface 601a on display 602c. In the example illustrated in FIG. 6T, computer system 600c is a smartwatch and user interface 601a is a watch face. In some embodiments, computer system 600c is a smartphone, tablet computer, or other type of computer system. In some embodiments, user interface 601a is a home screen, wake screen, or other user interface.

In FIG. 6T, user interface 601a includes an indication of time (e.g., an analog indication of time) and selectable user interface element 603 (e.g., a watch face complication). Computer system 600c detects selection 625g of user interface element 603 and, in response, initiates a process for sharing contact information of a user of computer system 600c. As shown in FIG. 6U, in response to detecting selection 625g of user interface element 603, computer system 600c displays (e.g., temporarily) user interface 605a, which indicates that computer system 600c has initiated the process for sharing contact information. In some embodiments, user interface 605a is analogous to (e.g., includes any or all features of) notification 606a and/or notification 606b described above.

After displaying user interface 605a, computer system 600c displays user interface 607 shown in FIG. 6V, which includes a representation and contact information of a user associated with computer system 600c. In the embodiment illustrated in FIGS. 6T-6AI, since computer system 600c is associated with the same user (e.g., Janelle Whitney) as first computer system 600a, user interface 607 includes representation 610a and name 612a described above. User interface 607 includes user interface element 609a, which displays an indication of the contact information selected for sharing. In FIG. 6V, user interface element 609a indicates that a phone number is selected for sharing.

In response to detecting selection 625h of user interface element 609a, computer system 600c displays information selection user interface 641 shown in FIG. 6W. Information selection user interface 641 includes phone number option 613 and email address option 615. Because the phone number was already selected for sharing (as indicated by user interface element 609a), phone number option 613 includes a selected indicator (e.g., a check mark). Email address option 615 does not include the selected indicator because the email address of the user of computer system 600c is not currently selected for sharing.

In response to detecting selection 625i of email address option 615, computer system 600c includes the email address in the information for sharing and displays a selected indicator (e.g., a check mark) in email address option 615, as shown in FIG. 6X. In FIG. 6X, computer system 600c detects selection 625j of done option 617. In response to detecting selection 625j of done option 617, computer system 600c displays (e.g., re-displays) user interface 607a, as shown in FIG. 6Y. Because the phone number and email address of the user of computer system 600c are selected for sharing, user interface element 609a has been updated to indicate that the phone number and email address are selected for sharing.

In FIG. 6Y, computer system 600c detect scroll input 625k (e.g., a tap and drag or swipe input). In response to detecting scroll input 625k, computer system 600c scrolls user interface 607a to display share option 619a and not now option 621a, shown in FIG. 6Z. In response to detecting selection 625l of share option 619a, computer system 600c displays instructions 627 for sharing the selected contact information with another computer system in user interface 623, as shown in FIG. 6AA. Instructions 627 include textual instructions (e.g., “Hold near watch or phone”) and graphical illustration of representation 623b of computer system 600c being placed in proximity with representation 623a of another computer system. In some embodiments, the graphical illustration includes an animation of representation 623a and representation 623b coming together.

In some embodiments, computer system 600c can transfer information to different types of computer systems. In FIG. 6AA, the textual portion of instructions 627 indicate that computer system 600c can transfer information to a watch or a phone, and representation 623a illustrates a watch computer system. To indicate that computer system 600c can transfer information to a phone, computer system 600c updates instructions 627 (e.g., via an animation) to replace representation 623a of the watch with representation 623c of a phone, as shown in FIG. 6AB.

Turning to FIG. 6AC, computer system 600c is shown displaying user interface 623 and another computer system 600d (e.g., a watch computer system) is shown displaying user interface 601b (e.g., a watch face with an indication of time). In FIG. 6AD, computer system 600c and computer system 600d are brought together (e.g., as shown in user interface 623 in FIG. 6AA) such that the set of criteria for sharing information is met. In response to obtaining an indication that the set of criteria for sharing information is met, computer system 600c displays user interface 607a and computer system 600d displays user interface 607b. User interface 607a is the same as described in FIG. 6Y, except that waiting indicator 622c is displayed (e.g., instead of a prompt, such as “Share Contact”) to indicate that computer system 600c is prepared to share contact information with computer system 600d.

In the example illustrated in FIGS. 6AC-6AI, computer system 600d is associated with the same user as second computer system 600b described above. Since computer system 600d is associated with the user of second computer system 600b, user interface 607b displayed on computer system 600d includes representation 610b and representation 612b described with reference to FIGS. 6C and 6D, as well as user interface element 609b, which indicates the contact information that is selected for sharing. In FIG. 6AE, computer system 600d detects scroll input 625m and, in response, scrolls user interface 607b to display share option 619b and just receive option 629b, as shown in FIG. 6AF. Share option 619b is analogous to (e.g., causes computer system 600d to perform the same operation as) share option 618a and share option 618b. Just receive option 629b is analogous to (e.g., causes computer system 600d to perform the same operation as) just receive option 616a and just receive option 616b.

In response to detecting selection 625n of share option 619b, computer system 600d initiates sharing contact information of the user of computer system 600d with computer system 600c and displays a waiting indicator (e.g., the same as or similar to 622c) in share option 619b, as shown in FIG. 6AG. As sharing continues, computer system 600d displays user interface 607b, as shown in FIG. 6AH. In FIG. 6AH, user interface 607b is the same as in FIG. 6AE, except with waiting indicator 622d (e.g., instead of “Share Contact”). After sharing is complete (e.g., computer system 600c has received contact information of the user of computer system 600d and computer system 600d has received contact information of the user of computer system 600c), computer system 600c displays user interface 631a (e.g., a contact card) and computer system 600d displays user interface 631b.

User interface 631a includes representation 610b (e.g., a representative image as described with reference to FIG. 6C) of the user of computer system 600d and selectable options for communicating with the user of computer system 600d. For example, in response to detecting selection of messaging option 633a, computer system 600c initiates a text message to the user of computer system 600d; in response to detecting selection of phone call option 635a, computer system 600c initiates a phone call to the user of computer system 600d; and in response to detecting selection of menu option 637a, computer system 600c displays additional information of (and/or options for communicating with) the user of computer system 600d.

User interface 631b includes representation 610a (e.g., a representative image as described with reference to FIG. 6C) of the user of computer system 600c and selectable options for communicating with the user of computer system 600c. For example, in response to detecting selection of messaging option 633b, computer system 600d initiates a text message to the user of computer system 600c; in response to detecting selection of phone call option 635b, computer system 600d initiates a phone call to the user of computer system 600c; and in response to detecting selection of menu option 637b, computer system 600d displays additional information of (and/or options for communicating with) the user of computer system 600c.

Turning to FIG. 6AJ, first computer system 600a displays an embodiment of user interface 608a. In some embodiments, first computer system 600a displays user interface 608a shown in FIG. 6AJ in response to the position of first computer system 600a relative to second computer system 600b satisfying the set of criteria for sharing information. In FIG. 6AJ, contact information 614a indicates that a single phone number is currently selected to be shared (e.g., in response to selection of share option 618a). In response to detecting input 6250 on contact information 614a, first computer system 600a displays information selection user interface 643, which includes information options 645a-645h, as shown in FIG. 6AK.

In FIG. 6AK, information option 645a is selected (e.g., as was indicated by contact information 614a in FIG. 6AJ). In FIG. 6AK, first computer system 600a detects input 625p selecting information option 645b corresponding to a work phone number associated with the user of first computer system 600a and detects input 625q selecting information option 645f corresponding to an address (e.g., a physical home address) associated with the user of first computer system 600a. As shown in FIG. 6AL, in response to detecting input 625p, first computer system 600a designates information option 645b (e.g., while maintaining selection of information option 645a); and in response to detecting input 625q, first computer system 600a designates information option 645f (e.g., while maintaining selection of information option 645a).

In response to detecting input 625r selecting save option 647, first computer system 600a displays (e.g., re-displays and/or returns to) user interface 608a as shown in FIG. 6AM. In FIG. 6AM, contact information 614a is updated to reflect the information selected to be transferred to second computer system 600b (e.g., the information corresponding to the information options designated in information selection user interface 643). For example, because more than one phone number is selected (e.g., the mobile phone number corresponding to information option 645a and the work phone number corresponding to information option 645b), contact information 614a includes the indication “PHONES”; and because an address is selected (e.g., the address corresponding to information option 645f), contact information 614a includes the indication “ADDRESS”.

In some embodiments, the information corresponding to the information options designated in information selection user interface 643 is automatically used the next time that the position of first computer system 600a relative to second computer system 600b (or another computer system) satisfies the set of criteria for sharing information (e.g., without the user having to re-select the mobile phone number corresponding to information option 645a and the work phone number corresponding to information option 645b) (e.g., the information options designated in information selection user interface 643 are persistent and/or remain selected after the information is transferred to second computer system 600b). For example, after detecting input 625r selecting save option 647, in response to the position of first computer system 600a relative to second computer system 600b (or another computer system) satisfying the set of criteria for sharing information, the mobile phone number corresponding to information option 645a, the work phone number corresponding to information option 645b, and the address corresponding to information option 645f are automatically selected to be transferred to second computer system 600b (or another computer system) and first computer system 600a displays user interface 608a as shown in FIG. 6AM, including contact information 614a with “PHONES & ADDRESS”.

In FIG. 6AM, first computer system 600a detects input 625s selecting contact information 614a. In response to detecting input 625s, first computer system 600a displays (e.g., re-displays) information selection user interface 643 with information options 645a-645h, as shown in FIG. 6AN. In FIG. 6AN, first computer system 600a detects input 625t selecting information option 645g corresponding to a birthdate associated with the user of first computer system 600a (e.g., while maintaining selection of information option 645a, information option 645b, and information option 645f). In response to detecting input 625t, first computer system 600a designates information option 645g as shown in FIG. 6AO.

In response to detecting input 625u selecting save option 647, first computer system 600a displays (e.g., re-displays and/or returns to) user interface 608a as shown in FIG. 6AP. In FIG. 6AP, contact information 614a is updated to reflect the information selected to be transferred to second computer system 600b (e.g., the information corresponding to the information options designated in information selection user interface 643). For example, because more than two types of information are selected (e.g., one or more phone numbers, one or more addresses, and one or more dates), contact information 614a includes a generic indication (e.g., “REVIEW INFO”) that indicates that contact information 614a can be selected to view and/or select the information to be transferred to second computer system 600b (e.g., in response to detecting selection of share option 618a). In the embodiment shown in FIG. 6AP, first computer system 600a displays icons corresponding to the types of information selected to be transferred to second computer system 600b. For example, because one or more phone numbers are selected, first computer system 600a displays phone icon 649a; because one or more addresses are selected, first computer system 600a displays address icon 649b; and because one or more dates are selected, first computer system 600a displays calendar icon 649c. In response to detecting input 625v selecting share option 618a, first computer system 600a initiates a process for transferring the information selected in information selection user interface 643 to second computer system 600b (e.g., as described with reference to FIGS. 6D-6G).

FIG. 6AQ illustrates an embodiment of a user interface 680a (e.g., a contact card) that includes information about the user of first computer system 600a. User interface 680a includes a representation (e.g., photo and/or name) of the user of first computer system 600a. User interface 680a can be scrolled to display additional information (e.g., phone number, email address, and/or physical address) of the user of first computer system 600a. User interface element 684a can be selected (e.g., via a tap input and/or other input selecting user interface element 630a) to open a menu (e.g., information selection user interface 643) for selecting the information that is transferred when contact information is shared with another computer system (e.g., the information that is shared with second computer system 600b in the process described with reference to FIGS. 6A-6G described above and/or FIGS. 6AT-6AU described below). In some embodiments, in response to detecting selection of user interface element 684a, first computer system 600a displays a user interface with some or all features described with reference to FIGS. 6V-6Y for selecting the contact information for transfer.

In FIG. 6AQ, first computer system 600a detects selection 625w of user interface element 682a (e.g., a tap and/or other input selecting user interface element 682a). In response to detecting selection 625w of user interface element 682a, first computer system 600a activates a mode for transferring contact information to another computer system. For example, in response to detecting selection 625w of user interface element 682a, first computer system 600a displays user interface 608a, with prompt 686a, and information selection user interface 643 as shown in FIG. 6AR. Prompt 686a includes an indication of a position to hold another computer system (e.g., second computer system 600b) to share contact information associated with first computer system 600a. In some embodiments, user interface 608a, prompt 686a, and/or information selection user interface 643 are displayed in response to detecting selection (e.g., selection 625c) of user interface element 636a shown in FIG. 6H.

While first computer system 600a is displaying information selection user interface 643 as shown in FIG. 6AR, first computer system 600a detects selection 625x of information option 645c (e.g., a tap and/or other input selecting information option 645c) corresponding to an email address (e.g., a personal email address) associated with the user of first computer system 600a. In response to detecting selection 625x, first computer system 600a visually indicates (e.g., with a checkmark) that information option 645c has been selected, as shown in FIG. 6AS. In some embodiments, in to detecting selection 625x, first computer system 600a selects and/or designates the information associated with information option 645c to be shared with another computer system if the set of criteria for sharing information is satisfied.

In FIG. 6AS, first computer system 600a detects selection 625y of save option 647 (e.g., a tap and/or other input selecting save option 647). In response to detecting selection 625y, first computer system 600a ceases display of information selection user interface 643 and displays user interface 608a as shown in FIG. 6AT. In FIG. 6AT, contact information 614a indicates that phone number and email information (e.g., corresponding to information option 645a and information option 645c selected in information selection user interface 643 in FIG. 6AS) are currently selected to be shared.

In FIG. 6AT, first computer system 600a and second computer system 600b are brought together. In response to the position of first computer system 600a relative to second computer system 600b satisfying the set of criteria for sharing contact information, first computer system 600a and second computer system 600b initiate a process for transferring contact information, as illustrated in FIG. 6AU. In the embodiment illustrated in FIGS. 6AT-6AU, when first computer system 600a and second computer system 600b are brought together, second computer system 600b already includes the phone number associated with first computer system 600a corresponding to information option 645a (e.g., the user of computer system 600a is a known contact to second computer system 600b) but second computer system 600b does not include the email information corresponding to information option 645c. Because the email information corresponding to information option 645c has been selected to be shared and second computer system 600b includes contact information for the user of first computer system 600a but does not include the email information, the email information is automatically shared with second computer system 600b (e.g., because the user of first computer system 600a is already known to second computer system 600b).

First computer system 600a indicates that contact information has been shared by displaying indication 639a, which indicates that contact information of the user of first computer system 600a was shared with second computer system 600b, and by displaying done option 638a, which can be selected to cease display of user interface 608a. Second computer system 600b indicated that contact information has been shared by displaying indication 690b (e.g., a notification) and information element 688b. Indication 690b identifies (e.g., with an icon and/or text) that an email address has been shared, and information element 688b includes an indication (e.g., a badge, tag, and/or text, such as “NEW”), which indicates that the information indicated in information element 688b is newly shared information. In some embodiments, if second computer system 600b does not include contact information (e.g., does not include any contact information) for the user of first computer system 600a when first computer system 600a and second computer system 600b are brought together as shown in FIG. 6AT, then first computer system 600a and second computer system 600b perform the operations described with reference to FIGS. 6I-6J (e.g., except with the email address corresponding to information option 645c selected to be shared). In some embodiments, if second computer system 600b includes all of the contact information of the user of first computer system 600a selected to be transferred (e.g., all the information selected in information selection user interface 643 and/or indicated by contact information 614a) when first computer system 600a and second computer system 600b are brought together as shown in FIG. 6AT, then first computer system 600a forgoes transferring (or initiating a process for transferring) contact information to second computer system 600b.

FIGS. 6AV-6BB illustrate techniques for sharing content on which first computer system 600a and second computer system 600b can collaborate (e.g., edit, view, scroll, and/or manipulate at the same time). In FIG. 6AV, computer system 600a displays content 692a (e.g., a document and/or collaborative content) that can be collaborated on (e.g., collaboratively shared) by first computer system 600a and second computer system 600b, and computer system 600b displays user interface 604b (e.g., a home screen).

In FIG. 6AV, first computer system 600a and second computer system 600b are brought together. In response to obtaining an indication that the set of criteria for sharing information is met (and, in some embodiments, because first computer system 600a includes contact information of the user of second computer system and second computer system 600b includes contact information of the user of first computer system 600a), first computer system 600a and second computer system 600b initiate a process for sharing and/or performing a collaboration session including content 692a. For example, in response to obtaining an indication that the set of criteria for sharing information is met, first computer system 600a displays representation 694 of content 692a, notification 644a, share option 698, and sharing-mode indicator 696. Because content 692a can be collaborated on, sharing-mode indicator 696 initially indicates that a collaborate sharing mode is selected. Second computer system 600b displays notification 644b indicating that second computer system 600b has connected with first computer system 600a.

In response to detecting selection 625z of share option 698 (e.g., a tap and/or other input selecting share option 698) at first computer system 600a while the collaborate sharing mode is selected, first computer system 600a requests to initiate a collaboration session including content 692a between first computer system 600a and second computer system 600b as shown in FIG. 6AZ. In response to the request to initiate the collaboration session, second computer system 600b displays prompt 693 with cancel option 693a (e.g., to decline the request to initiate the collaboration session) and open option 693b. In FIG. 6AZ, first computer system 600a updates notification 644a to indicate that first computer system 600a is waiting to receive a response from second computer system 600b and replaces share option 698 with cancel option 697 (e.g., for canceling the request to initiate the collaboration session). In response to detecting selection 625ad of open option 693b, a collaboration session including content 692a is initiated between first computer system 600a and second computer system 600b, as shown in FIG. 6BA. In FIG. 6BA, first computer system 600a displays (e.g., returns to display of) content 692a and second computer system 600b displays content 692a (e.g., in the collaboration session).

Returning to FIG. 6AW, in response to detecting selection 625aa of sharing-mode indicator 696, first computer system 600a displays sharing-mode option 699a (e.g., corresponding to the collaborate mode) and sharing-mode option 699b (e.g., corresponding to a send-copy mode), as shown in FIG. 6AX. In FIG. 6AX, first computer system 600a detects selection 625ab of sharing-mode option 699b. In response to detecting selection 625ab of sharing-mode option 699b, first computer system 600a updates sharing-mode indicator 696 to indicate that a send-copy mode is selected, as shown in FIG. 6AY. In some embodiments, the send-copy mode enables first computer system 600a to share a copy of content 692a (e.g., with second computer system 600b) without initiating (and/or without requesting to initiate) a collaboration session between first computer system 600a and second computer system 600b. For example, in response to detecting selection 625ac of share option 698 while the send-copy mode is selected, first computer system 600a shares a copy of content 692a with second computer system 600b without initiating a collaboration session (e.g., as described with reference to FIGS. 6AZ-6BA).

In some embodiments, after (or, optionally, in response to) first computer system 600a sharing content with second computer system 600b, a representation of the shared content is displayed in a message conversation between the user of first computer system 600a and the user of second computer system 600b. For example, FIG. 6BB illustrates user interface 691a of a messaging application displayed on first computer system 600a and user interface 691b of the messaging application (or, in some embodiments, a different messaging application) displayed on second computer system 600b. User interface 691a and user interface 691b display message conversation 698a (e.g., in a messages region) between the user of first computer system 600a and the user of second computer system 600b, message entry field 685, and keyboard 683. Message conversation 689a includes messages 687a-687e between the user of first computer system 600a and the user of second computer system 600b. Message 687e includes a representation of content 692a. After content 692a is shared with second computer system 600b, message 687e is displayed in message conversation 689a (e.g., to indicate that content 692a has been shared between first computer system 600a and second computer system 600b). In some embodiments, content 692a is displayed in response to detecting selection of message 687e (e.g., a tap and/or other input selecting message 687e). In some embodiments, if content 692a is shared in a collaboration mode, a collaboration session including content 692a is initiated (or attempted to be initiated) in response to detecting selection of message 687e (e.g., as described with reference to FIGS. 6AZ-6BA). In some embodiments, if content 692a is shared in a send-copy mode, content 692a is displayed in response to detecting selection of message 687e without initiating (or attempting to initiate) a collaboration session including content 692a (e.g., as described with reference to FIG. 6AY).

FIG. 7 is a flow diagram illustrating a method for transferring contact information using a computer system in accordance with some embodiments. Method 700 is performed at a first computer system (e.g., 100, 300, 500, 600a, 600b, 600c, or 600d) (e.g., a smart phone, a smart watch, a tablet computer, a laptop computer, a desktop computer, a wearable device, and/or head-mounted device) that is in communication with (e.g., includes and/or is connected to) a display generation component (e.g., 602a, 602b, 602c, or 602d) (e.g., a display, touch-screen display, a monitor, a holographic display system, and/or a head-mounted display system).

In some embodiments, the first computer system is in communication with (e.g., includes and/or is connected to) one or more input devices (e.g., 602a, 602b, 602c, 602d, 671c, and/or 671d) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device; a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)).

In some embodiments, the first computer system is in communication with (e.g., includes and/or is connected to) one or more sensors that are capable of, configured to, and/or enabled to detect, measure, and/or determine a physical distance between the first computer system and a second (e.g., remote and/or external) computer system. In some embodiments, one or more sensors include one or more electrical, magnetic, electromagnetic, mechanical, and/or acoustic sensors (e.g., antennas, magnets, and/or coils). In some embodiments, the one or more sensors detect, measure, and/or determine a physical distance between the first computer system and a second computer system using electrical, magnetic, electromagnetic, mechanical, and/or acoustic forces, signals, communication, and/or other techniques.

As described below, method 700 provides an intuitive way for transferring contact information. The method reduces the cognitive burden on a user for transferring contact information, thereby creating a more efficient human-machine interface. For battery-operated computing devices, enabling a user to transfer contact information faster and more efficiently conserves power and increases the time between battery charges. Some operations in method 700 are optionally combined, the orders of some operations are optionally changed, and some operations are optionally omitted.

The first computer system obtains (702) (e.g., receives and/or detects) an indication (e.g., data and/or information) that a set of contact information-sharing criteria is met, wherein the set of contact information-sharing criteria includes a set of position criteria that requires that (e.g., is met only if; or is not met unless) a physical distance (e.g., a measured physical distance, a detected physical distance, a determined physical distance, and/or a calculated physical distance) between the first computer system (or, in some embodiments, a respective portion of the first computer system) and a second computer system (e.g., 100, 300, 500, 600a, 600b, 600c, or 600d) (or, in some embodiments, a respective portion of the second computer system) satisfies (or, in some embodiments, is determined to satisfy) (e.g., is less than, is equal to, or is less than or equal to) a distance threshold (e.g., 0 inches, 0.5 inches, 1 inch, 2 inches, or 3 inches; e.g., the first computer system is in physical contact with the second computer system).

In some embodiments, obtaining the indication that the set of contact information-sharing criteria is met includes detecting (e.g., via one or more sensors of the first computer system and/or one or more sensors of the second computer system) and/or determining a physical position (e.g., location and/or orientation) of the first computer system relative to the second computer system. In some embodiments, the indication that the set of contact information-sharing criteria is met is based at least in part on the physical position of the first computer system relative to the second computer system (e.g., the detected and/or determined physical position of the first computer system relative to the second computer system).

In some embodiments, obtaining the indication that the set of contact information-sharing criteria is met includes the first computer system detecting and/or determining that the set of contact information-sharing criteria is met (e.g., the first computer system detects and/or determines that the set of contact information-sharing criteria is met). In some embodiments, obtaining the indication that the set of contact information-sharing criteria is met includes receiving data from the second computer system indicating that the set of contact information-sharing criteria is met (e.g., the second computer system detects and/or determines that the set of contact information-sharing criteria is met and sends an indication to the first computer system that the set of contact information-sharing criteria is met). In some embodiments, obtaining the indication that the set of contact information-sharing criteria is met includes receiving data from the second computer system indicating that a subset of the set of contact information-sharing criteria is met (e.g., detecting and/or determining that the set of contact information-sharing criteria is met is performed in part by the second computer system and in part by the first computer system).

In some embodiments, the set of contact information-sharing criteria requires that the set of position criteria is met (e.g., the set of contact information-sharing criteria is not met if the set of position criteria is not met; the set of contact information-sharing criteria is met only if the set of position criteria is met). In some embodiments, the set of position criteria is met only if the physical distance between the first computer system and the second computer system satisfies the distance threshold. In some embodiments, the set of position criteria is not met if the physical distance between the first computer system and the second computer system does not satisfy the distance threshold. In some embodiments, the set of contact information-sharing criteria is met only if the physical distance between the first computer system and the second computer system satisfies the distance threshold. In some embodiments, the set of contact information-sharing criteria is not met if the physical distance between the first computer system and the second computer system does not satisfy the distance threshold.

In response to obtaining the indication that the set of contact information-sharing criteria is met (704), the first computer system displays (706), via the display generation component, a first set of contact information (e.g., 608a, 610a, 612a, 614a, 608b, 610b, 612b, and/or 614b) (e.g., name, picture, phone number(s), email address(es), physical address, and/or birthday) associated with the first computer system (e.g., contact information associated with an account that the first computer system is logged into). In some embodiments, the contact information includes contact information of an entity such as, e.g., a person, a user of the first computer system, a business, a profile, an account (e.g., an email account, a user account, and/or a cloud-based account), a service, and/or a group of two or more individual entities.

In response to obtaining the indication that the set of contact information-sharing criteria is met (704), the first computer system provides (708) (e.g., displays via the display generation component and/or outputs) a prompt (e.g., 616a, 616b, 618a, 618b, 619a, 619b, and/or 629b) (e.g., a visual prompt, a graphical element, an icon, a button, an affordance, a selectable option, a selectable element, a user-interactive graphical element, text, instructions, an animation, a pop up, an audio output, a sound, and/or a tactile output) for transferring (e.g., sharing, sending, transmitting, and/or receiving) respective contact information (e.g., the contact information associated with the first computer system and/or contact information associated with the second computer system).

Displaying a first set of contact information associated with the first computer system in response to obtaining the indication that the set of contact information-sharing criteria is met informs the user that the set of contact information-sharing criteria was met and indicates what information is going to be transferred, thereby providing improved visual feedback to the user. Providing the prompt for transferring respective contact information in response to obtaining the indication that the set of contact information-sharing criteria is met informs the user that the set of contact information-sharing criteria was met, avoids inadvertently transferring contact information, and enables the user to initiate transfer of the respective contact information with fewer inputs, thereby providing improved visual feedback to the user, providing improved security, and reducing the number of inputs needed to perform an operation.

In some embodiments, the first computer system concurrently displays the contact information associated with the first computer system and provides the prompt for transferring the respective contact information. In some embodiments, the prompt for transferring respective contact information between the first computer system and the second computer system includes (e.g., is) a prompt to: share respective contact information with the first computer system; share respective contact information with the second computer system; send respective contact information to the first computer system; send respective contact information to the second computer system; receive respective contact information by the first computer system; receive respective contact information by the second computer system; request for the first computer system to send respective contact information; request for the second computer system to send respective contact information; request for the first computer system to receive respective contact information; request for the second computer system to receive respective contact information; allow the first computer system to receive the respective contact information; and/or allow the second computer system to receive the respective contact information.

In some embodiments, transferring the respective contact information includes sharing, sending, transmitting, and/or receiving the respective contact information between the first computer system and the second computer system. In some embodiments, transferring the respective contact information includes transmitting the respective contact information from the first computer system to the second computer system and/or from the second computer system to the first computer system.

In some embodiments, transferring the respective contact information between the first computer system and the second computer system includes: the first computer system sending contact information directly to the second computer system (e.g., via near-field communication (NFC)); the second computer system sending contact information directly to the first computer system (e.g., via NFC); the first computer system receiving contact information directly from the second computer system (e.g., via NFC); and/or the second computer system receiving contact information directly from the first computer system (e.g., via NFC).

In some embodiments, transferring the respective contact information between the first computer system and the second computer system includes: the first computer system and/or the second computer system receiving contact information from a remote server; and/or the first computer system and/or the second computer system sending contact information to a remote server.

In some embodiments, the first computer system is in communication with one or more input devices (e.g., 602a, 602b, 602c, and/or 602c). In some embodiments, in response to obtaining the indication that the set of contact information-sharing criteria is met, the first computer system displays, via the display generation component, a selectable share user interface element (e.g., 618a, 618b, 619a, and/or 619b) (e.g., a user-interactive user interface element, a button, a selectable icon, a selectable option, and/or an affordance); the first computer system detects, via the one or more input devices, selection (e.g., 625a, 625b, 625l, and/or 625n) of the share user interface element; and in response to detecting selection of the share user interface element, the first computer system initiates a process that includes transmitting a second set of contact information associated with the first computer system to the second computer system (e.g., from the first computer system to the second computer system). In some embodiments, displaying the prompt for transferring respective contact information between the first computer system and the second computer system includes displaying the share user interface element (e.g., the prompt includes the share user interface element; the prompt is the share user interface element; and/or the share user interface element is part of the prompt). In some embodiments, the prompt and the share user interface element are displayed concurrently. Displaying a share user interface element in response to obtaining the indication that the set of contact information-sharing criteria is met enables the user to initiate transmission of contact information to the second computer system without having to navigate additional user interfaces and allows the user to confirm the user's intent to transmit the contact information, thereby reducing the number of inputs needed to perform an operation and providing improved security.

In some embodiments, the first computer system is in communication with one or more input devices. In some embodiments, in response to obtaining the indication that the set of contact information-sharing criteria is met, the first computer system displays, via the display generation component, a receive user interface element (e.g., 616a, 616b, and/or 629b) (e.g., a receive only option and/or a just receive option); the first computer system detects, via the one or more input devices, selection (e.g., 625d) of the receive user interface element; and in response to detecting selection of the receive user interface element, the first computer system initiates a process that includes receiving a first set of contact information associated with the second computer system (e.g., without initiating a process that includes transmitting a set of contact information associated with the first computer system to the second computer system). In some embodiments, the receive user interface element includes (e.g., is) a user-interactive user interface element, a button, a selectable icon, a selectable option, and/or an affordance. In some embodiments, the first set of contact information associated with the second computer system is received from the second computer system or an external computer system (e.g., a server or cloud service). In some embodiments, displaying the prompt for transferring respective contact information between the first computer system and the second computer system includes displaying the receive user interface element (e.g., the prompt includes the receive user interface element; the prompt is the receive user interface element; and/or the receive user interface element is part of the prompt). In some embodiments, the prompt and the receive user interface element are displayed concurrently. In some embodiments, the share user interface element and the receive user interface element are displayed concurrently. Displaying the receive user interface element in response to obtaining the indication that the set of contact information-sharing criteria is met enables the user to easily obtain another user's contact information without having to share their contact information and without having to perform additional navigation of a user interface, thereby providing improved security and reducing the number of inputs needed to perform an operation.

In some embodiments, the first computer system is in communication with one or more input devices. In some embodiments, after providing the prompt for transferring respective contact information, the first computer system detects, via the one or more input devices, a first request (e.g., 625a, 625c, and/or 625l) (e.g., at the first computer system) to transfer the respective contact information (e.g., between the first computer system and the second computer system); and after (or, in some embodiments, in response to) detecting, via the one or more input devices, the first request (e.g., at the first computer system) to transfer the respective contact information (e.g., between the first computer system and the second computer system) and detection, at the second computer system, of a second request (e.g., 625b, 625d, and/or 625n) to transfer the respective contact information (e.g., between the first computer system and the second computer system), the first computer system transfers the respective contact information (e.g., between the first computer system and the second computer system) (e.g., the respective contact information is transferred after (or in response to) requests being received at both the first computer system and the second computer system; input is required at both the first computer system and the second computer system before transferring the respective contact information; the respective contact information is not transferred until input is received at both the first computer system and at the second computer system). Transferring the respective contact information after detecting the first request at the first computer system and detection of a second request at the second computer system prevents inadvertent transfer of contact information, thereby providing improved security.

In some embodiments, in response to detecting, via the one or more input devices, the first request (e.g., 625a, 625c, and/or 625l) (e.g., at the first computer system) to transfer the respective contact information (and, in some embodiments, before detection, at the second computer system, of the second request to transfer the respective contact information and/or before transferring the respective contact information), the first computer system displays, via the display generation component, an indication (e.g., 622a and/or 622c) that transferring the respective contact information has not started (e.g., an indication that the first computer system is waiting for the second computer system to detect a request to transfer the respective contact information); and after (or, in some embodiments, while) displaying the indication that transferring the respective contact information has not started, the first computer system receives an indication that detection, at the second computer system, of the second request (e.g., 625b, 625d, and/or 625n) to transfer the respective contact information has occurred, wherein transferring the respective contact information is performed in response to detection at the second computer system of the second request to transfer the respective contact information between the first computer system and the second computer system. Displaying an indication that transferring the respective contact information has not started informs the user about the state of the first computer system and enables the user to potentially cease the process before contact information is transferred, thereby providing improved visual feedback and security.

In some embodiments, the first request to transfer the respective contact information between the first computer system and the second computer system includes a request (e.g., selection of a share option) to transfer contact information associated with the first computer system to the second computer system (e.g., without receiving contact information associated with the second computer system), and the second request to transfer the respective contact information includes a request (e.g., selection of a receive option) to receive, at the second computer system, contact information associated with the first computer system (e.g., without transferring contact information associated with the second computer system to the first computer system) (e.g., selection of 616a and selection of 618b; or selection of 618a and selection of 616b). In some embodiments, the first request to transfer the respective contact information includes a request (e.g., selection of a receive option) to receive contact information associated with the second computer system (e.g., without transferring contact information associated with the first computer system to the second computer system), and the second request to transfer the respective contact information includes a request (e.g., selection of a share option) to transfer contact information associated with the second computer system (e.g., without receiving contact information associated with the first computer system). Allowing a first request to transfer contact information associated with the first computer system to the second computer system and a second request to receive, at the second computer system, contact information associated with the first computer system enables the first computer system to provide contact information without having to receive contact information, thereby providing improved security.

In some embodiments, while obtaining the indication that the set of contact information-sharing criteria is met, the first computer system displays, via the display generation component, a user interface (e.g., 604a, 624b, 601a, and/or 601b) that does not include contact information associated with the first computer system (e.g., the computer system obtains the indication that the set of contact information-sharing criteria is met while displaying a user interface that does not include contact information associated with the first computer system; the computer system is not displaying a contact card when the computer system obtains the indication that the set of contact information-sharing criteria is met). Obtaining the indication that the set of contact information-sharing criteria is met while displaying a user interface that does not include contact information associated with the first computer system enables the computer system to provide the prompt for transferring respective contact information without having to navigate to a user interface (e.g., a contact card) that includes contact information, thereby reducing the number of inputs needed to perform an operation.

In some embodiments, the set of position criteria requires that the first computer system (or, in some embodiments, a portion of the first computer system) is in a predetermined spatial orientation (e.g., the spatial orientation shown in FIG. 6B, 6I, or 6AD) (e.g., a predetermined spatial configuration and/or a predetermined spatial alignment) relative to the second computer system (or, in some embodiments, a portion of the second computer system). In some embodiments, the set of position criteria requires that a near-field communication antenna of the first computer system is aligned with a near-field communication antenna of the second computer system. In some embodiments, the set of position criteria requires that the first computer system is oriented at 180 degrees relative to the second computer system (e.g., relative to a first axis, while the first computer system and the second computer system have the same orientation relative to a second axis and a third axis). Having the set of position criteria require that the first computer system is in a predetermined spatial orientation relative to the second computer system avoids inadvertently transferring contact information, thereby providing improved security.

In some embodiments, in response to obtaining the indication that the set of contact information-sharing criteria is met (and, in some embodiments, before displaying the first set of contact information associated with the first computer system and providing the prompt for transferring respective contact information), the first computer system displays (e.g., temporarily displays and/or displays for a non-zero predetermined amount of time) a user interface element (e.g., 606a, 606b, and/or 605a) (e.g., a pop up, a notification, an indication, an alert, and/or a temporary user interface element) that indicates that the set of contact information-sharing criteria has been met. In some embodiments, in accordance with a determination that display of the user interface element that indicates that the set of contact information-sharing criteria has been met satisfies a time threshold (e.g., the user interface element has been displayed for a predetermined amount of time), the computer system ceases display of the user interface element that indicates that the set of contact information-sharing criteria has been met. Displaying a user interface element that indicates that the set of contact information-sharing criteria has been met in response to obtaining the indication that the set of contact information-sharing criteria is met informs the user that the set of contact information-sharing criteria has been met, thereby providing improved visual feedback to the user.

In some embodiments, the first computer system detects, via one or more input devices in communication with the first computer system, a request (e.g., 625k, 625m, and/or rotation of rotatable input mechanism 671c or 671d) to display one or more user-interactive user interface elements for selecting an option for transferring the respective contact information (e.g., between the first computer system and the second computer system); and in response to detecting the request to display the one or more sharing user interface elements for selecting an option for transferring the respective contact information, the first computer system displays, via the display generation component, the one or more sharing user interface elements for selecting an option for transferring the respective contact information (e.g., displaying the prompt, displaying a share option, and/or displaying an option to receive contact information without sharing contact information). In some embodiments, the request to display the one or more sharing user interface elements includes a tap gesture (e.g., on a notification), a swipe gesture, a tap and drag gesture, a rotation of a rotatable input mechanism, and/or a request to scroll a user interface. In some embodiments, the prompt for transferring the respective contact information and/or the one or more sharing user interface elements are initially hidden (e.g., not displayed in response to obtaining the indication that the set of contact information-sharing criteria is met). Displaying the one or more sharing user interface elements for selecting an option for transferring the respective contact information in response to detecting the request to display the one or more sharing user interface elements for selecting an option for transferring the respective contact information, provides greater control over display of the sharing user interface elements, and avoids inadvertently transferring contact information, thereby providing improved security.

In some embodiments, the set of contact information-sharing criteria is not met if the first computer system (or, in some embodiments, an account associated with the first computer system) includes (e.g., has access to) contact information associated with the second computer system (and/or, in some embodiments, the second computer system includes contact information associated with the first computer system) (e.g., as described with reference to FIGS. 6L-6S). For example, in some embodiments, if the first computer system includes contact information of a user account that is logged into the second computer system (e.g., the user of the second computer system is a known contact to the first computer system), the first computer system does not display the first set of contact information associated with the first computer system and/or provide the prompt for transferring respective contact information between the first computer system and the second computer system. In some embodiments, if the first computer system includes contact information associated with the second computer system but the second computer system does not include contact information associated with the first computer system, the first computer system displays the first set of contact information associated with the first computer system and/or provides the prompt for transferring respective contact information between the first computer system and the second computer system. Requiring that the set of contact information-sharing criteria is not met if the first computer system includes contact information associated with the second computer system avoids providing the prompt for transferring respective contact information if the first computer system already has contact information of the second computer system, thereby avoiding cluttering the user interface with additional displayed controls.

In some embodiments, in accordance with a determination that the set of contact information-sharing criteria is not met (e.g., the first computer system does not obtain an indication that the set of contact information-sharing criteria is met) and that content currently designated at the first computer system is a predetermined type of content (e.g., 640a, 648, 648a-648f, 656, 664, and/or 672) (e.g., a website, one or more photos, a media item, a TV show, a TV episode, a movie, a song, an album, an editable document, a watch face, and/or other type of content that can be shared), the first computer system provides (e.g., displays via the display generation component) a prompt (e.g., 646, 644b, 654, 660, 662, 668, 670, 676, and/or 678) for transferring (e.g., sharing a copy of, sharing for collaboration, and/or sharing for synchronized playback) the content currently designated at the first computer system (e.g., to or with the second computer system). Providing a prompt for transferring the content currently designated at the first computer system in accordance with a determination that the set of contact information-sharing criteria is not met and that content currently designated at the first computer system is a predetermined type of content enables the computer system to provide an efficient method for transferring currently designated content when contact information sharing is not required, thereby performing an operation when a set of conditions has been met without requiring further user input and providing additional control options without cluttering the user interface with additional displayed controls.

In some embodiments, in accordance with a determination that the set of contact information-sharing criteria is not met (e.g., the first computer system does not obtain an indication that the set of contact information-sharing criteria is met) and that the content currently designated at the first computer system is not a predetermined type of content (e.g., 604a, 604b, 624b, 601a, 601b, a wake screen, a home screen, and/or a system-level user interface), the first computer system maintains a display state (e.g., a current display state, an existing display state, and/or display of a user interface) of the display generation component (e.g., the first computer system maintains a current display state without displaying the first set of contact information associated with the first computer system, without providing the prompt for transferring respective contact information, and without providing the prompt for transferring the content currently designated t the first computer system). Maintaining a display state of the display generation component in accordance with a determination that the set of contact information-sharing criteria is not met and that the content currently designated at the first computer system is not a predetermined type of content avoids display of content that is not relevant to the user, thereby performing an operation when a set of conditions has been met without requiring further user input and avoiding cluttering the user interface with additional displayed controls.

In some embodiments, displaying the first set of contact information associated with the first computer system includes displaying one or more of a name (e.g., 612a, 612b, and/or a user's name) associated with the first computer system, an image (e.g., 610a, 610b, a picture, avatar, monogram, initials, or other visual representation) associated with the first computer system, a phone number associated with the first computer system, or an address (e.g., an email address and/or a physical address) associated with the first computer system. Displaying one or more of a name associated with the first computer system, an image associated with the first computer system, a phone number associated with the first computer system, or an address associated with the first computer system informs the user of the information that is available for transfer, thereby providing improved visual feedback to the user.

In some embodiments, after obtaining the indication that the set of contact information-sharing criteria is met and while the physical distance between the first computer system and the second computer system does not satisfy the distance threshold (e.g., the first computer system has been separated and/or moved away from the second computer system), the first computer system initiates transfer of the respective contact information (e.g., sending contact information associated with the first computer system to the second computer system, causing the first computer system to receive contact information associated with the second computer system, and/or enabling the first computer system to receive contact information associated with the second computer system). Initiating transfer of the respective contact information after obtaining the indication that the set of contact information-sharing criteria is met and while the physical distance between the first computer system and the second computer system does not satisfy the distance threshold enables the user to continue with the process for transferring the respective contact information without having to maintain the first computer system and the second computer system in a configuration that might make it more difficult to otherwise use and helps prevent mistakes, thereby reducing the number of inputs need to perform an operation.

In some embodiments, in response to obtaining the indication that the set of contact information-sharing criteria is met, the first computer system initiates (e.g., automatically, without detecting user input) transfer of the respective contact information (e.g., as described with reference to FIG. 6B) (e.g., sending contact information associated with the first computer system to the second computer system, causing the first computer system to receive contact information associated with the second computer system, and/or enabling the first computer system to receive contact information associated with the second computer system). In some embodiments, transferring the respective contact information is initiated solely by obtaining the indication that the set of contact information-sharing criteria is met. Initiating transfer of the respective contact information in response to obtaining the indication that the set of contact information-sharing criteria is met enables the transfer of the respective contact information without additional inputs, thereby reducing the number of inputs needed to perform an operation.

In some embodiments, while displaying a user interface (e.g., 626a, 626b, 634a, 607a, 680a, and/or a contact card) that includes a second set of contact information associated with the first computer system (e.g., a set of contact information of a user associated with the first computer system), the first computer system detects, via one or more input devices in communication with the first computer system, a request (e.g., 625c, 625l, and/or 625w) to initiate a process for transferring respective contact information; and in response to detecting the request to initiate a process for transferring respective contact information, the first computer system initiates a mode in which the first computer system is enabled to perform a process that includes transferring respective contact information (e.g., between the first computer system and the second computer system). In some embodiments, the request to initiate a process for transferring respective contact information includes selection of (e.g., a tap on and/or other input selecting) a user-interactive user interface element (e.g., 636a, 682a, a button, a selectable icon, a selectable option, and/or an affordance). Initiating a mode in which the first computer system is enabled to perform a process that includes transferring respective contact information in response to detecting the request to initiate a process for transferring respective contact information prevents inadvertent transfer of contact information and helps prevent mistakes, thereby providing improved security and reducing the number of inputs needed to perform an operation.

In some embodiments, in response to detecting the request to initiate a process for transferring respective contact information, the first computer system displays, via the display generation component, instructions (e.g., 620a, 620b, 623, 623a, 623b, 623c, 627, and/or 686a) for initiating the process that includes transferring respective contact information. Displaying instructions for initiating the process that includes transferring respective contact information in response to detecting the request to initiate a process for transferring respective contact information informs the user how to initiate the process and helps avoid incorrect inputs, thereby providing improved visual feedback to the user and reducing the number of inputs needed to perform an operation.

In some embodiments, displaying the instructions for initiating the process that includes transferring respective contact information includes displaying the instructions for initiating the process that includes transferring respective contact information at a display location adjacent to a portion (e.g., a near-field communication antenna and/or a top edge) of the first computer system (e.g., the portion of 600a that overlaps 600b in FIGS. 6B and 6I, or the portion of 600b that overlaps 600a in FIGS. 6B and 6I), wherein a position of the portion of the first computer system is used to determine the physical distance between the first computer system and the second computer system. Displaying the instructions for initiating the process that includes transferring respective contact information at a display location adjacent to a portion of the first computer system that is used to determine the physical distance between the first computer system and the second computer system provides the instructions at a location that is relevant to the operation being performed and likely to have the attention of the user, thereby providing improved visual feedback to the user.

In some embodiments, in response to detecting the request to initiate a process for transferring respective contact information, the first computer system displays, via the display generation component, a set of one or more selectable information elements (e.g., 613, 615, and/or 645a-645h) corresponding to respective contact information items (e.g., phone number, email, website, URL, address, birthday, date, related name, social profile, instant message, and/or pronoun) associated with the first computer system (e.g., at least a first selectable information element corresponding to a first contact information item of a user of the first computer system and a second selectable information element corresponding to a second contact information item of the user of the first computer system); the first computer system detects, via the one or more input devices, selection of (e.g., 625i, 625p, 625q, 625t, 625x, a tap on, and/or other input selecting) a first information element (e.g., 613, 615, and/or 645a-645h) of the set of one or more selectable information elements, the first information element corresponding to a first contact information item associated with the first computer system; and in response to detecting selection of the first information element, the first computer system designates (e.g., selects and/or visually designates) the first information element (e.g., as shown in FIGS. 6X, 6AL, 6AO, and/or 6AS); wherein transferring the respective contact information includes: in accordance with a determination that the first information element has been selected (and, in some embodiments, has not been subsequently deselected), transferring the first contact information item corresponding to the first information element; and in accordance with a determination that the first information element has not been selected (and/or, in some embodiments, has been selected and then subsequently deselected), transferring the respective contact information without transferring the first contact information item corresponding to the first information element. In some embodiments, transferring the respective contact information includes transferring contact information items corresponding to the information elements in the set of one or more selectable information elements that have been (or are currently) selected and not transferring contact information items corresponding to the information elements in the set of one or more selectable information elements that have not been (or are not currently) selected. Transferring the respective contact information with or without the first contact information item based on whether the first information element has been selected enables the user to quickly and efficiently control what information is transferred, thereby providing improved security, performing an operation when a set of conditions has been met without requiring further user input, and reducing the number of inputs needed to perform an operation.

In some embodiments, the first computer system receives contact information associated with the second computer system; and after (e.g., in response to) receiving the contact information associated with the second computer system, the first computer system displays, via the display generation component, the contact information (e.g., 610a 610b, 612a, 612b, 614a, 614b, 626a, 628a, 628b, 632a, 632b, 631a, and/or 631b) associated with the second computer system (e.g., the first computer system displays a contact card of a user associated with the second computer system that includes contact information of the user associated with the second computer system). Displaying the contact information associated with the second computer system receiving contact information associated with the second computer system informs the user that contact information has been successfully transferred, thereby providing improved visual feedback to the user.

In some embodiments, obtaining the indication that the set of contact information-sharing criteria is met occurs while the first computer system is displaying a first user interface; and in response to a determination that communication of the respective contact information is complete, the first computer system displays, via the display generation component, the first user interface (e.g., the first computer system returns to a previously displayed user interface after sharing and/or receiving the respective contact information). Displaying the first user interface that is displayed while obtaining the indication that the set of contact information-sharing criteria is met in response to a determination that communication of the respective contact information is complete automatically provides the user with the user interface that they were using immediately before transferring contact information without having to navigate a user interface, thereby reducing the number of inputs needed to perform an operation.

In some embodiments, in response to a determination that communication of the respective contact information is complete, the first computer system provides (e.g., displays via the display generation component) an indication (e.g., 626a, 626b, 636a, 631a, and/or 631b) (e.g., a user interface element, a sound, an audio output, and/or a tactile output) that transfer of the respective contact information is complete (e.g., that communication of the respective contact information was successful). In some embodiments, the first computer system provides the indication that transfer of the respective contact information is complete in accordance with a determination that (e.g., only if) the first computer system does not receive contact information associated with the second computer system (e.g., a user of the first computer system selected to share contact information of the user of the first computer system with the second computer system, and a user of the second computer system selected not to share contact information of the user of the second computer system with the first computer system). Providing an indication that transfer of the respective contact information is complete in response to a determination that communication of the respective contact information is complete informs the user that the respective contact information has been transferred and that no additional input is required, thereby providing improved visual feedback to the user and reducing the number of inputs needed to perform an operation.

In some embodiments, in accordance with a determination that a set of authentication criteria has not been met (e.g., 600b in FIG. 6C) (e.g., the first computer system is in a locked state and/or a user interface of the first computer system is locked), the first computer system foregoes (e.g., postpones) display of at least a portion (e.g., 610b, 612b, and/or 614b) of the first set of contact information associated with the first computer system (e.g., as described with reference to 620b in FIG. 6C) (e.g., displaying a user interface without displaying the first set of contact information associated with the first computer system; or displaying a first portion of the set of contact information associated with the first computer system without displaying a second portion of the first set of contact information associated with the first computer system). In some embodiments, in accordance with a determination that the set of authentication criteria has not been met, the first computer system foregoes providing the prompt for transferring respective contact information. In some embodiments, in accordance with a determination that the set of authentication criteria has not been met, the first computer system displays an obscured or blurry version of a visual representation (e.g., a profile picture) associated with the first computer system. In some embodiments, in accordance with a determination that the set of authentication criteria has not been met, the first computer system displays a prompt for a user to perform authentication (e.g., provide a passcode, provide a personal identification number, and/or position a face of the user within a field of view of one or more sensors of the first computer system so that the first computer system can perform facial identification). In some embodiments, the set of contact information-sharing criteria requires that the set of authentication criteria has been met. Foregoing display of at least a portion of the first set of contact information associated with the first computer system in accordance with a determination that a set of authentication criteria has not been met avoids unauthorized display of potentially personal or sensitive information, thereby providing improved security and improved visual feedback to the user.

In some embodiments, in accordance with (e.g., in response to) a determination that the set of authentication criteria has been met (e.g., 600b in FIG. 6D), the first computer system displays, via the display generation component, the first set of contact information (e.g., 610b, 612b, and/or 614b in FIG. 6D) associated with the first computer system (and, in some embodiments, providing the prompt for transferring respective contact information). In some embodiments, displaying the first set of contact information in response to obtaining the indication that the set of contact information-sharing criteria is met is performed in accordance with a determination that the set of authentication criteria has been met. In some embodiments, the first computer system foregoes displaying the first set of contact information associated with the first computer system until the set of authentication criteria has been met. In some embodiments, in response to obtaining the indication that the set of contact information-sharing criteria is met: in accordance with a determination that a set of authentication criteria has been met, the first computer system displays, via the display generation component, the first set of contact information associated with the first computer system and provides the prompt for transferring respective contact information; and in accordance with a determination that the set of authentication criteria has not been met, the first computer system foregoes display of at least a portion of the first set of contact information associated with the first computer system and, optionally, foregoes providing the prompt for transferring respective contact information. Displaying the first set of contact information associated with the first computer system in accordance with a determination that the set of authentication criteria has been met automatically provides the contact information when display of the information is authorized, thereby performing an operation when a set of conditions has been met without requiring further user input and providing improved security.

In some embodiments, in response to obtaining the indication that the set of contact information-sharing criteria is met, the first computer system displays, via the display generation component, an information-selection user interface element (e.g., 609a, 609b, 614a, and/or 614b) (e.g., a selectable user interface element, a user-interactive user interface element, a button, and/or an affordance); the first computer system detects, via the one or more input devices, an input (e.g., 625h, 6250, 625s, a tap, and/or other input) selecting the information-selection user interface element; in response to detecting the input selecting the information-selection user interface element, the first computer system displays, via the display generation component, one or more information items (e.g., 613, 615, and/or 645a-645h) (e.g., a list of information items and/or selectable user interface elements corresponding to respective information); the first computer system detects, via the one or more input devices, a set of one or more inputs (e.g., 625i, 625p, 625q, 625r, 625t, 625u, taps, and/or other inputs) that includes selection of a set of information items (e.g., one or more information items) from the one or more information items; after (or, in some embodiments, in response to) detecting the set of one or more inputs that includes selection of the set of information items, the first computer system detects, via the one or more input devices, an input (e.g., 625a, 625b, 625l, 625n, 625v, a tap, and/or other input) selecting the prompt for transferring respective contact information; and in response to detecting the input selecting the prompt for transferring respective contact information, the first computer system transfers (or, in some embodiments, initiates a process for transferring) contact information (e.g., phone number(s), email address(es), physical address(es), pronoun(s), website(s), URL(s), related name(s), social profile(s), instant message ID(s), and/or date(s)) that corresponds to the set of information items (e.g., the selected set of information items). Transferring contact information that corresponds to the set of selected information items enables a user to quickly and efficiently customize the information that is shared with another user and/or device, thereby reducing the number of inputs needed to perform an operation and providing improved security.

In some embodiments, in response to obtaining the indication that the set of contact information-sharing criteria is met, the first computer system displays, via the display generation component, an indication (e.g., text, icon(s), graphic(s), color(s), and/or animation(s)) (e.g., 649a, 649b, 649c, “(123) 456-7890” in FIGS. 6C, 6V, and/or 6AJ, “PHONE & EMAIL” in FIG. 6Y, “PHONES & ADDRESS” in FIG. 6AN, and/or “REVIEW INFO” in FIG. 6AP) of one or more currently selected (e.g., user-selected and/or default) information items (e.g., items of information that will be transferred in response to selection of the prompt for transferring respective contact information). Displaying an indication of one or more currently selected information items in response to obtaining the indication that the set of contact information-sharing criteria is met enables a user to automatically see what information is set to be transferred and decide whether the information needs to be altered, thereby performing an operation when a set of conditions has been met without requiring further user input, providing improved visual feedback to the user, and providing improved security. In some embodiments, the information-selection user interface element includes the indication of one or more currently selected information items. In some embodiments, the indication of one or more currently selected information items indicates a type of information item, such as, e.g., phone number, email, website, URL, address, birthday, date, related name, social profile, instant message ID, and/or pronoun. In some embodiments, after (or, in some embodiments, in response to) detecting the set of one or more inputs (e.g., 625j, 625r, and/or 625u) that includes selection of the set of information items, the first computer system displays (e.g., updates display of) the indication of one or more currently selected information items to indicate the set of information items (e.g., as shown in FIGS. 6Y, 6AM, and/or 6AP). Displaying the indication to indicate the set of information items that were selected enables a user to confirm that the desired information was selected, thereby providing improved visual feedback to the user, reducing the number of inputs needed to perform an operation, and providing improved security. In some embodiments, displaying the indication of one or more currently selected information items includes displaying a first icon (e.g., 649a, 649b, and/or 649c) corresponding to a first currently selected information item and a second icon (e.g., 649a, 649b, and/or 649c) corresponding to a second currently selected information item, wherein the second icon is different from the first icon and the second currently selected information item is different from the first currently selected information item. Displaying icons corresponding to selected information items provides an efficient technique for informing the user of the selected information and enables the user to quickly see the type of information that is selected to be shared without further user input, thereby providing improved visual feedback to the user and reducing the number of inputs needed to perform an operation.

In some embodiments, displaying the information-selection user interface element includes: in accordance with a determination that a set of information-display criteria is met (e.g., more than two types of information items are selected or a pronoun information item is selected), displaying the information-selection user interface element having a first appearance that does not indicate a currently-selected information item (e.g., a generic appearance such as “Review Info” as shown in FIG. 6AP); and in accordance with a determination that the set of information-display criteria is not met (e.g., a pronoun information item is not selected and two or fewer types of information items are selected), displaying the information-selection user interface element having a second appearance, different from the first appearance, that indicates a currently-selected information item (e.g., text, color, and/or graphics that indicate the currently-selected information item(s)) (e.g., 614a as shown in FIGS. 6C, 6V, 6Y, 6AJ, and/or 6AN). In some embodiments, the set of information-display criteria is based on the information items that are selected and/or the type of information associated with the information items that are selected. Displaying the information-selection user interface element with different appearances based on a set of information-display criteria enables the first computer system to automatically adjust the appearance of the information-selection user interface element to convey information to the user and optimize display space without requiring additional inputs from the user, thereby providing improved visual feedback to the user, reducing the number of inputs needed to perform an operation, and performing an operation when a set of conditions has been met without requiring further user input.

In some embodiments, in response to obtaining the indication that the set of contact information-sharing criteria is met: in accordance with a determination that the second computer system (e.g., 600b in FIGS. 6AT-6AU) includes first contact information (e.g., the mobile phone number indicated by 645a) associated with the first computer system (e.g., 600a in FIGS. 6AT-6AU) and does not include second contact information (e.g., the personal email address indicated in 645c) associated with the first computer system that is different from the first contact information associated with the first computer system, the first computer system initiates a process for transferring (e.g., automatically transfers, without additional user input at the first computer system and/or the second computer system) the second contact information associated with the first computer system (e.g., as shown and described with reference to FIG. 6AU) (e.g., if the user of the first computer system is already known to the second computer system, then the first computer system will transfer additional contact information associated with the first computer system). Initiating a process for transferring the second contact information in accordance with a determination that the second computer system includes first contact information associated with the first computer system and does not include second contact information associated with the first computer system enables a user to quickly and efficiently share (and/or obtain) additional contact information, thereby performing an operation when a set of conditions has been met without requiring further user input and reducing the number of inputs needed to perform an operation. In some embodiments, in accordance with a determination that the first contact information and the second contact information are selected to be transferred by the first computer system and the second computer system includes the first contact information and does not include the second contact information, the second contact information is transferred to the second computer system (e.g., automatically, without additional user input at the first computer system and/or the second computer system, in response to obtaining the indication that the set of contact information-sharing criteria is met). In some embodiments, in accordance with a determination that the second computer system includes all contact information that is selected to be transferred by the first computer system, the first computer system forgoes transferring the respective contact information. In some embodiments, in response to receiving the second contact information, the second computer system displays an indication (e.g., 690b and/or 688b) of the second contact information. In some embodiments, initiating the process for transferring the second contact information associated with the first computer system includes transferring (e.g., automatically transferring, without additional user input at the first computer system and/or the second computer system) the second contact information associated with the first computer system in response to obtaining the indication that the set of contact information-sharing criteria is met. Transferring the second contact information associated with the first computer system in response to obtaining the indication that the set of contact information-sharing criteria is met enables the first computer system to automatically transfer the second contact information when the second computer system already includes some information (e.g., the first contact information) associated with the first computer system, thereby providing improved security and reducing the number of inputs needed to perform an operation.

Note that details of the processes described above with respect to method 700 (e.g., FIG. 7) are also applicable in an analogous manner to the methods described below. For example, method 800 and/or method 900 optionally includes one or more of the characteristics of the various methods described above with reference to method 700. For example, the first computer system in method 800 and/or method 900 can transfer contact information according to the techniques described in method 700. For brevity, these details are not repeated below.

FIG. 8 is a flow diagram illustrating a method for transferring designated content using a computer system in accordance with some embodiments. Method 800 is performed at a first computer system (e.g., 100, 300, 500, 600a, 600b, 600c, or 600d) (e.g., a smart phone, a smart watch, a tablet computer, a laptop computer, a desktop computer, a wearable device, and/or head-mounted device) that is in communication with (e.g., includes and/or is connected to) a display generation component (e.g., 602a, 602b, 602c, or 602d) (e.g., a display, touch-screen display, a monitor, a holographic display system, and/or a head-mounted display system).

In some embodiments, the first computer system is in communication with (e.g., includes and/or is connected to) one or more input devices (e.g., 602a, 602b, 602c, 602d, 671c, and/or 671d) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device; a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)).

In some embodiments, the first computer system is in communication with (e.g., includes and/or is connected to) one or more sensors that are capable of, configured to, and/or enabled to detect, measure, and/or determine a physical distance between the first computer system and a second (e.g., remote and/or external) computer system. In some embodiments, one or more sensors include one or more electrical, magnetic, electromagnetic, mechanical, and/or acoustic sensors (e.g., antennas, magnets, and/or coils). In some embodiments, the one or more sensors detect, measure, and/or determine a physical distance between the first computer system and a second computer system using electrical, magnetic, electromagnetic, mechanical, and/or acoustic forces, signals, communication, and/or other techniques.

As described below, method 800 provides an intuitive way for transferring designated content. The method reduces the cognitive burden on a user for transferring designated content, thereby creating a more efficient human-machine interface. For battery-operated computing devices, enabling a user to transfer designated content faster and more efficiently conserves power and increases the time between battery charges. Some operations in method 800 are optionally combined, the orders of some operations are optionally changed, and some operations are optionally omitted.

The first computer system obtains (802) (e.g., receives and/or detects) an indication (e.g., data and/or information) that a set of content-sharing criteria is met, wherein the set of content-sharing criteria includes a set of position criteria that requires that (e.g., is met only if; or is not met unless) a physical distance (e.g., a measured physical distance, a detected physical distance, a determined physical distance, and/or a calculated physical distance) between the first computer system (or, in some embodiments, a respective portion of the first computer system) and a second computer system (e.g., 100, 300, 500, 600a, 600b, 600c, or 600d) (or, in some embodiments, a respective portion of the second computer system) satisfies (or, in some embodiments, is determined to satisfy) (e.g., is less than, is equal to, or is less than or equal to) a distance threshold (e.g., 0 inches, 0.5 inches, 1 inch, 2 inches, or 3 inches; e.g., the first computer system is in physical contact with the second computer system).

In some embodiments, obtaining the indication that the set of content-sharing criteria is met includes detecting (e.g., via one or more sensors of the first computer system and/or one or more sensors of the second computer system) and/or determining a physical position (e.g., location and/or orientation) of the first computer system relative to the second computer system. In some embodiments, the indication that the set of content-sharing criteria is met is based at least in part on the physical position of the first computer system relative to the second computer system (e.g., the detected and/or determined physical position of the first computer system relative to the second computer system).

In some embodiments, obtaining the indication that the set of content-sharing criteria is met includes the first computer system detecting and/or determining that the set of content-sharing criteria is met (e.g., the first computer system detects and/or determines that the set of content-sharing criteria is met). In some embodiments, obtaining the indication that the set of content-sharing criteria is met includes receiving data from the second computer system indicating that the set of content-sharing criteria is met (e.g., the second computer system detects and/or determines that the set of content-sharing criteria is met and sends an indication to the first computer system that the set of content-sharing criteria is met). In some embodiments, obtaining the indication that the set of content-sharing criteria is met includes receiving data from the second computer system indicating that a subset of the set of content-sharing criteria is met (e.g., detecting and/or determining that the set of content-sharing criteria is met is performed in part by the second computer system and in part by the first computer system).

In some embodiments, the set of content-sharing criteria requires that the set of position criteria is met (e.g., the set of content-sharing criteria is not met if the set of position criteria is not met; the set of content-sharing criteria is met only if the set of position criteria is met). In some embodiments, the set of position criteria is met only if the physical distance between the first computer system and the second computer system satisfies the distance threshold. In some embodiments, the set of position criteria is not met if the physical distance between the first computer system and the second computer system does not satisfy the distance threshold. In some embodiments, the set of content-sharing criteria is met only if the physical distance between the first computer system and the second computer system satisfies the distance threshold. In some embodiments, the set of content-sharing criteria is not met if the physical distance between the first computer system and the second computer system does not satisfy the distance threshold.

In response to obtaining the indication that the set of content-sharing criteria is met, the first computer system provides (804) (e.g., displays via the display generation component and/or outputs) a prompt (e.g., 644a, 642a, 646, 644b, 650, 652, 654, 658, 660, 662, 666, 668, 670, 674, 676, and/or 678) (e.g., a visual prompt, a graphical element, an icon, a button, an affordance, a selectable option, a selectable element, a user-interactive graphical element, text, instructions, an animation, a pop up, an audio output, a sound, and/or a tactile output) for sharing, with the second computer system, respective designated content (e.g., 640a, 648, 648a-648f, 656, 664, and/or 672) (e.g., a website, one or more photos, a media item, a TV show, a TV episode, a movie, a song, an album, an editable document, a watch face, and/or other type of content that can be shared) that is currently designated (e.g., currently displayed, currently selected, and/or currently in focus) at the first computer system. Providing a prompt for sharing respective designated content with the second computer system in response to obtaining the indication that the set of content-sharing criteria is met provides an efficient method for sharing content with another computer system without having to navigate a user interface, thereby performing an operation when a set of conditions has been met without requiring further user input and reducing the number of inputs needed to perform an operation.

In some embodiments, the prompt for sharing the designated content with the second computer system includes (e.g., is) a prompt for: sending the respective designated content to the second computer system; causing the second computer system to receive the respective designated content; requesting for the first computer system to send the respective designated content; requesting for the second computer system to receive the respective designated content; and/or allowing the second computer system to receive the respective designated content.

In some embodiments, sharing the respective designated content includes sending, transmitting, and/or receiving the respective designated content between the first computer system and the second computer system. In some embodiments, sharing the respective designated content includes transmitting the respective designated content from the first computer system to the second computer system. In some embodiments, sharing the respective designated content includes: the first computer system sending the respective designated content directly to the second computer system (e.g., via near-field communication (NFC)); and/or the second computer system receiving the respective designated content directly from the first computer system (e.g., via NFC). In some embodiments, sharing the respective designated content includes the second computer system receiving the respective designated content from a remote server; and/or the first computer system sending the respective designated content to a remote server.

In some embodiments, the respective designated content includes (e.g., is) content (e.g., 640a, 648, 648a-648f, 656, 664, and/or 672) that is displayed (e.g., currently displayed), via the display generation component, when obtaining the indication that the set of content-sharing criteria is met occurs (e.g., when the computer system obtains the indication that the content-sharing criteria is met) (e.g., in FIG. 6M). In some embodiments, the respective designated content is currently displayed content. Providing a prompt for sharing content that is displayed when obtaining the indication that the set of content-sharing criteria is met provides an efficient method for sharing displayed content with another computer system without having to navigate a user interface, thereby performing an operation when a set of conditions has been met without requiring further user input and reducing the number of inputs needed to perform an operation.

In some embodiments, the respective designated content includes (e.g., is) content (e.g., 648a-648f) that is selected (e.g., currently selected; e.g., selected photos, videos, files, and/or other selected items) when obtaining the indication that the set of content-sharing criteria is met occurs (e.g., when the computer system obtains the indication that the content-sharing criteria is met). In some embodiments, the respective designated content is currently selected content. Providing a prompt for sharing content that is selected when obtaining the indication that the set of content-sharing criteria is met occurs provides an efficient method for sharing selected content with another computer system without having to navigate a user interface, thereby performing an operation when a set of conditions has been met without requiring further user input and reducing the number of inputs needed to perform an operation.

In some embodiments, the respective designated content includes (e.g., is) content that is in focus in a user interface (e.g., a user interface that is displayed via the display generation component) when obtaining the indication that the set of content-sharing criteria is met occurs (e.g., when the computer system obtains the indication that the content-sharing criteria is met). In some embodiments, the respective designated content is currently in-focus content. Providing a prompt for sharing content that is in focus in a user interface when obtaining the indication that the set of content-sharing criteria is met occurs provides an efficient method for sharing in-focus content with another computer system without having to navigate a user interface, thereby performing an operation when a set of conditions has been met without requiring further user input and reducing the number of inputs needed to perform an operation.

In some embodiments, in response to obtaining the indication that the set of content-sharing criteria is met, the first computer system displays (e.g., concurrently with the prompt for sharing the respective designated content), via the display generation component, a representation (e.g., 644a) (e.g., a visual representation, an image, a photo, a monogram, a thumbnail, a name, and/or an avatar) of a user associated with the second computer system (e.g., a user associated with an account that the second computer system is logged into). In some embodiments, in response to obtaining the indication that the set of content-sharing criteria is met, the first computer system displays (e.g., concurrently with the representation of the user associated with the second computer system and/or the prompt for sharing the respective designated content) a selectable user interface element that, when selected, causes the computer system to display information (e.g., name, phone number, email address, and/or physical address) of the user associated with the second computer system. Displaying a representation of a user associated with the second computer system in response to obtaining the indication that the set of content-sharing criteria is met informs the user of the first computer system with whom the respective designated content is to be shared, thereby providing improved visual feedback to the user.

In some embodiments, while obtaining the indication that the set of content-sharing criteria is met, the first computer system displays, via the display generation component, a first representation (e.g., 640a, 648, 648a-648f, 656, 664, and/or 672) (e.g., image) of the respective designated content; and in response to obtaining the indication that the set of content-sharing criteria is met, the first computer system displays (e.g., concurrently with the prompt for sharing the respective designated content), via the display generation component, a second representation (e.g., 642a, 650, 658, 666, and/or 674) (e.g., image) of the respective designated content that is different from (e.g., smaller than and/or a different image from) the first representation of the respective designated content. Displaying a second representation of the respective designated content that is different from the first representation of the respective designated content in response to obtaining the indication that the set of content-sharing criteria is met indicates to the user that the set of content-sharing criteria is met, thereby providing improved visual feedback to the user.

In some embodiments, displaying the second representation of the respective designated content includes fading display of the first representation of the respective designated content and displaying the second representation of the respective designated content in a center of a user interface (e.g., of the display generation component) (e.g., 640a fades into 642a; 648 fades into 650; 656 fades into 658; 664 fades into 666; and/or 672 fades into 674). Fading display of the first representation of the respective designated content and displaying the second representation of the respective designated content in a center of a user interface indicates to the user that the set of content-sharing criteria is met, thereby providing improved visual feedback to the user.

In some embodiments, the first computer system detects (e.g., via one or more input devices that are in communication with the first computer system) a request to share the respective designated content with the second computer system (e.g., selection of a user interface element and/or selection of the prompt for sharing the respective designated content or a portion); and in response to detecting the request to share the respective designated content with the second computer system, the first computer system displays, via the display generation component, an indication (e.g., 622a, 622b, and/or 622c) that the first computer system is waiting to share the respective designated content with the second computer system. In some embodiments, the computer system waits to receive an indication that the second computer system has accepted the request for the first computer system to share the respective designated content with the second computer system before sharing the respective designated content with the second computer system. Displaying an indication that the first computer system is waiting to share the respective designated content with the second computer system in response to detecting the request to share the respective designated content with the second computer system informs the user of the state of the first computer system and prevents the user from providing unnecessary inputs, thereby providing improved visual feedback to the user and reducing the number of inputs needed to perform an operation.

In some embodiments, the first computer system receives an indication that the second computer system has accepted the request for the first computer system to share the respective designated content with the second computer system; and in response to receiving an indication that the second computer system has accepted the request for the first computer system to share the respective designated content with the second computer system, the first computer system ceases display of the indication that the first computer system is waiting to share the respective designated content with the second computer system (and, In some embodiments, sharing the respective designated content with the second computer system). Ceasing display of the indication that the first computer system is waiting to share the respective designated content with the second computer system in response to receiving an indication that the second computer system has accepted the request for the first computer system to share the respective designated content with the second computer system indicates to the user that the second computer system has accepted the request for the first computer system to share the respective designated content with the second computer system, thereby providing improved visual feedback to the user.

In some embodiments, the first computer system shares the respective designated content with the second computer system (e.g., in response to selection of the prompt for sharing the respective designated content or other request to share the respective designated content); and in response to a determination that sharing the respective designated content with the second computer system is successful (e.g., in response to receiving an indication that sharing the respective designated content with the second computer system is successful), the first computer system displays, via the display generation component, an indication (e.g., 636a and/or 640a in FIG. 6O) (e.g., a check mark icon, a color, an animation, the respective designated content, and/or text) that sharing the respective designated content with the second computer system was successful. Displaying an indication that sharing the respective designated content with the second computer system was successful informs the user of the success of sharing the respective designated content, thereby providing improved visual feedback to the user.

In some embodiments, after sharing the respective designated content with the second computer system (e.g., in response to selection of the prompt for sharing the respective designated content or other request to share the respective designated content), the first computer system displays, via the display generation component, a representation of a user associated with the second computer system (e.g., 673a and/or 673b) (e.g., while displaying the respective designated content). In some embodiments, the representation of the user associated with the second computer system is displayed in a dynamic region (e.g., 677a and/or 677b) of a user interface (e.g., a region of the user interface that changes size and/or position in the user interface over time). In some embodiments, in accordance with a determination that a time condition is met (e.g., the representation of the user associated with the second computer system has been displayed for a threshold amount of time), the first computer system ceases display of the representation of the user associated with the second computer system. Displaying a representation of a user associated with the second computer system after sharing the respective designated content with the second computer system informs the user to whom the respective designated content was shared, thereby providing improved visual feedback and improved security.

In some embodiments, the respective designated content includes (e.g., is) a website (e.g., 640a). Providing a prompt for sharing a website in response to obtaining the indication that the set of content-sharing criteria is met provides an efficient method for sharing a website with another computer system without having to navigate a user interface, thereby performing an operation when a set of conditions has been met without requiring further user input and reducing the number of inputs needed to perform an operation.

In some embodiments, the respective designated content includes (e.g., is) one or more photos (e.g., 648a-648f). Providing a prompt for sharing one or more photos in response to obtaining the indication that the set of content-sharing criteria is met provides an efficient method for sharing one or more photos with another computer system without having to navigate a user interface, thereby performing an operation when a set of conditions has been met without requiring further user input and reducing the number of inputs needed to perform an operation.

In some embodiments, the respective designated content includes two or more photos (e.g., 648a-648f) and the first computer system shares the two or more photos with the second computer system. Providing a prompt for sharing two or more photos in response to obtaining the indication that the set of content-sharing criteria is met provides an efficient method for sharing multiple photos with another computer system without having to navigate a user interface, thereby performing an operation when a set of conditions has been met without requiring further user input and reducing the number of inputs needed to perform an operation.

In some embodiments, the respective designated content includes (e.g., is) a music media item (e.g., 656) (e.g., a song and/or an album). Providing a prompt for sharing a music media item in response to obtaining the indication that the set of content-sharing criteria is met provides an efficient method for sharing a music media item with another computer system without having to navigate a user interface, thereby performing an operation when a set of conditions has been met without requiring further user input and reducing the number of inputs needed to perform an operation.

In some embodiments, the respective designated content includes (e.g., is) a video (e.g., 664) (e.g., a TV show, a TV series, and/or a movie). Providing a prompt for sharing a video in response to obtaining the indication that the set of content-sharing criteria is met provides an efficient method for sharing a video with another computer system without having to navigate a user interface, thereby performing an operation when a set of conditions has been met without requiring further user input and reducing the number of inputs needed to perform an operation.

In some embodiments, the first computer system detects (e.g., via one or more input devices that are in communication with the first computer system) a request to share the respective designated content with the second computer system (e.g., selection of a user interface element and/or selection of the prompt for sharing the respective designated content or a portion), wherein in response to detecting the request to share the respective designated content with the second computer system, the second computer system displays a selectable user interface element (e.g., 644b) for accepting (e.g., receiving) the respective designated content. Displaying a selectable user interface element for accepting the respective designated content on the second computer system helps prevent inadvertent sharing, thereby providing improved security.

In some embodiments, in response to a determination that the selectable user interface element for accepting the respective designated content has been selected on the second computer system (e.g., 625f), the first computer system displays, via the display generation component, the respective designated content. In some embodiments, in response to detecting a selection at the second computer system of the selectable user interface element for accepting the respective designated content, the second computer system displays the respective designated content. Displaying the respective designated content in response to a determination that the selectable user interface element for accepting the respective designated content has been selected on the second computer system indicates to the user that the respective designated content was successfully shared and prevents the user from making unnecessary inputs, thereby providing improved visual feedback and reducing the number of inputs needed to perform an operation.

In some embodiments, a representation (e.g., 673a and/or 673b) of a user associated with the first computer system is displayed at the second computer system concurrently with the respective designated content (e.g., the second computer system concurrently displays the respective designated content and the representation of the user associated with the first computer system). In some embodiments, in accordance with a determination that a time condition is met (e.g., the representation of the user associated with the first computer system has been displayed for a threshold amount of time), the second computer system ceases display of the representation of the user associated with the first computer system. Displaying a representation of a user associated with the first computer system at the second computer system concurrently with the respective designated content enabled the user of the second computer system to confirm the user from whom the content was shared, thereby providing improved security.

In some embodiments, display of the representation (e.g., 673a and/or 673b) of the user associated with the first computer system at the second computer system is removed when the second computer system displays content different from the respective designated content (e.g., the second computer system ceases display of the representation of the user associated with the first computer system in response to a request to navigate away from the respective designated content). Removing display of the representation of the user associated with the first computer system when the second computer system displays content different from the respective designated content enables the computer system to provide more relevant content, thereby providing additional control options without cluttering the user interface with additional displayed controls.

In some embodiments, in response to obtaining the indication that the set of content-sharing criteria is met: in accordance with a determination that the respective designated content includes (e.g., is) a first type of content (e.g., 656, 664, and/or 672) (e.g., a website, one or more photos, a media item, a song, an album, a podcast, a movie, a TV show, an episode of a TV show, a word processing document, a spreadsheet, a presentation, a watch face, and/or a collaborative document), the first computer system displays (e.g., concurrently displays), via the display generation component: a share user interface element (e.g., 646, 654, 660, 668, and/or 676) (e.g., a user-interactive user interface element, a button, a selectable icon, a selectable option, and/or an affordance) that, when selected, causes the first computer system to share the respective designated content with the second computer system; and a sharing session user interface element (e.g., 662, 670, and/or 678) (e.g., a user-interactive user interface element, a button, a selectable icon, a selectable option, and/or an affordance) that, when selected, causes initiation of a content-sharing session between the first computer system and the second computer system. In some embodiments, in response to obtaining the indication that the set of content-sharing criteria is met: in accordance with a determination that the respective designated content includes (e.g., is) a second type of content (e.g., 640a, 648, and/or 648a-648f) that is different from the first type of content, the first computer system displays, via the display generation component, the share user interface element without displaying the sharing session user interface element. In some embodiments, the prompt for sharing the respective designated content includes (e.g., is) the share user interface element and/or the sharing session user interface element. In some embodiments, providing the prompt for sharing the respective designated content includes displaying the share user interface element and/or the sharing session user interface element. Displaying a share user interface element and a sharing session user interface element in accordance with a determination that the respective designated content includes a first type of content provides sharing options that are relevant to the designated content and provides the user with an efficient method for selecting the manner in which sharing is to be performed without having to navigate a user interface, thereby performing an operation when a set of conditions has been met without requiring further user input, reducing the number of inputs needed to perform an operation, and providing improved security.

In some embodiments, the first computer system detects selection of the sharing session user interface element (e.g., 662 and/or 670) (e.g., a tap on the sharing session user interface, a mouse click on the sharing session user interface element, or other input selecting the sharing session user interface element); and in response to detecting selection of the sharing session user interface element, the first computer system initiates a synchronized content sharing session that includes playback of the respective designated content at the first computer system that is synchronized in time with playback of the respective designated content at the second computer system. Initiating a synchronized content sharing session that includes playback of the respective designated content at the first computer system that is synchronized in time with playback of the respective designated content at the second computer system in response to detecting selection of the sharing session user interface element enables the user to efficiently share the designated content in a synchronized content sharing session without having to further navigate to an application or menu, thereby reducing the number of inputs needed to perform an operation.

In some embodiments, the first computer system detects selection of the sharing session user interface element (e.g., 662 and/or 670) (e.g., a tap on the sharing session user interface, a mouse click on the sharing session user interface element, or other input selecting the sharing session user interface element); and in response to detecting selection of the sharing session user interface element, the first computer system initiates a real-time communication session (e.g., a phone call, a video call, and/or an audio call that includes a capability to include video) that includes the capability to perform real-time communication between the first computer system and the second computer system. Initiating a real-time communication session that includes the capability to perform real-time communication between the first computer system and the second computer system in response to detecting selection of the sharing session user interface element enables the user to efficiently share the designated content in a real-time communication session without having to further navigate to an application or menu, thereby reducing the number of inputs needed to perform an operation.

In some embodiments, the first computer system detects selection of the sharing session user interface element (e.g., 678) (e.g., a tap on the sharing session user interface, a mouse click on the sharing session user interface element, or other input selecting the sharing session user interface element); and in response to detecting selection of the sharing session user interface element, the first computer system initiates a collaboration session that includes the capability to edit the respective designated content via the first computer system and the second computer system. Initiating a collaboration session that includes the capability to edit the respective designated content via the first computer system and the second computer system in response to detecting selection of the sharing session user interface element enables the user to efficiently share the designated content in a collaboration session without having to further navigate to an application or menu, thereby reducing the number of inputs needed to perform an operation.

In some embodiments, in response to obtaining the indication that the set of content-sharing criteria is met: in accordance with a determination that the respective designated content includes (e.g., is) a first type of content (e.g., a website, one or more photos, a media item, a song, an album, a podcast, a movie, a TV show, an episode of a TV show, a word processing document, a spreadsheet, a presentation, and/or a collaborative document), the first computer system displays, via the display generation component, a first sharing-mode user interface element (e.g., 696, a user-interactive user interface element, a button, a selectable icon, a selectable option, and/or an affordance) (and, in some embodiments, concurrently displays a share user interface element (e.g., 698), such as a user-interactive user interface element, a button, a selectable icon, a selectable option, and/or an affordance, that when selected causes the first computer system to share the respective designated content with the second computer system according to a sharing mode indicated by the sharing-mode user interface element), the first sharing-mode user interface element indicating (e.g., visually indicating) a first sharing mode (e.g., a collaborate mode; a send-copy mode; a mode that includes causing initiation of a content-sharing session between the first computer system and the second computer system; e.g., a mode that includes playback of the respective designated content at the first computer system that is synchronized in time with playback of the respective designated content at the second computer system; a mode that includes a real-time communication session, such as a phone call, a video call, and/or an audio call that includes a capability to include video, that includes the capability to perform real-time communication between the first computer system and the second computer system; a mode that includes sending a copy of the respective designated content; and/or a mode that includes the capability to edit the respective designated content via the first computer system and the second computer system); the first computer system detects, via the one or more input devices, selection of (e.g., 625aa, a tap on, and/or other input selecting) the first sharing-mode user interface element; in response to detecting selection of the first sharing-mode user interface element, the first computer system displays, via the display generation component, a second sharing-mode user interface element (e.g., 699a, 699b, a user-interactive user interface element, a button, a selectable icon, a selectable option, and/or an affordance) corresponding to a second sharing mode (e.g., a mode that includes transferring respective designated content to the second computer system without initiating a collaborative and/or real-time content-sharing session between the first computer system and the second computer system; e.g., a mode that includes sharing a copy of the respective designated content and/or sharing a link to the respective designated content without initiating a content-sharing session between the first computer system and the second computer system); the first computer system detects, via the one or more input devices, selection of (e.g., 625ab, a tap on, and/or other input selecting) the second sharing-mode user interface element; in response to detecting selection of the second sharing-mode user interface element, the first computer system selects the second sharing mode (and, in some embodiments, visually designates the second sharing-mode user interface element, such as with a check mark, outlining, and/or highlighting) (e.g., as shown and described in FIG. 6AY); the first computer system detects (e.g., via one or more input devices that are in communication with the first computer system) a request (e.g., 625z and/or 625ac) to share the respective designated content with the second computer system (e.g., selection of a user interface element and/or selection of the prompt for sharing the respective designated content or a portion); and in response to detecting the request to share the respective designated content with the second computer system: in accordance with a determination that the first sharing mode is selected (e.g., the first sharing-mode user interface element indicates the first sharing mode), the first computer system shares (or, in some embodiments, initiates a process for sharing) the respective designated content with the second computer system according to the first sharing mode; and in accordance with a determination that the second sharing mode is selected (e.g., the first sharing-mode user interface element indicates the second sharing mode and/or the second sharing-mode user interface element was selected), the first computer system shares (or, in some embodiments, initiates a process for sharing) the respective designated content with the second computer system according to the second sharing mode (e.g., sharing the respective designated content with the second computer system according to the selected sharing mode indicated by the first sharing-mode user interface element). Sharing the respective designated content according to the first sharing mode or the second sharing mode based on whether the first sharing mode or the second sharing mode is selected, respectively, enables the user to quickly and efficiently choose a mode for sharing the respective designated content, thereby performing an operation when a set of conditions has been met without requiring further user input and reducing the number of inputs needed to perform an operation. In some embodiments, in response to obtaining the indication that the set of content-sharing criteria is met: in accordance with a determination that the respective designated content includes (e.g., is) a second type of content that is different from the first type of content, the first computer system displays, via the display generation component, the share user interface element without displaying the first sharing-mode user interface element. In some embodiments, in response to detecting selection of the second sharing-mode user interface element, the computer system displays the first sharing-mode user interface element having an indication of the second sharing mode (e.g., updating an appearance of the first sharing-mode user interface to indicate the second sharing mode).

In some embodiments, the first computer system shares the respective designated content with the second computer system (e.g., in response to selection of the prompt for sharing the respective designated content or other request to share the respective designated content); and after sharing the respective designated content with the second computer system: the first computer system displays, via the display generation component, a user interface (e.g., 691a or 691b) of a messaging application, the user interface of the messaging application including a messages region (e.g., 689a) that includes one or more messages (e.g., 678a-687e) in a message conversation between a user of the first computer system and a user of the second computer system; the first computer system displays, in the messages region of the user interface of the messaging application, a shared content user interface element (e.g., 687e, a message in the message conversation, and/or a selectable link to the respective designated content) corresponding to the respective designated content; the first computer system detects, via the one or more input devices, selection of (e.g., a tap on and/or other input selecting) the shared content user interface element; and in response to detecting the selection of the shared content user interface element, the first computer system displays, via the display generation component, the respective designated content (e.g., displaying 692a as shown in FIG. 6BA). Providing a user interface element for displaying the respective designated content in a messaging application informs the user that the respective designated content has been shared and enables a user to quickly and efficiently access the respective designated content, thereby providing improved visual feedback to the user and reducing the number of inputs needed to perform an operation.

In some embodiments, in response to obtaining the indication that the set of content-sharing criteria is met: in accordance with a determination that content (e.g., 640a, 648, 648a-648f, 656, 664, and/or 672) designated (e.g., displayed, selected, and/or in focus) at the second computer system satisfies a set of sharing criteria, the first computer system displays, via the display generation component, an accept user interface element (e.g., 644b) (e.g., a user-interactive user interface element, a button, a selectable icon, a selectable option, and/or an affordance); the first computer system detects selection (e.g., 625f) of the accept user interface element; and in response to detecting selection of the accept user interface element, the first computer system displays, via the display generation component, the content designated at the second computer system. Displaying an accept user interface element in accordance with a determination that content designated at the second computer system satisfies a set of sharing criteria indicates to the user that the content is available, helps prevent inadvertent sharing of the content designated at the second computer system, and reduces mistakes, thereby providing improved visual feedback to the user, performing an operation when a set of conditions has been met without requiring further user input, reducing the number of inputs needed to perform an operation, and providing improved security.

In some embodiments, to be met, the set of content-sharing criteria requires that the respective designated content is a predetermined type of content (e.g., 640a, 648, 648a-648f, 656, 664, and/or 672) (e.g., a type of content in a set of two or more predetermined types of content) (e.g., a website, one or more photos, a media item, a TV show, a TV episode, a movie, a song, an album, an editable document, a watch face, and/or other type of content that can be shared). For example, in accordance with a determination that the respective designated content is a first type of content (e.g., a predetermined type of content), the set of content-sharing criteria is met (e.g., and the first computer system provides the prompt for sharing the respective designated content with the second computer system); and in accordance with a determination that the respective designated content is a second type of content that is different from the first type of content (e.g., the respective designated content is not a predetermined type of content), the set of content-sharing criteria is not met (e.g., and the first computer system does not provide the prompt for sharing the respective designated content with the second computer system). Having the set of content-sharing criteria require that the respective designated content is a predetermined type of content enables display of the prompt in relevant circumstances and prevents display when the context is not relevant, thereby providing additional control options without cluttering the user interface with additional displayed controls.

In some embodiments, to be met, the set of content-sharing criteria requires that the first computer system includes (or, in some embodiments, has access to) contact information of a user associated with the second computer system (e.g., a user associated with the second computer system is a known contact and/or in a list of contactable entities of the first computer system). In some embodiments, to be met, the set of content-sharing criteria requires that the second computer system includes (or, in some embodiments, has access to) contact information of a user associated with the first computer system (e.g., a user associated with the first computer system is a known contact and/or in a list of contactable entities of the second computer system). Having the set of content-sharing criteria require that the first computer system includes contact information of a user associated with the second computer system enables display of the prompt in relevant circumstances and prevents display when the context is not relevant, thereby providing additional control options without cluttering the user interface with additional displayed controls.

In some embodiments, the first computer system obtains (e.g., receives and/or detects) an indication (e.g., data and/or information) that a set of contact information-sharing criteria is met, wherein the set of contact information-sharing criteria includes a set of position criteria that requires that (e.g., is met only if; or is not met unless) a physical distance (e.g., a measured physical distance, a detected physical distance, a determined physical distance, and/or a calculated physical distance) between the first computer system (or, in some embodiments, a respective portion of the first computer system) and the second computer system (or, in some embodiments, a respective portion of the second computer system) satisfies (or, in some embodiments, is determined to satisfy) (e.g., is less than, is equal to, or is less than or equal to) the distance threshold; and in response to obtaining the indication that the set of contact information-sharing criteria is met: the first computer system displays, via the display generation component, a first set of contact information (e.g., 608a, 610a, 612a, 614a, 608b, 610b, 612b, and/or 614b) (e.g., name, picture, phone number(s), email address(es), physical address, and/or birthday) associated with the first computer system (e.g., contact information associated with an account that the first computer system is logged into); and the first computer system provides (e.g., displays via the display generation component and/or outputs) a prompt (e.g., 616a, 616b, 618a, 618b, 619a, 619b, and/or 629b) (e.g., a visual prompt, a graphical element, an icon, a button, an affordance, a selectable option, a selectable element, a user-interactive graphical element, text, instructions, an animation, a pop up, an audio output, a sound, and/or a tactile output) to perform a process that includes communication of (e.g., sharing, sending, transmitting, and/or receiving) respective contact information (e.g., the contact information associated with the first computer system and/or contact information associated with the second computer system). In some embodiments, the contact information includes contact information of an entity such as, e.g., a person, a user of the first computer system, a business, a profile, an account (e.g., an email account, a user account, and/or a cloud-based account), a service, and/or a group of two or more individual entities. Displaying a first set of contact information associated with the first computer system in response to obtaining the indication that the set of contact information-sharing criteria is met informs the user that the set of contact information-sharing criteria was met and indicates what information is going to be transferred, thereby providing improved visual feedback to the user. Providing the prompt for transferring respective contact information in response to obtaining the indication that the set of contact information-sharing criteria is met informs the user that the set of contact information-sharing criteria was met, avoids inadvertently transferring contact information, and enables the user to initiate transfer of the respective contact information with fewer inputs, thereby providing improved visual feedback to the user, providing improved security, and reducing the number of inputs needed to perform an operation.

Note that details of the processes described above with respect to method 800 (e.g., FIG. 7) are also applicable in an analogous manner to the methods described above and below. For example, method 700 and/or method 900 optionally includes one or more of the characteristics of the various methods described above with reference to method 800. For example, the first computer system in method 700 and/or method 900 can transfer designated content in accordance with the techniques described in method 800. For brevity, these details are not repeated below.

FIG. 9 is a flow diagram illustrating a method for transferring information using a computer system in accordance with some embodiments. Method 900 is performed at a first computer system (e.g., 100, 300, 500, 600a, 600b, 600c, or 600d) (e.g., a smart phone, a smart watch, a tablet computer, a laptop computer, a desktop computer, a wearable device, and/or head-mounted device) that is in communication with (e.g., includes and/or is connected to) a display generation component (e.g., 602a, 602b, 602c, or 602d) (e.g., a display, touch-screen display, a monitor, a holographic display system, and/or a head-mounted display system).

In some embodiments, the first computer system is in communication with (e.g., includes and/or is connected to) one or more input devices (e.g., 602a, 602b, 602c, 602d, 671c, and/or 671d) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device; a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)).

In some embodiments, the first computer system is in communication with (e.g., includes and/or is connected to) one or more sensors that are capable of, configured to, and/or enabled to detect, measure, and/or determine a physical distance between the first computer system and a second (e.g., remote and/or external) computer system. In some embodiments, one or more sensors include one or more electrical, magnetic, electromagnetic, mechanical, and/or acoustic sensors (e.g., antennas, magnets, and/or coils). In some embodiments, the one or more sensors detect, measure, and/or determine a physical distance between the first computer system and a second computer system using electrical, magnetic, electromagnetic, mechanical, and/or acoustic forces, signals, communication, and/or other techniques.

As described below, method 900 provides an intuitive way for transferring information. The method reduces the cognitive burden on a user for transferring information, thereby creating a more efficient human-machine interface. For battery-operated computing devices, enabling a user to transfer information faster and more efficiently conserves power and increases the time between battery charges. Some operations in method 900 are optionally combined, the orders of some operations are optionally changed, and some operations are optionally omitted.

The first computer system obtains (902) (e.g., receives and/or detects) an indication (e.g., data and/or information) that a set of information-sharing criteria is met, wherein the set of information-sharing criteria includes a set of position criteria that requires that (e.g., is met only if; or is not met unless) a physical distance (e.g., a measured physical distance, a detected physical distance, a determined physical distance, and/or a calculated physical distance) between the first computer system (or, in some embodiments, a respective portion of the first computer system) and a second computer system (or, in some embodiments, a respective portion of the second computer system) satisfies (or, in some embodiments, is determined to satisfy) (e.g., is less than, is equal to, or is less than or equal to) a distance threshold (e.g., 0 inches, 0.5 inches, 1 inch, 2 inches, or 3 inches; e.g., the first computer system is in physical contact with the second computer system).

In some embodiments, obtaining the indication that the set of information-sharing criteria is met includes detecting (e.g., via one or more sensors of the first computer system and/or one or more sensors of the second computer system) and/or determining a physical position (e.g., location and/or orientation) of the first computer system relative to the second computer system. In some embodiments, the indication that the set of information-sharing criteria is met is based at least in part on the physical position of the first computer system relative to the second computer system (e.g., the detected and/or determined physical position of the first computer system relative to the second computer system).

In some embodiments, obtaining the indication that the set of information-sharing criteria is met includes the first computer system detecting and/or determining that the set of information-sharing criteria is met (e.g., the first computer system detects and/or determines that the set of information-sharing criteria is met). In some embodiments, obtaining the indication that the set of information-sharing criteria is met includes receiving data from the second computer system indicating that the set of information-sharing criteria is met (e.g., the second computer system detects and/or determines that the set of information-sharing criteria is met and sends an indication to the first computer system that the set of information-sharing criteria is met). In some embodiments, obtaining the indication that the set of information-sharing criteria is met includes receiving data from the second computer system indicating that a subset of the set of information-sharing criteria is met (e.g., detecting and/or determining that the set of information-sharing criteria is met is performed in part by the second computer system and in part by the first computer system).

In some embodiments, the set of information-sharing criteria requires that the set of position criteria is met (e.g., the set of information-sharing criteria is not met if the set of position criteria is not met; the set of information-sharing criteria is met only if the set of position criteria is met). In some embodiments, the set of position criteria is met only if the physical distance between the first computer system and the second computer system satisfies the distance threshold. In some embodiments, the set of position criteria is not met if the physical distance between the first computer system and the second computer system does not satisfy the distance threshold. In some embodiments, the set of information-sharing criteria is met only if the physical distance between the first computer system and the second computer system satisfies the distance threshold. In some embodiments, the set of information-sharing criteria is not met if the physical distance between the first computer system and the second computer system does not satisfy the distance threshold.

In response to obtaining the indication that the set of information-sharing criteria is met (904) and in accordance with a determination that a first set of criteria (e.g., a set of contact information-sharing criteria) is met (e.g., the second computer system is associated with a contactable user that is known to (e.g., in a contacts list of) the first computer system), the first computer system provides (906) (e.g., displays via the display generation component and/or outputs) a prompt (e.g., 616a, 616b, 618a, 618b, 619a, 619b, and/or 629b) (e.g., a visual prompt, a graphical element, an icon, a button, an affordance, a selectable option, a selectable element, a user-interactive graphical element, text, instructions, an animation, a pop up, an audio output, a sound, and/or a tactile output) for transferring (e.g., sharing, sending, transmitting, and/or receiving) a first set of information (e.g., contact information associated with the first computer system and/or contact information associated with the second computer system). In some embodiments, in response to obtaining the indication that the set of information-sharing criteria is met and that the first set of criteria is met, the computer system displays a first set of contact information (e.g., name, picture, phone number(s), email address(es), physical address, and/or birthday) associated with the first computer system (e.g., contact information associated with an account that the first computer system is logged into). In some embodiments, the first set of information includes contact information of an entity such as, e.g., a person, a user of the first computer system, a business, a profile, an account (e.g., an email account, a user account, and/or a cloud-based account), a service, and/or a group of two or more individual entities. In some embodiments, the prompt for transferring the first set of information includes (e.g., is) a prompt to: share the first set of information with the first computer system; share the first set of information with the second computer system; send the first set of information to the first computer system; send the first set of information to the second computer system; receive the first set of information by the first computer system; receive the first set of information by the second computer system; request for the first computer system to send the first set of information; request for the second computer system to send the first set of information; request for the first computer system to receive the first set of information; request for the second computer system to receive the first set of information; allow the first computer system to receive the first set of information; and/or allow the second computer system to receive the first set of information. In some embodiments, transferring the first set of information includes sharing, sending, transmitting, and/or receiving the first set of information between the first computer system and the second computer system. In some embodiments, transferring the first set of information includes transmitting the first set of information from the first computer system to the second computer system and/or from the second computer system to the first computer system. In some embodiments, transferring the first set of information includes: the first computer system sending first set of information directly to the second computer system (e.g., via near-field communication (NFC)); the second computer system sending the first set of information directly to the first computer system (e.g., via NFC); the first computer system receiving the first set of information directly from the second computer system (e.g., via NFC); and/or the second computer system receiving the first set of information directly from the first computer system (e.g., via NFC). In some embodiments, transferring the first set of information includes: the first computer system and/or the second computer system receiving the first set of information from a remote server; and/or the first computer system and/or the second computer system sending the first set of information to a remote server.

In response to obtaining the indication that the set of information-sharing criteria is met (904) and in accordance with a determination that the first set of criteria is not met (e.g., the second computer system is associated with a contactable user that is not known to (e.g., in a contacts list of) the first computer system), the first computer system provides (908) (e.g., displays via the display generation component and/or outputs) a prompt (e.g., 644a, 642a, 646, 644b, 650, 652, 654, 658, 660, 662, 666, 668, 670, 674, 676, and/or 678) (e.g., a visual prompt, a graphical element, an icon, a button, an affordance, a selectable option, a selectable element, a user-interactive graphical element, text, instructions, an animation, a pop up, an audio output, a sound, and/or a tactile output) for transferring a second set of information (e.g., 640a, 648, 648a-648f, 656, 664, and/or 672) (e.g., designated content (or data representing designated content) that is, e.g., currently displayed, currently selected, and/or currently in focus at the first computer system) that is different from the first set of information. In some embodiments, the prompt for transferring the second set of information includes (e.g., is) a prompt for: sending the second set of information to the second computer system; causing the second computer system to receive the second set of information; requesting for the first computer system to send the second set of information; requesting for the second computer system to receive the second set of information; and/or allowing the second computer system to receive the second set of information. In some embodiments, transferring the second set of information includes sending, transmitting, and/or receiving the respective designated content between the first computer system and the second computer system. In some embodiments, transferring the second set of information includes transmitting the second set of information from the first computer system to the second computer system. In some embodiments, transferring the second set of information includes: the first computer system sending the second set of information directly to the second computer system (e.g., via near-field communication (NFC)); and/or the second computer system receiving the second set of information directly from the first computer system (e.g., via NFC). In some embodiments, transferring the second set of information includes the second computer system receiving the second set of information from a remote server; and/or the first computer system sending the second set of information to a remote server.

Providing a prompt for transferring a first set of information when the first set of criteria is met and a prompt for transferring a second, different set of information when the first set of criteria is not met indicates to the user that content can be transferred and enables the computer system to automatically provide an option to share content that is relevant to the user based on the context without having to navigate an additional interface, thereby providing improved visual feedback to the user and performing an operation when a set of conditions has been met without requiring further user input.

In some embodiments, the set of information-sharing criteria includes a criterion that is met when content designated at the first computer system includes (e.g., is) a predetermined type of content (e.g., 640a, 648, 648a-648f, 656, 664, and/or 672) (e.g., a website, one or more photos, a media item, a TV show, a TV episode, a movie, a song, an album, an editable document, a watch face, and/or other type of content that can be shared) (e.g., a type of content in a set of two or more predetermined types of content). For example, in accordance with a determination that a first type of content (e.g., a predetermined type of content) is designated at the first computer system, the set of information-sharing criteria is met (e.g., and the first computer system provides a prompt for sharing the designated content with the second computer system); and in accordance with a determination that a second type of content that is different from the first type of content (e.g., content that is not a predetermined type of content) is designated at the first computer system, the set of information-sharing criteria is not met (e.g., and the first computer system does not provide the prompt for sharing the designated content with the second computer system). In some embodiments, the set of information-sharing criteria is met if the physical distance between the first computer system and the second computer system satisfies the distance threshold and content designated at the first computer system includes a predetermined type of content. Including in the set of information-sharing criteria a criterion that is met when content designated at the first computer system includes a predetermined type of content enables the computer system to provide a prompt for transferring information in contexts that are relevant to the user and avoid prompting the user to transfer information when doing so is not relevant, which avoids excess inputs and potential mistakes, thereby performing an operation when a set of conditions has been met without requiring further user input and reducing the number of inputs needed to perform an operation.

In some embodiments, the first set of criteria is not met when contact information associated with the first computer system is known to (e.g., the user of the first computer system is a known contact of) the second computer system and contact information associated with the second computer system is known to (e.g., the user of the second computer system is a known contact of) the first computer system. In some embodiments, the first set of criteria is not met when contact information associated with the first computer system is known to the second computer system or contact information associated with the second computer system is known to the first computer system. In some embodiments, the set of information-sharing criteria is met if the physical distance between the first computer system and the second computer system satisfies the distance threshold and contact information associated with the first computer system is not known to the second computer system and contact information associated with the second computer system is not known to the first computer system. In some embodiments, the set of information-sharing criteria is met if the physical distance between the first computer system and the second computer system satisfies the distance threshold and contact information associated with the first computer system is not known to the second computer system or contact information associated with the second computer system is not known to the first computer system. Not meeting the first set of criteria when contact information associated with the first computer system is known to the second computer system and contact information associated with the second computer system is known to the first computer system prevents display of the prompt to provide the first set of information when not relevant, thereby performing an operation when a set of conditions has been met without requiring further user input and avoids cluttering the user interface with additional displayed controls.

In some embodiments, the first set of criteria is met while the first computer system is not displaying contact information associated with the first computer system (e.g., not displaying 626a, 626b, 634a, 631a, and/or 631b) (e.g., the first set of criteria does not require that the first computer system is displaying contact information associated with the first computer system). In some embodiments, the first computer system obtains the indication that the set of information-sharing criteria is met while displaying a user interface that does not include contact information associated with the first computer system (e.g., while the first computer system is not displaying a contact card of a user associated with the first computer system). Meeting the first set of criteria while the first computer system is not displaying contact information associated with the first computer system enables the first computer system to display the prompt for transferring the first set of information (e.g., contact information) without the user having to navigate to a user interface that includes contact information (e.g., a contact card), thereby reducing the number of inputs needed to perform an operation.

In some embodiments, the first set of criteria is met when the first computer system does not include contact information associated with the second computer system (e.g., the user of the second computer system is not known to the first computer system and/or is not a known contact of the first computer system) or the second computer system does not include contact information associated with the first computer system (e.g., the user of the first computer system is not known to the second computer system and/or is not a known contact of the second computer system). In some embodiments, the first set of criteria requires that the first computer system does not include contact information associated with the second computer system (e.g., the user of the second computer system is not known to the first computer system) and the second computer system does not include contact information associated with the first computer system (e.g., the user of the first computer system is not known to the second computer system). Meeting the first set of criteria when the first computer system does not include contact information associated with the second computer system or the second computer system does not include contact information associated with the first computer system enables the first computer system to display the prompt for transferring the first set of information (e.g., contact information) when either the first computer system or the second computer system does not include contact information of the other computer system and avoids additional inputs, thereby performing an operation when a set of conditions has been met without requiring further user input and reducing the number of inputs needed to perform an operation.

In some embodiments, providing the prompt for transferring the first set of information includes: in accordance with a determination that the first computer system does not include contact information associated with the second computer system (e.g., the user of the second computer system is not known to the first computer system and/or is not a known contact of the first computer system) and that the second computer system does not include contact information associated with the first computer system (e.g., the user of the first computer system is not known to the second computer system and/or is not a known contact of the second computer system), displaying (e.g., concurrently displaying), via the display generation component: a share user interface element (e.g., 618a, 618b, 619a, and/or 619b) (e.g., a user-interactive user interface element, a button, a selectable icon, a selectable option, and/or an affordance) that, when selected, causes sharing, with the second computer system, of contact information associated with the first computer system; and a receive user interface element (e.g., 616a, 616b, and/or 629b) (e.g., a user-interactive user interface element, a button, a selectable icon, a selectable option, and/or an affordance) that, when selected, enables the first computer system to receive contact information associated with the second computer system without sharing, with the second computer system, contact information associated with the first computer system. Displaying the share user interface element and the receive user interface element in accordance with a determination that the first computer system does not include contact information associated with the second computer system and that the second computer system does not include contact information associated with the first computer system enables the user to efficiently choose whether to share and/or receive contact information without navigating an interface, thereby performing an operation when a set of conditions has been met without requiring further user input and reducing the number of inputs needed to perform an operation.

In some embodiments, providing the prompt for transferring the first set of information includes: in accordance with a determination that the first computer system includes contact information associated with the second computer system (e.g., the user of the second computer system is known to the first computer system and/or is a known user of the first computer system) and that the second computer system does not include contact information associated with the first computer system (e.g., the user of the first computer system is not known to the second computer system and/or is not a known contact of the second computer system), displaying, via the display generation component, a share user interface element (e.g., 618a, 618b, 619a, and/or 619b) (e.g., a user-interactive user interface element, a button, a selectable icon, a selectable option, and/or an affordance) that, when selected, causes sharing, with the second computer system, of contact information associated with the first computer system without displaying a receive user interface element (e.g., 616a, 616b, and/or 629b) (e.g., a user-interactive user interface element, a button, a selectable icon, a selectable option, and/or an affordance) that, when selected, enables the first computer system to receive contact information associated with the second computer system without sharing, with the second computer system, contact information associated with the first computer system. In some embodiments, providing the prompt for transferring the first set of information includes: in accordance with a determination that the first computer system includes contact information associated with the second computer system (e.g., the user of the second computer system is known to the first computer system) and that the second computer system does not include contact information associated with the first computer system (e.g., the user of the first computer system is not known to the second computer system), displaying (e.g., concurrently displaying), via the display generation component: the share user interface element that, when selected, causes sharing, with the second computer system, of contact information associated with the first computer system; and the receive user interface element that, when selected, enables the first computer system to receive contact information associated with the second computer system without sharing, with the second computer system, contact information associated with the first computer system. Displaying a share user interface element without displaying a receive user interface element in accordance with a determination that the first computer system includes contact information associated with the second computer system and that the second computer system does not include contact information associated with the first computer system provides the user with relevant options without distracting the user with less relevant option based on whether the computer systems include contact information of each other, thereby performing an operation when a set of conditions has been met without requiring further user input and providing additional control options without cluttering the user interface with additional displayed controls.

In some embodiments, when the first computer system includes contact information associated with the second computer system (e.g., the user of the second computer system is known to the first computer system and/or is a known contact of the first computer system) and the second computer system does not include contact information associated with the first computer system (e.g., the user of the first computer system is not known to the second computer system and/or is not a known contact of the second computer system), the second computer system displays a receive user interface element (e.g., 616a, 616b, and/or 629b) (e.g., a user-interactive user interface element, a button, a selectable icon, a selectable option, and/or an affordance) that, when selected, enables the second computer system to receive contact information associated with the first computer system without sharing, with the first computer system, contact information associated with the second computer system (e.g., without displaying a share user interface element that, when selected, causes sharing, with the first computer system, of contact information associated with the second computer system). Displaying a receive user interface element at the second computer system when the first computer system includes contact information associated with the second computer system and the second computer system does not include contact information associated with the first computer system provides the user with relevant options without distracting the user with less relevant option based on whether the computer systems include contact information of each other, thereby performing an operation when a set of conditions has been met without requiring further user input and providing additional control options without cluttering the user interface with additional displayed controls. In some embodiments, when the first computer system includes contact information associated with the second computer system (e.g., the user of the second computer system is known to the first computer system) and the second computer system does not include contact information associated with the first computer system (e.g., the user of the first computer system is not known to the second computer system), the second computer system displays a receive user interface element that, when selected, enables the second computer system to receive contact information associated with the first computer system and displays a share user interface element that, when selected, causes sharing, with the first computer system, of current contact information associated with the second computer system.

In some embodiments, providing the prompt for transferring the first set of information includes: in accordance with a determination that the first computer system does not include contact information associated with the second computer system (e.g., the user of the second computer system is not known to the first computer system and/or is not a known contact of the first computer system) and that the second computer system includes contact information associated with the first computer system (e.g., the user of the first computer system is known to the second computer system and/or is a known contact of the second computer system), displaying, via the display generation component, a receive user interface element (e.g., 616a, 616b, and/or 629b) (e.g., a user-interactive user interface element, a button, a selectable icon, a selectable option, and/or an affordance) that, when selected, enables the first computer system to receive contact information associated with the second computer system without sharing, with the second computer system, contact information associated with the first computer system (e.g., without displaying a share user interface element that, when selected, causes sharing, with the second computer system, of contact information associated with the first computer system). Displaying the receive user interface element in accordance with a determination that the first computer system does not include contact information associated with the second computer system and that the second computer system includes contact information associated with the first computer system provides the user with relevant options without distracting the user with less relevant option based on whether the computer systems include contact information of each other, thereby performing an operation when a set of conditions has been met without requiring further user input and providing additional control options without cluttering the user interface with additional displayed controls. In some embodiments, providing the prompt for transferring the first set of information includes: in accordance with a determination that the first computer system does not include contact information associated with the second computer system (e.g., the user of the second computer system is not known to the first computer system) and that the second computer system includes contact information associated with the first computer system (e.g., the user of the first computer system is known to the second computer system), displaying (e.g., concurrently displaying), via the display generation component: the share user interface element that, when selected, causes sharing, with the second computer system, of contact information associated with the first computer system; and the receive user interface element that, when selected, enables the first computer system to receive contact information associated with the second computer system without sharing, with the second computer system, contact information associated with the first computer system.

In some embodiments, when the first computer system does not include contact information associated with the second computer system (e.g., the user of the second computer system is not known to the first computer system and/or is not a known contact of the first computer system) and the second computer system includes contact information associated with the first computer system (e.g., the user of the first computer system is known to the second computer system and/or is a known contact of the second computer system), the second computer system displays a share user interface element (e.g., 618a, 618b, 619a, and/or 619b) (e.g., a user-interactive user interface element, a button, a selectable icon, a selectable option, and/or an affordance) that, when selected, causes sharing, with the first computer system, of contact information associated with the second computer system (e.g., without displaying a receive user interface element that, when selected, enables the second computer system to receive contact information associated with the first computer system). Displaying the share user interface element at the second computer system when the first computer system does not include contact information associated with the second computer system and the second computer system includes contact information associated with the first computer system provides the user with relevant options without distracting the user with less relevant option based on whether the computer systems include contact information of each other, thereby performing an operation when a set of conditions has been met without requiring further user input and providing additional control options without cluttering the user interface with additional displayed controls. In some embodiments, when the first computer system does not include contact information associated with the second computer system (e.g., the user of the second computer system is not known to the first computer system) and the second computer system includes contact information associated with the first computer system (e.g., the user of the first computer system is known to the second computer system), the second computer system displays (e.g., concurrently displays): a share user interface element that, when selected, causes sharing, with the first computer system, of contact information associated with the second computer system; and a receive user interface element that, when selected, enables the second computer system to receive contact information associated with the first computer system.

Note that details of the processes described above with respect to method 900 (e.g., FIG. 7) are also applicable in an analogous manner to the methods described above. For example, method 700 and/or method 800 optionally includes one or more of the characteristics of the various methods described above with reference to method 900. For example, the first computer system in method 700 and/or method 800 can transfer a first set of information or a second set of information based on whether a set of criteria is met. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to transfer contact information and/or designated content. Accordingly, use of such personal information data enables users to have calculated control of the transferred content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of information transfer, the present technology can be configured to allow users to select to “opt in” or “opt out” of participation in the collection of personal information data during registration for services or anytime thereafter. In another example, users can select not to provide data. In yet another example, users can select to limit the length of time data is maintained or entirely prohibit the maintenance of data. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be transferred based on non-personal information data or a bare minimum amount of personal information, such as the content being requested by the device associated with a user, other non-personal information, or publicly available information.

What is claimed is:

1. A first computer system configured to communicate with a display generation component, comprising:
one or more processors; and
memory storing one or more programs configured to be executed by the one or more processors, the one or more programs including instructions for:
while displaying a first representation of respective designated content that is currently designated at the first computer system, obtaining an indication that a set of content-sharing criteria is met, wherein the set of content-sharing criteria includes a set of position criteria that requires that a physical distance between the first computer system and a second computer system satisfies a distance threshold; and
in response to obtaining the indication that the set of content-sharing criteria is met:
providing a prompt for sharing, with the second computer system, the respective designated content that is currently designated at the first computer system; and
displaying, via the display generation component, a second representation of the respective designated content that is different from the first representation of the respective designated content.

2. The first computer system of claim 1, wherein the respective designated content includes content that is displayed, via the display generation component, when obtaining the indication that the set of content-sharing criteria is met occurs.

3. The first computer system of claim 1, wherein the respective designated content includes content that is selected when obtaining the indication that the set of content-sharing criteria is met occurs.

4. The first computer system of claim 1, wherein the respective designated content includes content that is in focus in a user interface when obtaining the indication that the set of content-sharing criteria is met occurs.

5. The first computer system of claim 1, the one or more programs further including instructions for:
in response to obtaining the indication that the set of content-sharing criteria is met, displaying, via the display generation component, a representation of a user associated with the second computer system.

6. The first computer system of claim 1, wherein displaying the second representation of the respective designated content includes fading display of the first representation of the respective designated content and displaying the second representation of the respective designated content in a center of a user interface.

7. The first computer system of claim 1, the one or more programs further including instructions for:
detecting a request to share the respective designated content with the second computer system; and
in response to detecting the request to share the respective designated content with the second computer system, displaying, via the display generation component, an indication that the first computer system is waiting to share the respective designated content with the second computer system.

8. The first computer system of claim 7, the one or more programs further including instructions for:
receiving an indication that the second computer system has accepted the request for the first computer system to share the respective designated content with the second computer system; and
in response to receiving an indication that the second computer system has accepted the request for the first computer system to share the respective designated content with the second computer system, ceasing display of the indication that the first computer system is waiting to share the respective designated content with the second computer system.

9. The first computer system of claim 1, the one or more programs further including instructions for:
sharing the respective designated content with the second computer system; and
in response to a determination that sharing the respective designated content with the second computer system is successful, displaying, via the display generation component, an indication that sharing the respective designated content with the second computer system was successful.

10. The first computer system of claim 1, the one or more programs further including instructions for:
after sharing the respective designated content with the second computer system, displaying, via the display generation component, a representation of a user associated with the second computer system.

11. The first computer system of claim 1, wherein the respective designated content includes a website.

12. The first computer system of claim 1, wherein the respective designated content includes one or more photos.

13. The first computer system of claim 12, wherein the respective designated content includes two or more photos, the one or more programs further including instructions for:
sharing the two or more photos with the second computer system.

14. The first computer system of claim 1, wherein the respective designated content includes a music media item.

15. The first computer system of claim 1, wherein the respective designated content includes a video.

16. The first computer system of claim 1, the one or more programs further including instructions for:
detecting a request to share the respective designated content with the second computer system, wherein in response to detecting the request to share the respective designated content with the second computer system, the second computer system displays a selectable user interface element for accepting the respective designated content.

17. The first computer system of claim 16, the one or more programs further including instructions for:
in response to a determination that the selectable user interface element for accepting the respective designated content has been selected on the second computer system, displaying, via the display generation component, the respective designated content.

18. The first computer system of claim 17, wherein a representation of a user associated with the first computer system is displayed at the second computer system concurrently with the respective designated content.

19. The first computer system of claim 18, wherein display of the representation of the user associated with the first computer system at the second computer system is removed when the second computer system displays content different from the respective designated content.

20. The first computer system of claim 1, the one or more programs further including instructions for:
in response to obtaining the indication that the set of content-sharing criteria is met:
in accordance with a determination that the respective designated content includes a first type of content, displaying, via the display generation component:
a share user interface element that, when selected, causes the first computer system to share the respective designated content with the second computer system; and
a sharing session user interface element that, when selected, causes initiation of a content-sharing session between the first computer system and the second computer system.

21. The first computer system of claim 20, the one or more programs further including instructions for:
detecting selection of the sharing session user interface element; and
in response to detecting selection of the sharing session user interface element, initiating a synchronized content sharing session that includes playback of the respective designated content at the first computer system that is synchronized in time with playback of the respective designated content at the second computer system.

22. The first computer system of claim 20, the one or more programs further including instructions for:
detecting selection of the sharing session user interface element; and
in response to detecting selection of the sharing session user interface element, initiating a real-time communication session that includes a capability to perform real-time communication between the first computer system and the second computer system.

23. The first computer system of claim 20, the one or more programs further including instructions for:
detecting selection of the sharing session user interface element; and
in response to detecting selection of the sharing session user interface element, initiating a collaboration session that includes a capability to edit the respective designated content via the first computer system and the second computer system.

24. The first computer system of claim 1, wherein the first computer system is configured to communicate with one or more input devices, the one or more programs further including instructions for:
in response to obtaining the indication that the set of content-sharing criteria is met:
in accordance with a determination that the respective designated content includes a first type of content, displaying, via the display generation component, a first sharing-mode user interface element, the first sharing-mode user interface element indicating a first sharing mode;
detecting, via the one or more input devices, selection of the first sharing-mode user interface element;
in response to detecting selection of the first sharing-mode user interface element, displaying, via the display generation component, a second sharing-mode user interface element corresponding to a second sharing mode;
detecting, via the one or more input devices, selection of the second sharing-mode user interface element;
in response to detecting selection of the second sharing-mode user interface element, selecting the second sharing mode;
detecting a request to share the respective designated content with the second computer system; and
in response to detecting the request to share the respective designated content with the second computer system:
in accordance with a determination that the first sharing mode is selected, sharing the respective designated content with the second computer system according to the first sharing mode; and
in accordance with a determination that the second sharing mode is selected, sharing the respective designated content with the second computer system according to the second sharing mode.

25. The first computer system of claim 1, wherein the first computer system is configured to communicate with one or more input devices, the one or more programs further including instructions for:
sharing the respective designated content with the second computer system; and
after sharing the respective designated content with the second computer system:
displaying, via the display generation component, a user interface of a messaging application, the user interface of the messaging application including a messages region that includes one or more messages in a message conversation between a user of the first computer system and a user of the second computer system;
displaying, in the messages region of the user interface of the messaging application, a shared content user interface element corresponding to the respective designated content;
detecting, via the one or more input devices, selection of the shared content user interface element; and
in response to detecting the selection of the shared content user interface element, displaying, via the display generation component, the respective designated content.

26. The first computer system of claim 1, the one or more programs further including instructions for:
in response to obtaining the indication that the set of content-sharing criteria is met:
in accordance with a determination that content designated at the second computer system satisfies a set of sharing criteria, displaying, via the display generation component, an accept user interface element;
detecting selection of the accept user interface element; and
in response to detecting selection of the accept user interface element, displaying, via the display generation component, the content designated at the second computer system.

27. The first computer system of claim 1, wherein, to be met, the set of content-sharing criteria requires that the respective designated content is a predetermined type of content.

28. The first computer system of claim 1, wherein, to be met, the set of content-sharing criteria requires that the first computer system includes contact information of a user associated with the second computer system.

29. The first computer system of claim 28, the one or more programs further including instructions for:
obtaining an indication that a set of contact information-sharing criteria is met, wherein the set of contact information-sharing criteria includes a set of position criteria that requires that a physical distance between the first computer system and the second computer system satisfies the distance threshold; and
in response to obtaining the indication that the set of contact information-sharing criteria is met:
displaying, via the display generation component, a first set of contact information associated with the first computer system; and
providing a prompt to perform a process that includes communication of respective contact information.

30. A non-transitory computer-readable storage medium storing one or more programs configured to be executed by one or more processors of a first computer system that is in communication with a display generation component, the one or more programs including instructions for:
while displaying a first representation of respective designated content that is currently designated at the first computer system, obtaining an indication that a set of content-sharing criteria is met, wherein the set of content-sharing criteria includes a set of position criteria that requires that a physical distance between the first computer system and a second computer system satisfies a distance threshold; and
in response to obtaining the indication that the set of content-sharing criteria is met:
providing a prompt for sharing, with the second computer system, the respective designated content that is currently designated at the first computer system; and
displaying, via the display generation component, a second representation of the respective designated content that is different from the first representation of the respective designated content.

31. A method, comprising:
at a first computer system that is in communication with a display generation component:
while displaying a first representation of respective designated content that is currently designated at the first computer system, obtaining an indication that a set of content-sharing criteria is met, wherein the set of content-sharing criteria includes a set of position criteria that requires that a physical distance between the first computer system and a second computer system satisfies a distance threshold; and
in response to obtaining the indication that the set of content-sharing criteria is met:
providing a prompt for sharing, with the second computer system, the respective designated content that is currently designated at the first computer system; and
displaying, via the display generation component, a second representation of the respective designated content that is different from the first representation of the respective designated content.
